(19) United States
(12) Patent Application Publication
(10) Pub. No.: US 2015/0324710 A1
(43) Pub. Date: Nov. 12, 2015

(54) METHOD FOR CONTROLLING COMMUNICATION DEVICE, METHOD FOR PROVIDING INFORMATION IN INFORMATION MANAGEMENT SYSTEM, AND COMPUTER-READABLE RECORDING MEDIUM

(71) Applicant: PANASONIC INTELLECTUAL PROPERTY CORPORATION OF AMERICA, Torrance, CA (US)

(72) Inventor: Takamitsu Sasaki, Kanagawa (JP)

(73) Assignee: PANASONIC INTELLECTUAL PROPERTY CORPORATION OF AMERICA, Torrance, CA (US)

(21) Appl. No.: 14/807,182

(22) Filed: Jul. 23, 2015

Related U.S. Application Data
(63) Continuation of application No. PCT/JP2014/002352, filed on Apr. 25, 2014.
(60) Provisional application No. 61/931,134, filed on Jan. 24, 2014.

(51) Int. Cl. G06Q 10/02; G09G 5/00

(52) U.S. Cl. CPC G06Q 10/02; G09G 5/003; G09G 2370/022

(57) ABSTRACT

A method causes a computer of a communication device to: acquire appointment available dates and times at a specialized institution; determine candidate appointment dates and times at the specialized institution by excluding each date and time, on which a plan of a user is stored in the communication device, from the acquired appointment available dates and times; display each display representing each candidate appointment time based on the determined candidate appointment dates and times, in each region corresponding to each day represented in calendar data; and display an appointment screen on a display when selection of one region is detected, the one region corresponding to one day represented in the calendar data and representing one candidate appointment time, the appointment screen being used for setting the one candidate appointment date and time corresponding to the selected one region as an appointment date and time at the specialized institution.

### TECHNICAL FIELD

The present disclosure relates to a method for controlling a communication device used in an information management system that performs an appointment process for a specialized institution such as a medical institution, a method for providing information in an information management system that performs an appointment process for a specialized institution, and a computer-readable recording medium.

### BACKGROUND ART

Conventional examples of an information management system of a medical institution include an information management system described below.

The information management system includes a household apparatus that is installed in a household, a medical institution apparatus that is installed in a medical institution, and a service provider apparatus, which is connected to the household apparatus and the medical institution apparatus, accepts an appointment request for the medical institution from the household apparatus, and mediates an appointment process for the medical institution (for example, refer to Patent Literature 1).

However, the conventional art described above require further improvements.

### CITATION LIST

### Patent Literature

Patent Literature 1: Japanese Unexamined Patent Publication No. 2001-222618

### SUMMARY OF INVENTION

In one general aspect, the techniques disclosed here feature a method for causing a computer of a communication device to: acquire appointment available dates and times at a specialized institution from an information management system; determine candidate appointment dates and times at the specialized institution by excluding each date and time, on which a plan of a user is stored in the communication device, from the acquired appointment available dates and times; display each display representing each candidate appointment time based on the determined candidate appointment dates and times, in each region corresponding to each day represented in calendar data; and display an appointment screen on a display when selection of one region is detected in the calendar data, the one region corresponding to one day represented in the calendar data and representing one candidate appointment time, the appointment screen being used for setting the one candidate appointment date and time corresponding to the selected one region as an appointment date and time at the specialized institution.

Accordingly, further improvements can be achieved. These general and specific aspects may be implemented using a system, a method, and a computer program, and any combination of systems, methods, and computer programs.

### BRIEF DESCRIPTION OF DRAWINGS

FIG. 1 is a diagram showing a first example of an overall configuration of an appointment system according to the present disclosure.

FIG. 2 is a diagram showing a second example of an overall configuration of an appointment system according to the present disclosure.

FIG. 3 is a diagram showing a third example of an overall configuration of an appointment system according to the present disclosure.

FIG. 4 is a diagram showing a fourth example of an overall configuration of an appointment system according to the present disclosure.

FIG. 5 is a block diagram showing a configuration pattern of an appointment system according to the first example.

FIG. 6 is a block diagram showing a configuration pattern of an appointment system according to the first example.

FIG. 7 is a block diagram showing a configuration pattern of an appointment system according to the first example.

FIG. 8 is a block diagram showing a configuration pattern of an appointment system according to the first example.

FIG. 9 is a block diagram showing a configuration pattern of an appointment system according to the second example.

FIG. 10 is a block diagram showing a configuration pattern of an appointment system according to the third example.

FIG. 11 is a block diagram showing a configuration pattern of an appointment system according to the third example.

FIG. 12 is a block diagram showing a configuration pattern of an appointment system according to the fourth example.

FIG. 13 is a diagram showing an example of a basic screen.

FIG. 14 is a diagram showing an example of a top screen.

FIG. 15 is a diagram showing an example of a top screen.

FIG. 16A is a diagram showing an example of an appointment guide notification screen.

FIG. 16B is a diagram showing an example of an appointment guide notification screen.

FIG. 17 is a diagram showing an example of a specialized institution confirmation screen.

FIG. 18 is a diagram showing a specialized institution confirmation screen on which a pull down menu is displayed.

FIG. 19 is a diagram showing a first example of an appointment date selection screen.

FIG. 20 is a diagram showing a second example of an appointment date selection screen.

FIG. 21 is a diagram showing an example of an appointment date selection screen for a month following the appointment date selection screen shown in FIG. 20.

FIG. 22 is a diagram showing a third example of an appointment date selection screen.

FIG. 23 is a diagram showing a fourth example of an appointment date selection screen.

FIG. 24 is a diagram showing an example of an appointment time selection screen.

FIG. 25 is a diagram showing an appointment time selection screen in a state in which a candidate appointment time is selected.

FIG. 26 is a diagram showing an example of an appointment content confirmation screen.

FIG. 27 is a diagram showing a first example of an appointment completion screen.

FIG. 28 is a diagram showing a second example of an appointment completion screen.

FIG. 29 is a diagram showing an example of an appointment detail confirmation screen.

FIG. 30 is a diagram showing a screen flow according to the present disclosure.

FIG. 31 is a diagram showing an example of a data configuration of customer history.

FIG. 32 is a diagram showing an example of a data configuration of customer information.

FIG. 33 is a diagram showing an example of a data configuration of a specialized institution list.

FIG. 34A is a diagram showing an example of a data configuration of recommended appointment information.

FIG. 34B is a diagram showing an example of a data configuration of recommended appointment information.

FIG. 35 is a diagram showing an example of a data configuration of a calendar plan list.

FIG. 36 is a diagram showing an example of a data configuration of an appointment available date list.

FIG. 37 is a diagram showing an example of a data configuration of a candidate appointment date list.

FIG. 38 is a sequence diagram showing a first example of an automatic startup process of an appointment application.

FIG. 39 is a sequence diagram showing a second example of an automatic startup process of an appointment application.

FIG. 40 is a sequence diagram showing a startup process of an appointment application when the appointment application is an embedded application.

FIG. 41 is a sequence diagram showing a startup process of an appointment application when the appointment application is an HTML application.

FIG. 42 is a sequence diagram of an overall process sequence of a first example of an appointment system according to the present disclosure.

FIG. 43 is a sequence diagram of an overall process sequence of a second example of an appointment system according to the present disclosure.

FIG. 44 is a sequence diagram of an overall process sequence of a third example of an appointment system according to the present disclosure.

FIG. 45 is a sequence diagram of an overall process sequence of a fourth example of an appointment system according to the present disclosure.

FIG. 46 is a sequence diagram of an overall process sequence of a fifth example of an appointment system according to the present disclosure.

FIG. 47 is a sequence diagram of an overall process sequence of a sixth example of an appointment system according to the present disclosure.

FIG. 48 is a sequence diagram showing a startup process of a calendar application when the calendar application is an embedded application.

FIG. 49 is a sequence diagram showing a startup process of a calendar application when the calendar application is an HTML application.

FIG. 50 is a flow chart showing a first example of an automatic startup process of an appointment application.

FIG. 51 is a flow chart showing a second example of an automatic startup process of an appointment application.

FIG. 52 is a flow chart showing an example of an overall process of an appointment application.

FIG. 53 is a flow chart showing details of a display process (S5202 in FIG. 52. S5407 in FIG. 54, and S5909 in FIG. 59) of a top screen.

FIG. 54 is a flow chart showing an example of a display process (S5203 in FIG. 52. S5307 in FIG. 53, and S5807 in FIG. 58) of a specialized institution confirmation screen.

FIG. 55 is a flow chart showing a first example of a display process (S5204 in FIG. 52 and S5405 in FIG. 54) of an appointment date selection screen.

FIG. 56 is a flow chart showing a second example of a display process (S5204 in FIG. 52 and S5405 in FIG. 54) of an appointment date selection screen.

FIG. 57 is a flow chart showing a third example of a display process (S5204 in FIG. 52 and S5405 in FIG. 54) of an appointment date selection screen.

FIG. 58 is a flow chart representing a continuation of FIGS. 55 to 57.

FIG. 59 is a flow chart showing a display process (S5207 in FIG. 52) of an appointment completion screen.

FIG. 60 is a flow chart showing a process of a first example of an appointment server.

FIG. 61 is a flow chart showing a process of a second example of an appointment server.

FIG. 62 is a flow chart showing a process of a third example of an appointment server.

FIG. 63 is a flow chart showing an example of a process (S6003 in FIG. 60, S6103 in FIG. 61, and S6203 in FIG. 62) of calculating a fee for each appointment available date and time.

FIG. 64 is a flow chart showing a first example of an extraction process of a candidate appointment date by an appointment server or an appointment terminal.

FIG. 65 is a flow chart showing a second example of an extraction process of a candidate appointment date by an appointment server or an appointment terminal.

FIG. 66 is a flow chart showing a third example of an extraction process of a candidate appointment date by an appointment server or an appointment terminal.

FIG. 67 is a flow chart showing a fourth example of an extraction process of a candidate appointment date by an appointment server or an appointment terminal.

FIG. 68 is a flow chart showing a fifth example of an extraction process of a candidate appointment date by an appointment server or an appointment terminal.

### DETAILED DESCRIPTION

(Circumstances Leading to the Invention of an Aspect of the Present Disclosure)

The following processes are performed when a patient (user) of the household apparatus decides an appointment time and date at the medical institution using the medical institution information management system disclosed in Patent Literature 1 described earlier.

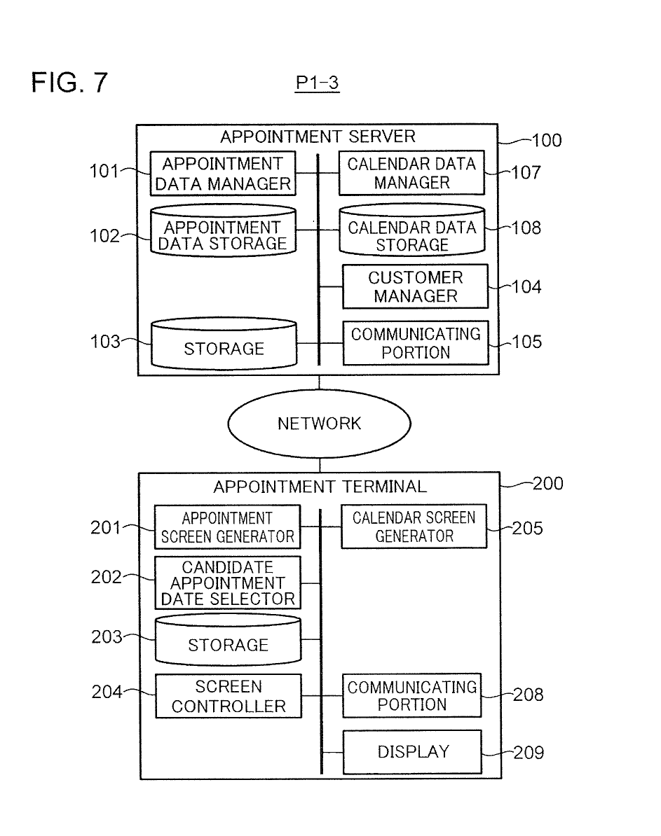

First, the user uses the household apparatus to access the service provider apparatus and downloads a program for the medical institution information management system which is provided by the service provider to the household apparatus from the service provider apparatus. Next, in order to make an appointment at the medical institution, the user starts up the medical institution appointment program on the household apparatus and accesses the service provider apparatus. An initial input screen for inputting information necessary to make an appointment at the medical institution appears on a display screen of the household apparatus. Based on the information input through the initial input screen, the service provider apparatus lists up medical institutions that suit the preferences of the user and displays the medical institutions on the display screen of the household apparatus. The user selects a medical institution at which the user desires to make an appointment from the list of medical institutions. The service provider apparatus transmits patient information of the user to a medical institution apparatus of the selected medical institution, loads appointment available date and time data from the medical institution apparatus, and displays options of appointment available dates and times on the display screen of the household apparatus (for example, paragraph [0028] in Patent Literature 1). For example, a display sample thereof is shown in FIG. 7 in Patent Literature 1. When the user selects a desired date and time from the displayed options of appointment available dates and times, an appointment process for the medical institution is performed via the service provider apparatus (for example, paragraph [0029] in Patent Literature 1).

However, with the medical institution information management system disclosed in Patent Literature 1, options of appointment available dates and times at the medical institution are simply unilaterally presented from the medical institution apparatus to the household apparatus and no consideration whatsoever is given to the convenience of the user.

In addition, recently, service operators provide a communication device of the user with a calendar function via a network. However, an appointment process for the specialized institution by the medical institution information management system is not linked to calendar data that is handled by the calendar function.

There may be cases where the user is already using the calendar function to manage the user's schedule. In such a case, for example, the user must confirm whether the options of appointment available dates and times do not overlap with the other schedules of the user. Therefore, the user causes calendar data that is handled by the calendar function to be displayed on the communication device of the user separately from the display screen of the medical institution information management system. Subsequently, the user must compare the options of appointment available dates and times with calendar data of the user. As a result, the convenience of calendar data provided by the calendar function cannot be advantageously utilized and, instead, the appointment process becomes even more complicated. Therefore, there is a risk that the user may make an erroneous input and may register an incorrect option of an appointment available date and time.

In addition, for example, there may be cases where, even if one of the options of appointment available dates and times overlaps with a date on which the user has plans to go out, an appointment may be made at the medical institution on the same day as the day on which the user has plans to go out if a distance between the medical institution and the outing destination is near. However, the user confirms the options of appointment available dates and times and the dates on which the user has plans to go out by separately viewing the options of appointment available dates and times and the dates on which the user plans to go out. Therefore, confirmation of the options of appointment available dates and times and the dates on which the user plans to go out while comparing the two may be repetitively performed and efficiency of the appointment process may decline. As a result, the user may overlook dates and times at which an appointment can be made at the specialized institution.

Furthermore, for example, even if a plurality of the options of appointment available dates and times are presented, the user may mentally perform a process of excluding dates on which the user has plans to go out from the options of appointment available dates and times. However, in such a case, there is a risk that the user ends up performing a process of making an appointment on a same day as a day on which the user has plans to go out due to misrecognition by the user or an erroneous operation performed by the user when making an appointment.

In order to solve the above problems, the inventors have come up with the inventions with the following aspects.

An aspect of the present disclosure is a method for controlling a communication device having a display and being used in an information management system, the information management system performing an appointment process for a specialized institution via a network connected to the specialized institution,

the communication device having a memory for managing schedule information of a user of the communication device,

the method causing a computer of the communication device to:

display display data on the display, the display data being generated using the managed schedule information and including calendar data, the calendar data representing each day on a per month or per week basis;

access the information management system via the network to acquire appointment available dates and times at the specialized institution from the information management system when performing the appointment process for the specialized institution;

extract appointment available dates and times obtained by excluding each date and time, on which a plan of the user is registered, from the acquired appointment available dates and times at the specialized institution, as candidate appointment dates and times at the specialized institution:

display a display representing candidate appointment time based on the extracted candidate appointment dates and times, in a region corresponding to each day represented in the calendar data; and

display an appointment screen on the display when selection of a region is detected, the region corresponding to the day represented in the calendar data and corresponding to the display representing the candidate appointment time, the appointment screen setting a candidate appointment date and time corresponding to the selected region as an appointment date and time at the specialized institution.

According to the present aspect, when the user wishes to make an appointment at the specialized institution, the user can use the calendar data to cause an appointment screen for making an appointment at the specialized institution to be displayed. In other words, the calendar data doubles as an instruction screen for causing an appointment screen of the specialized institution to be displayed. Therefore, the user can avoid the hassle of separately starting up and displaying the calendar data and the appointment screen and collating the separately displayed calendar data and appointment screen with each other. Therefore, efficiency of the appointment process for the specialized institution can be improved.

In addition, according to the present aspect, the calendar data is displayed on a display of a communication device of the user. Using the calendar data which is a shared medium, the user's plans are confirmed and candidate appointment times at the specialized institution are displayed at the same time on the communication device. Accordingly, the calendar data which is a shared medium is used as described above. As a result, the candidate appointment times at the specialized institution can be presented to the user on a same screen which displays the plans of the user. Therefore, for example, by referring to the candidate appointment time and another plan of the user before or after the candidate appointment time on a same day, determinations such as whether the specialized institution can be reached by the candidate appointment time on the same day may be readily made while considering a location of the other plan or a travel time from the location of the other plan to the specialized institution. As a result, for example, the hassle of having to repetitively adjust appointment dates and times with the specialized institution since the user is unable to reach the specialized institution by the candidate appointment time can be avoided and the appointment process for the specialized institution can be smoothly performed. As described above, both the plans of the user and the plans of the specialized institution can be confirmed at the same time. As a result, the appointment process for the specialized institution can be smoothly performed.

Furthermore, according to the present aspect, candidate appointment times at the specialized institution are displayed in a region corresponding to each day that is represented in the calendar data after excluding dates and times on which plans of the user are registered. Accordingly, since the calendar data that is a shared medium is used as described above, candidate appointment dates and times at the specialized institution can be presented to the user among dates and times on which plans of the user are not yet registered on a same screen as the display of the plans of the user. Therefore, at a stage where candidate appointment times at the specialized institution are displayed in a region corresponding to each day that is represented in the calendar data, dates and times on which plans of the user are registered have already been excluded from the candidate appointment times at the specialized institution. Therefore, the candidate appointment dates and times that are likely to be selected by the user can be presented in an efficient manner. As a result, the hassle of the user of having to exclude dates and times at which the user is unavailable from the candidate appointment dates and times due to the inclusion of such dates and times at which the user is unavailable in the candidate appointment times can be avoided. In addition, the hassle of the user of having to change the user's plans to make room for the candidate appointment dates and times can be avoided. As a result, the appointment process for the specialized institution can be smoothly performed.

In the aspect described above, for example, the method may further cause the computer of the communication device to:

transmit an appointment request to the information management system via the network based on a result of an appointment made using the appointment screen, the appointment request indicating the selected one candidate appointment date and time; and

perform registration of the selected one candidate appointment date and time in the information management system, as the appointment date and time at the specialized institution.

According to the present aspect, a process of registering an appointment date and time at the specialized institution to the information management system is completed.

In the aspect described above, for example, the method may further cause the computer of the communication device to display the appointment date and time at the specialized institution within the one region in the calendar data, when the registration has been completed in the information management system.

For example, when an operation for registering an appointment date and time at the specialized institution in the calendar data occurs separately after performing an appointment process for the specialized institution, since a registration operation in the calendar data is to be performed separately from the appointment process for the specialized institution, the processes become a hassle. If the user forgets to register an appointment date and time at the specialized institution in the calendar data, even if an appointment at the specialized institution is made, the user may fail to remember to visit the specialized institution.

According to the present aspect, the appointment date and time at the specialized institution for which registration in the information management system has been completed is displayed in a region corresponding to the appointment date and time represented in the calendar data. Accordingly, the calendar data is to include the appointment date and time at the specialized institution. In other words, a result of the appointment at the specialized institution is reflected in the calendar data. Therefore, the user need not take the trouble of registering the appointment result in the calendar data. As a result, a situation can be avoided in which, after performing an appointment process for the specialized institution, the user fails to remember to visit the specialized institution because the user forgot to register the appointment date and time at the specialized institution in the calendar data.

In the aspect described above, for example, the method may further cause the computer of the communication device to display on the display a message indicating completion of the registration, in association with the display of the calendar data.

According to the present aspect, the fact that the registration has been completed is displayed on the display in association with the display of the calendar data. Accordingly, the user can be effectively reminded using existing display resources as to for what purpose an appointment had been made and when the appointment was made.

In the aspect described above, for example,

the information management system may collect to manage customer information via the network, the customer information being associated with the user of the communication device, and

a notice may be received from the information management system via the network when it is determined in the information management system based on the customer information that a service, which is in accordance with preferences or history of the user of the communication device, is provided by the specialized institution, wherein the notice indicates that the service is provided by the specialized institution.

According to the present aspect, when it is judged based on the customer information that there is a service provided by a specialized institution in accordance with the preferences or history of a user of the communication device, a notice to that effect is arranged to be received from the information management system via the network. Accordingly, if there is a service provided by a specialized institution in accordance with the preferences or history of the user of the communication device, even when the user is not aware of that fact, a candidate appointment date and time at the specialized institution can be presented based on the customer information. Therefore, for example, in a case where a user receives a dental checkup once every half a year, even when the user has not made an appointment in advance or has forgotten to make an appointment for half a year later, the user can make an appointment at a medical institution for a dental checkup when about half a year has lapsed from a previous dental checkup.

In the aspect described above, for example, the calendar data included in the display data may represent each day of a concerned month,

the method may further cause the computer of the communication device to:

in a case where the each display representing the each candidate appointment time is included in respective displays of the concerned month and a following month, display a display notice in the display data which includes the calendar data representing each day of the concerned month, wherein the display notice indicates that each display representing each remaining candidate appointment time is to be displayed in each region corresponding to each day included in the display of the following month.

For example, when today is the end of a month, a display representing the candidate appointment time may sometimes be included not only in the concerned month but also in a following month. In such a case, when a display representing the candidate appointment time is to be selected in a region corresponding to any of days included in the concerned month that is presently displayed, for example, the user is to be asked to select an appointment date and time in a constrained manner with respect to plans of the user from a range that is narrower than an original range of candidate appointment dates and times. In addition, for example, when a display representing a candidate appointment time is not provided in a region corresponding to days included in a display of the concerned month and a display representing a candidate appointment time is hidden in a region corresponding to days included in a display of the following month, the user may overlook the hidden display and fail to set an appointment date and time.

According to the present aspect, a notice to the effect that a display representing the candidate appointment time is to be provided in a region corresponding to any of days included in the display of the following month is displayed in display data including calendar data representing each day of the concerned month. Accordingly, for example, when a display representing the candidate appointment time is included not only in the display of the concerned month but also included in the display of the following month, an original candidate appointment date and time is to be presented to the user. Therefore, a situation can be avoided where, for example, the user is asked to select an appointment date and time in a constrained manner from a range that is narrower than an original range of candidate appointment dates and times. In addition, for example, when a display representing a candidate appointment time is not included in the display of the concerned month and a display representing a candidate appointment time is included in the display of the following month, the user can be prevented from overlooking the display that is included in the display of the following month. As a result, an appointment date and time that is suitable for the user with respect to plans of the user can be selected from an original range of candidate appointment dates and times without omitting an original candidate appointment date and time.

In the aspect described above, for example, the calendar data included in the display data may represent each day of a concerned week,

the method may further cause the computer of the communication device to:

in a case where the each display representing the each candidate appointment time is included in respective displays of the concerned week and a following week, display a display notice in the display data which includes the calendar data representing each day of the concerned week, wherein the display notice indicates that each display representing each remaining candidate appointment time is to be displayed in each region corresponding to each day included in the display of the following week.

For example, when today is a weekend, a display representing the candidate appointment time may sometimes be included not only in the concerned week but also in a following week. In such a case, when a display representing the candidate appointment time is to be selected in a region corresponding to any of days included in the concerned week that is presently displayed, for example, the user is to be asked to select an appointment date and time in a constrained manner with respect to plans of the user from a range that is narrower than an original range of candidate appointment dates and times. In addition, for example, when a display representing a candidate appointment time is not provided in a region corresponding to days included in a display of the concerned week and a display representing a candidate appointment time is hidden in a region corresponding to days included in a display of the following week, the user may overlook the hidden display and fail to set an appointment date and time.

According to the present aspect, a notice to the effect that a display representing the candidate appointment time is to be provided in a region corresponding to any of days included in the display of the following week is displayed in display data including calendar data representing each day of the concerned week. Accordingly, for example, when a display representing the candidate appointment time is included not only in the display of the concerned week but also included in the display of the following week, an original candidate appointment date and time is to be presented to the user. Therefore, a situation can be avoided where, for example, the user is asked to select an appointment date and time in a constrained manner from a range that is narrower than an original range of candidate appointment dates and times. In addition, for example, when a display representing a candidate appointment time is not included in the display of the concerned week and a display representing a candidate appointment time is included in the display of the following week, the user can be prevented from overlooking the display that is included in the display of the following week. As a result, an appointment date and time that is suitable for the user with respect to plans of the user can be selected from an original range of candidate appointment dates and times without omitting an original candidate appointment date and time.

In the aspect described above, for example,

a region corresponding to a day, which includes a plan of the user in the calendar data, may be displayed in a first display color, and

the each region corresponding to the each day, which includes the each display representing the each candidate appointment time in the calendar data, may be displayed in a second display color different from the first display color.

According to the present aspect, a plan of the user and a candidate appointment time at the specialized institution are distinguished by and displayed in different display colors in the calendar data. Accordingly, a plan of the user and a candidate appointment time at the specialized institution can be easily distinguished from one another. Therefore, a misoperation involving overlooking a candidate appointment time at the specialized institution or a misoperation involving misidentifying a display representing a candidate appointment time at the specialized institution for a display of a plan of the user can be prevented. As a result, the user can be made aware of a candidate appointment date and time at the specialized institution in an appropriate manner and a misoperation involving misidentifying a display representing a candidate appointment time at the specialized institution can be prevented.

In the aspect described above, for example,

a fee for a service provided by the specialized institution may be displayed, when the each display representing the each candidate appointment time is displayed in the each region corresponding to the each day represented in the calendar data.

For example, fees for services provided by the specialized institution may differ depending on types of provided services. Displaying fees for services provided by the specialized institution enables the candidate appointment date and time to be selected while also taking the fees into consideration. According to the present aspect, the user can confirm the fees before selecting an appointment date and time from the candidate appointment dates and times. In addition, for example, the user can select a candidate appointment date and time after confirming the fees.

In the aspect described above, for example, the method may further cause the computer of the communication device to:

in a case where a region corresponding to a given day represented in the calendar data has not an enough area to display all of displays which represent a plurality of candidate appointment times corresponding to the given day, display a display representing a candidate appointment date at the specialized institution in the region corresponding to the given day, without displaying all of the displays representing the plurality of the candidate appointment times corresponding to the given day in the region corresponding to the given day.

A region corresponding to each day represented in the calendar data is limited in terms of display area. For example, there may be cases where another schedule is already registered in a region corresponding to a given day represented in the calendar data. In addition, there may be cases where a plurality of candidate appointment times are provided in a region corresponding to a given day represented in the calendar data even when no other schedules are registered in the region corresponding to the given day. In such cases, all of the displays representing candidate appointment times corresponding to the given day cannot necessarily be displayed.

According to the present aspect, when all of the displays representing candidate appointment times corresponding to a given day represented in the calendar data cannot be displayed in a region corresponding to the given day, a display representing candidate appointment dates at the specialized institution is displayed in the region corresponding to the given day instead of displaying a display representing the candidate appointment time corresponding to the given day. Accordingly, in this case, even when the candidate appointment dates and times are not displayed in the region corresponding to the given day, the fact that the given day is a candidate appointment date at the specialized institution can be notified. Therefore, a situation can be prevented where only a part of displays representing candidate appointment times corresponding to the given day is displayed and an appointment process is performed based on a misidentification that candidate appointment times that are not displayed do not exist.

In such a case, an aspect may be adopted in which, for example, all of the displays representing candidate appointment times corresponding to the given day are separately displayed by selecting a display representing a candidate appointment date at the specialized institution.

In the aspect described above, for example,

the specialized institution may include a medical institution, a restaurant, or a lodging facility.

In the aspect described above, for example,

the communication device may be configured to be able to register the plan of the user in the each region corresponding to the each day represented in the calendar data.

An aspect of the present disclosure is a method for providing information in an information management system which performs an appointment process for a specialized institution via a network connected to the specialized institution, the method comprising:

receiving from a communication device of an authenticated user an inquiry signal and schedule information of the user via the network, the inquiry signal being related to the appointment process for the specialized institution, the schedule information of the user being stored in a memory of the communication device;

acquiring first candidate data using a database in response to the inquiry signal, the database storing appointment available dates and times at the specialized institution, the first candidate data indicating the appointment available dates and times at the specialized institution;

determining, using the acquired first candidate data and the received schedule information, candidate appointment dates and times at the specialized institution by excluding each date and time, on which a plan of the user is included in the received schedule information, from the appointment available dates and times indicated by the acquired first candidate data;

transmitting second candidate data indicating the determined candidate appointment dates and times to the communication device via the network, wherein the communication device displays each display representing each candidate appointment time based on the candidate appointment dates and times indicated by the second candidate data, within each region corresponding to each day represented in calendar data that is generated using the schedule information at the communication device; and

when selection of one region is detected in the communication device, the one region corresponding to one day represented in the calendar data and representing one candidate appointment time, and when an appointment request, which indicates one candidate appointment date and time corresponding to the selected one region, is received from the communication device via the network, registering the one candidate appointment date and time indicated by the appointment request as an appointment date and time in the information management system.

According to the present aspect, the information management system receives the inquiry signal related to the appointment process for the specialized institution and schedule information from the communication device. The information management system uses the received schedule information and the first candidate data indicating appointment available dates and times at the specialized institution to extract appointment available dates and times obtained by excluding each date and time on which a plan of the user is registered from the appointment available dates and times at the specialized institution, as candidate appointment dates and times at the specialized institution. The information management system transmits the second candidate data indicating the extracted candidate appointment dates and times to the communication device.

At the communication device, based on the candidate appointment dates and times represented by the second candidate data, a display representing a candidate appointment time is displayed in a region corresponding to each day represented in calendar data that is generated using schedule information. At the communication device, a selection of a region which corresponds to any day represented in the calendar data and which corresponds to any one display representing a candidate appointment time is detected.

Upon receiving the appointment request indicating the candidate appointment date and time corresponding to the selected region from the communication device via the network, the information management system registers the candidate appointment date and time indicated by the appointment request as the appointment date and time at the specialized institution.

Therefore, even in an aspect configured such that the communication device is responsible for managing schedule information and the information management system is responsible for performing an extraction process of a candidate appointment date and time as is the case of the present aspect, the appointment process for the specialized institution can be facilitated and efficiency thereof can be improved as described above.

In the aspect described above, for example,

the appointment date and time at the specialized institution may be displayed in the communication device within the one region represented in the calendar data when the registration has been completed in the information management system.

For example, when an operation for registering an appointment date and time at the specialized institution in the calendar data occurs separately after performing an appointment process for the specialized institution, since a registration operation in the calendar data is to be performed separately from the appointment process for the specialized institution, the processes become a hassle. If the user forgets to register an appointment date and time at the specialized institution in the calendar data, even if an appointment at the specialized institution is made, the user may fail to remember to visit the specialized institution.

According to the present aspect, the appointment date and time at the specialized institution, for which registration in the information management system has been completed, is displayed on the communication device in a region corresponding to the appointment date and time represented in the calendar data. Accordingly, the calendar data is to include the appointment date and time at the specialized institution. As a result, a situation can be avoided in which, after performing an appointment process for the specialized institution, the user fails to remember to visit the specialized institution because the user forgot to register the appointment date and time at the specialized institution in the calendar data.

In the aspect described above, for example,

the information management system may collect to manage customer information via the network, the customer information being associated with the user of the communication device, and

the method may further comprise:

transmitting a notice to the communication device via the network, when it is determined based on the customer information that a service, which is in accordance with preferences or history of the user of the communication device, is provided by the specialized institution, wherein the notice indicates that the service is provided by the specialized institution.

According to the present aspect, when the information management system judges, based on the customer information, that there is a service provided by a specialized institution in accordance with the preferences or history of a user of the communication device, the information management system transmits a notice to that effect to the communication device via the network. Accordingly, if there is a service provided by a specialized institution in accordance with the preferences or history of the user of the communication device, even when the user is not aware of that fact, a candidate appointment date and time at the specialized institution can be presented based on the customer information. Therefore, for example, in a case where a user receives a dental checkup once every half a year, even when the user has not made an appointment in advance or has forgotten to make an appointment for half a year later, the user can make an appointment at a medical institution for a dental checkup when about half a year has lapsed from a previous dental checkup.

Another aspect of the present disclosure is a method for controlling a communication device having a display and being used in an information management system, the information management system performing an appointment process for a specialized institution via a network connected to the specialized institution,

the information management system managing schedule information of a user of the communication device,

the method causing a computer of the communication device to:

access the information management system via the network to acquire i) schedule information of the user of the communication device and ii) appointment available dates and times at the specialized institution from the information management system when performing the appointment process for the specialized institution;

display display data on the display, the display data being generated using the acquired schedule information with calendar data, the calendar data representing each day on a per month or per week basis;

determine candidate appointment dates and times at the specialized institution by excluding each date and time, on which a plan of the user is acquired from the information management system, from the acquired appointment available dates and times at the specialized institution;

display each display representing each candidate appointment time based on the determined candidate appointment dates and times, in each region corresponding to each day represented in the calendar data; and

display an appointment screen on the display when selection of one region is detected in the calendar data, the one region corresponding to one day and representing one candidate appointment time, the appointment screen being used for setting one candidate appointment date and time corresponding to the selected one region as an appointment date and time at the specialized institution.

According to the present aspect, when performing an appointment process for a specialized institution, the communication device acquires schedule information of the user of the communication device and candidate data indicating appointment available dates and times at the specialized institution from the information management system. The communication device displays on the display display data, which is generated using the acquired schedule information and includes calendar data. The communication device uses the candidate data indicating appointment available dates and times at the specialized institution to extract appointment available dates and times obtained by excluding each date and time on which a plan of the user is registered from the appointment available dates and times at the specialized institution, as candidate appointment dates and times at the specialized institution.

The communication device displays a display representing a candidate appointment time based on the extracted candidate appointment dates and times in a region corresponding to each day represented in the calendar data. When a selection of a region, which corresponds to any day represented in the calendar data and corresponds to any one display representing a candidate appointment time, is detected, the communication device displays on the display an appointment screen in which a candidate appointment date and time corresponding to the selected region is set as an appointment date and time at the specialized institution.

Therefore, even in an aspect configured such that the information management system is responsible for managing schedule information and the communication device is responsible for performing an extraction process of a candidate appointment date and time as is the case of the present aspect, an appointment process for a specialized institution can be facilitated and efficiency thereof can be improved.

In the other aspect described above, for example, the method may further cause the computer of the communication device to:

transmit an appointment request to the information management system via the network based on a result of an appointment made using the appointment screen, the appointment request indicating the selected one candidate appointment date and time; and

perform registration of the selected one candidate appointment date and time in the information management system, as the appointment date and time at the specialized institution.

In the other aspect described above, for example, the method may further cause the computer of the communication device to display the appointment date and time at the specialized institution, within the one region in the calendar data, when the registration has been completed in the information management system.

For example, when an operation for registering an appointment date and time at the specialized institution in the calendar data occurs separately after performing an appointment process for the specialized institution, since a registration operation in the calendar data is to be performed separately from the appointment process for the specialized institution, the processes become a hassle. If the user forgets to register an appointment date and time at the specialized institution in the calendar data, even if an appointment at the specialized institution is made, the user may fail to remember to visit the specialized institution.

According to the present aspect, the appointment date and time at the specialized institution for which registration in the information management system has been completed is displayed in a region corresponding to the appointment date and time represented in the calendar data. Accordingly, the calendar data is to include the appointment date and time at the specialized institution. As a result, a situation can be avoided in which, after performing an appointment process for the specialized institution, the user fails to remember to visit the specialized institution because the user forgot to register the appointment date and time at the specialized institution in the calendar data.

In the other aspect described above, for example, the method may further cause the computer of the communication device to display on the display a message indicating completion of the registration, in association with the display of the calendar data.

In the other aspect described above, for example,

the information management system may collect to manage customer information via the network, the customer information being associated with the user of the communication device, and

a notice may be received from the information management system via the network when it is determined in the information management system based on the customer information that a service, which is in accordance with preferences or history of the user of the communication device, is provided by the specialized institution, wherein the notice indicating that the service is provided by the specialized institution.

According to the present aspect, when it is judged based on the customer information that there is a service provided by a specialized institution in accordance with the preferences or history of a user of the communication device, a notice to that effect is arranged to be received from the information management system via the network. Accordingly, if there is a service provided by a specialized institution in accordance with the preferences or history of the user of the communication device, even when the user is not aware of that fact, a candidate appointment date and time at the specialized institution can be presented based on the customer information. Therefore, for example, in a case where a user receives a dental checkup once every half a year, even when the user has not made an appointment in advance or has forgotten to make an appointment for half a year later, the user can make an appointment at a medical institution for a dental checkup when about half a year has lapsed from a previous dental checkup.

In the other aspect described above, for example,

the communication device may be configured to be able to register the plan of the user in the each region corresponding to the each day represented in the calendar data.

Another aspect of the present disclosure is a method for providing information in an information management system which performs an appointment process for a specialized institution via a network connected to the specialized institution, the method comprising:

receiving an inquiry signal from a communication device of an authenticated user via the network, the inquiry signal being related to the appointment process for the specialized institution;

acquiring schedule information of the user of the communication device using a first database based on the inquiry signal, the first database storing the schedule information of the user of the communication device;

acquiring first candidate data using a second database based on the inquiry signal, the second database storing appointment available dates and times at the specialized institution, the first candidate data indicating the appointment available dates and times at the specialized institution;

determining, using the acquired schedule information and the acquired first candidate data, candidate appointment dates and times obtained by excluding each date and time, on which a plan of the user is included in the acquired schedule information, from the appointment available dates and times at the specialized institution indicated by the acquired first candidate data;

transmitting second candidate data indicating the determined candidate appointment dates and times to the communication device via the network, wherein the communication device displays each display representing each candidate appointment time based on the candidate appointment dates and times indicated by the second candidate data, within each region corresponding to each day represented in calendar data that is generated using the schedule information at the communication device; and

when selection of one region is detected in the communication device, the one region corresponding to one day represented in the calendar data and representing one candidate appointment times, and when an appointment request, which indicates one candidate appointment date and time corresponding to the selected one region, is received from the communication device via the network, registering the one candidate appointment date and time indicated by the appointment request as an appointment date and time at the specialized institution in the information management system.

According to the present aspect, the information management system acquires schedule information of a user from a first database based on an inquiry signal from the communication device. The information management system acquires first candidate data indicating appointment available dates and times at the specialized institution based on an inquiry signal from the communication device. The communication device uses the schedule information and the first candidate data to extract appointment available dates and times obtained by excluding each date and time on which a plan of the user is registered from the appointment available dates and times at the specialized institution, as candidate appointment dates and times at the specialized institution. The information management system transmits second candidate data indicating the extracted candidate appointment dates and times to the communication device.

At the communication device, based on the candidate appointment dates and times represented by the second candidate data, a display representing a candidate appointment time is displayed in a region corresponding to each day represented in calendar data that is generated by the communication device. At the communication device, a selection of a region, which corresponds to any day represented in the calendar data and corresponds to any one display representing a candidate appointment time, is detected.

Upon receiving an appointment request indicating a candidate appointment date and time corresponding to the selected region from the communication device via the network, the information management system registers the candidate appointment date and time indicated by the appointment request as an appointment date and time at the specialized institution.

Therefore, even in an aspect configured such that the information management system is responsible for both managing schedule information and performing an extraction process of a candidate appointment date and time as is the case of the present aspect, an appointment process for the specialized institution can be facilitated and efficiency thereof can be improved.

In the other aspect described above, for example,

the appointment date and time at the specialized institution may be displayed in the communication device within the one region represented in the calendar data, when the registration has been completed in the information management system.

For example, when an operation for registering an appointment date and time at the specialized institution in the calendar data occurs separately after performing an appointment process for the specialized institution, since a registration operation in the calendar data is to be performed separately from the appointment process for the specialized institution, the processes become a hassle. If the user forgets to register an appointment date and time at the specialized institution in the calendar data, even if an appointment at the specialized institution is made, the user may fail to remember to visit the specialized institution.

According to the present aspect, the appointment date and time at the specialized institution, for which registration in the information management system has been completed, is displayed on the communication device in a region corresponding to the appointment date and time represented in the calendar data. Accordingly, the calendar data is to include the appointment date and time at the specialized institution. As a result, a situation can be avoided in which, after performing an appointment process for the specialized institution, the user fails to remember to visit the specialized institution because the user forgot to register the appointment date and time at the specialized institution in the calendar data.

In the other aspect described above, for example,

the information management system may collect to manage customer information via the network, the customer information being associated with the user of the communication device, and

the method may further comprise:

transmitting a notice to the communication device via the network, when it is determined based on the customer information that a service, which is in accordance with preferences or history of the user of the communication device, is provided by the specialized institution, wherein the notice indicates that the service is provided by the specialized institution.

According to the present aspect, when the information management system judges, based on the customer information, that there is a service provided by a specialized institution in accordance with the preferences or history of a user of the communication device, the information management system transmits a notice to that effect to the communication device via the network. Accordingly, if there is a service provided by a specialized institution in accordance with the preferences or history of the user of the communication device, even when the user is not aware of that fact, a candidate appointment date and time at the specialized institution can be presented based on the customer information. Therefore, for example, in a case where a user receives a dental checkup once every half a year, even when the user has not made an appointment in advance or has forgotten to make an appointment for half a year later, the user can make an appointment at a medical institution for a dental checkup when about half a year has lapsed from a previous dental checkup.

### Embodiment

Hereinafter, an appointment system according to the present disclosure will be described. The appointment system according to the present disclosure is a system that manages appointments at a specialized institution such as a hospital and a restaurant.

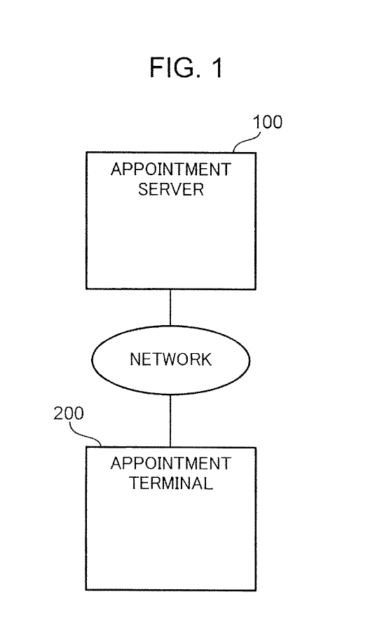

FIG. 1 is a diagram showing a first example of an overall configuration of the appointment system according to the present disclosure. The appointment system according to the first example includes an appointment server 100 and an appointment terminal 200. The appointment server 100 and the appointment terminal 200 are connected so as to be capable of communicating with each other via a network. For example, a public communication network such as the Internet or a mobile phone communication network can be adopted as the network over which various types of data are transmitted and received using the TCP/IP communication protocol.

The appointment server 100 is, for example, a cloud server constituted by one or more computers. In addition, the appointment server 100 receives information related to an appointment that is input by a user through the appointment terminal 200 and manages the information. In this case, for example, the appointment server 100 may be a service provider server that is managed by a service provider who provides a service according to the present disclosure to the user.

Moreover, in the appointment system according to the first example, the appointment server 100 corresponds to an example of the information management system.

The appointment terminal 200 is constituted by, for example, a button type mobile phone, a portable computer such as a smartphone and a tablet terminal, or a stationary computer. In addition, the appointment terminal 200 receives an appointment instruction from the user and transmits information related to the appointment to the appointment server 100 via the network. In this case, as the appointment terminal 200, a computer that performs the role of a home server in a house of the user may be adopted or a computer that does not perform such a role may be adopted. Moreover, while only one appointment terminal 200 is shown in FIG. 1, a plurality of appointment terminals 200 may exist so as to correspond to a plurality of users.

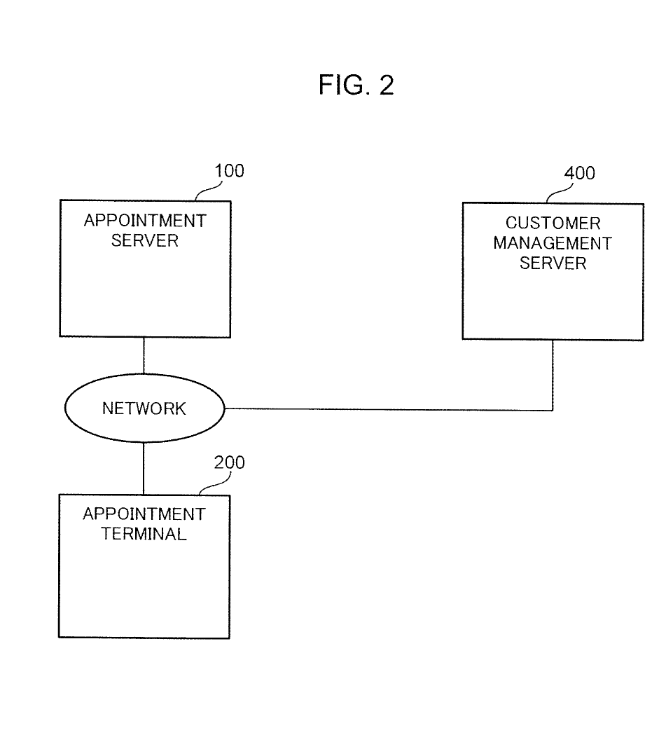

FIG. 2 is a diagram showing a second example of an overall configuration of the appointment system according to the present disclosure. The appointment system according to the second example differs from the appointment system according to the first example in that a customer management server 400 is further provided. The customer management server 400 is, for example, a cloud server constituted by one or more computers. In addition, the customer management server 400 manages each user. In the appointment system according to the second example, the customer management server 400 is given the responsibility of managing customers. In this case, as the customer management server 400, a manufacturer server can be adopted which is used by a manufacturer of an electric appliance to provide various services related to the electric appliance to a user having purchased the electric appliance. Moreover, in the appointment system according to the second example, the appointment server 100 and the customer management server 400 correspond to an example of the information management system.

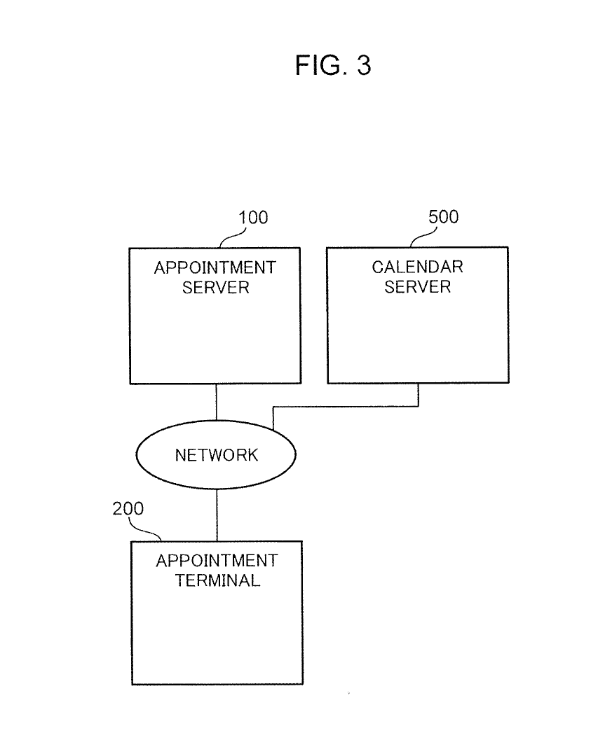

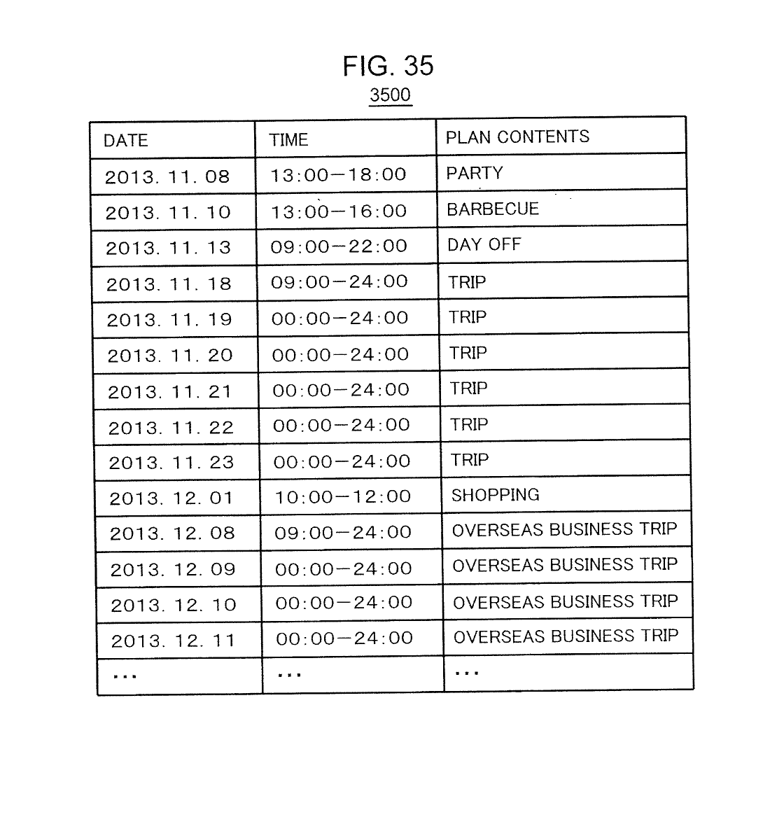

FIG. 3 is a diagram showing a third example of an overall configuration of the appointment system according to the present disclosure. The appointment system according to the third example differs from the appointment system according to the first example in that a calendar server 500 is further provided. The calendar server 500 is, for example, a cloud server constituted by one or more computers. In addition, the calendar server 500 manages schedule information of each of one or more users. In this case, as the schedule information, for example, a calendar plan list 3500 shown in FIG. 35 is adopted.

While schedule information is managed by the appointment server 100 or the appointment terminal 200 in the appointment systems according to the first and second examples, the calendar server 500 is given the responsibility of managing schedule information in the appointment system according to the third example. Moreover, in the appointment system according to the third example, the appointment server 100 and the calendar server 500 correspond to an example of the information management system.

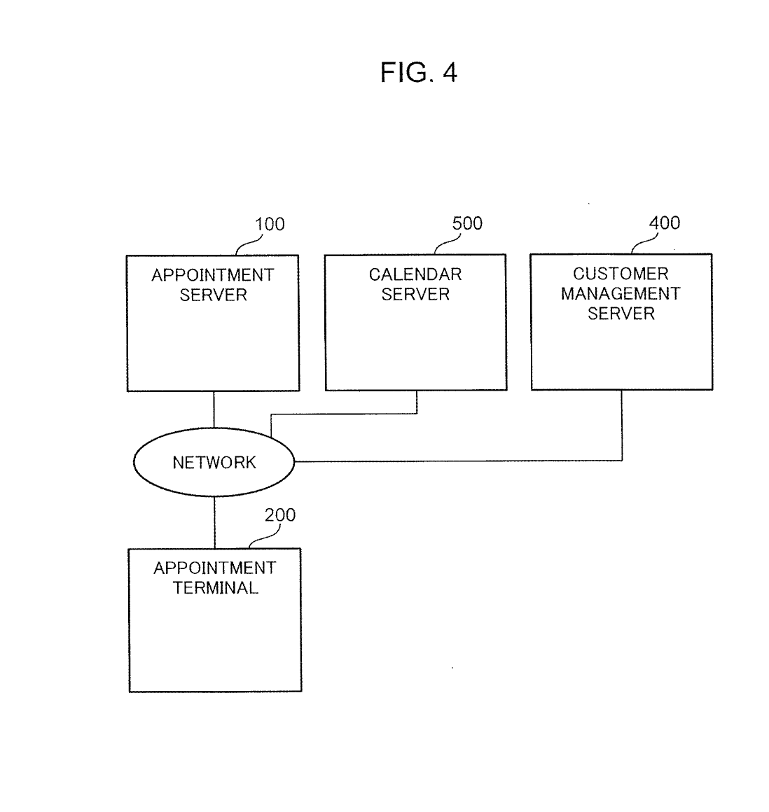

FIG. 4 is a diagram showing a fourth example of an overall configuration of the appointment system according to the present disclosure. The appointment system according to the fourth example incorporates all of the servers that have been described in the first to third examples. In other words, in the appointment system according to the fourth example, the customer management server 400 and the calendar server 500 are present as servers in addition to the appointment server 100.

In the appointment system according to the fourth example, the calendar server 500 is given the responsibility of managing schedule information and the customer management server 400 is given the responsibility of managing customers. Moreover, in the appointment system according to the fourth example, the appointment server 100, the customer management server 400, and the calendar server 500 correspond to an example of the information management system.

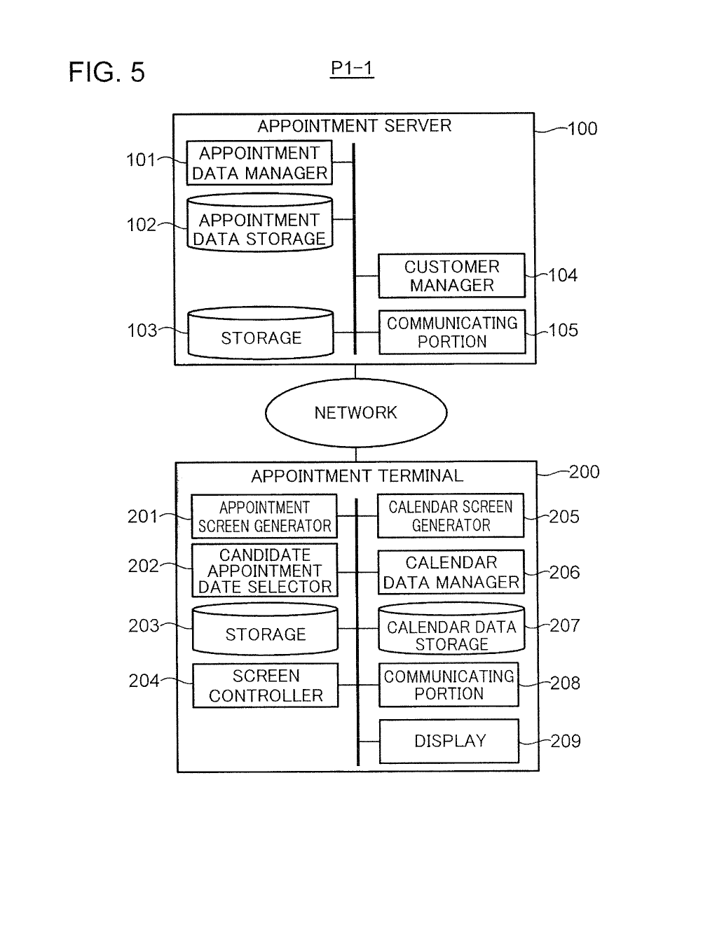

FIG. 5 is a block diagram showing a configuration pattern P1-1 of the appointment system according to the first example. In the appointment system shown in FIG. 5, the appointment server 100 includes an appointment data manager 101, an appointment data storage 102, a storage 103, a customer manager 104, and a communicating portion 105.

The appointment data manager 101 causes the appointment data storage 102 to store information related to an appointment that is input by a user through the appointment terminal 200 and manages the information related to the appointment. The appointment data manager 101 manages a specialized institution list 3300 and a specialized institution service menu (to be described later). Examples of a specialized institution include a hospital, a hotel, and a restaurant.

The appointment data storage 102 is constituted by, for example, a non-volatile rewritable storage device and stores information related to an appointment.

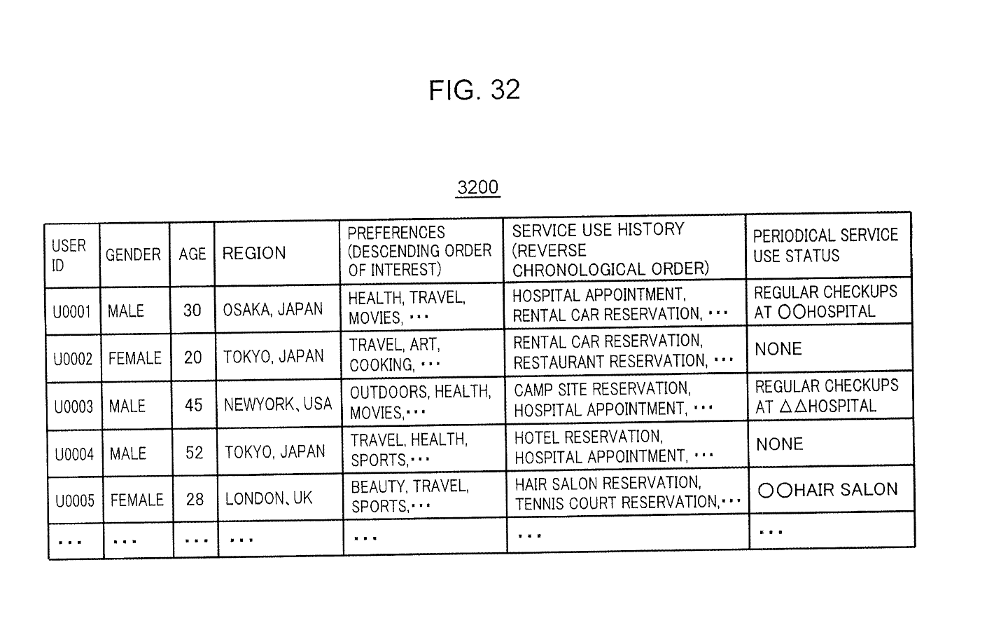

The storage 103 is constituted by, for example, a non-volatile rewritable storage device and stores various types of data that are used by the appointment server 100 when performing various processes. In the example shown in FIG. 5, since the customer manager 104 is present in the appointment server 100, the storage 103 stores customer information that is managed by the customer manager 104. In this case, for example, customer information 3200 shown in FIG. 32 can be adopted as the customer information.

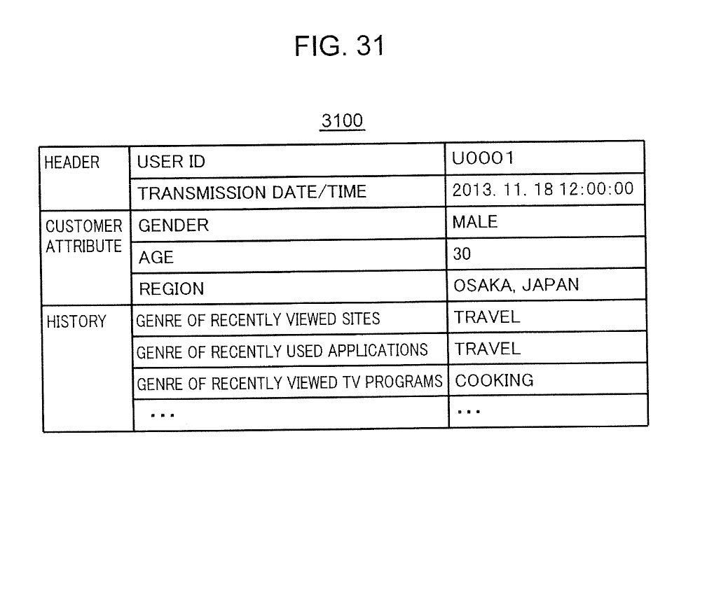

Based on customer history 3100 (FIG. 31) that is transmitted from the appointment terminal 200, the customer manager 104 generates the customer information 3200, stores the generated customer information 3200 in the storage 103, and manages the customer information 3200.

The communicating portion 105 connects the appointment server 100 to the network and enables the appointment server 100 to communicate with the appointment terminal 200 and the like.

In FIG. 5, the appointment terminal 200 includes an appointment screen generator 201, a candidate appointment date selector 202, a storage 203, a screen controller 204, a calendar screen generator 205, a calendar data manager 206, a calendar data storage 207, a communicating portion 208, and a display 209.

The appointment screen generator 201 generates image data of various screens used by an appointment application that causes a computer to function as the appointment terminal 200 and displays the image data on the display 209.

The candidate appointment date selector 202 extracts, from appointment available dates and times that represent dates and times at which an appointment can be made at a specialized institution, appointment available dates and times from which dates and times on which plans of the user are registered have been excluded as candidate appointment dates and times at the specialized institution.

Alternatively, the candidate appointment date selector 202 extracts, from appointment available dates that represent dates on which an appointment can be made at a specialized institution, appointment available dates from which dates on which plans of the user are registered have been excluded as candidate appointment dates at the specialized institution. Hereinafter, processes of extracting candidate appointment dates and times or candidate appointment dates which is performed by the candidate appointment date selector 202 will be collectively described as an extraction process of a candidate appointment date.

The storage 203 stores various data that is used by the appointment terminal 200 to perform various processes.

The screen controller 204 detects various operations performed by the user on the various screens displayed on the display 209. In the present disclosure, a touch panel included in the display 209 is adopted as an operating device that accepts operations by the user. Therefore, the screen controller 204 senses operations such as tapping, swiping, and flicking input by the user through the touch panel. In addition, when the screen controller 204 senses an operation involving tapping a GUI component displayed on the display 209, the screen controller 204 determines that the GUI component has been selected by the user. Moreover, when a keyboard or a mouse is adopted as the operating device, the screen controller 204 may sense an operation by the user on the keyboard or an operation by the user using the mouse. Furthermore, when the screen controller 204 detects an operation by the user during startup of the appointment application, the screen controller 204 notifies the detected contents to the appointment screen generator 201 and causes the appointment screen generator 201 to detect the operation by the user.

The calendar screen generator 205 generates image data of various screens used by a calendar application and displays the image data on the display 209. Moreover, the calendar application is an application that is installed in existing smartphones and the calendar screen generator 205 is a program module that is responsible for generating a calendar screen. In addition, in the present disclosure, a calendar screen is displayed in various screens of the appointment application. Image data of the screens of the appointment application is generated by the appointment screen generator 201. As such, the calendar screen that is generated by the calendar screen generator 205 will not be particularly described.

The calendar data manager 206 generates schedule information, stores the schedule information in the calendar data storage 207, and manages the schedule information.

The calendar data storage 207 stores schedule information.

The communicating portion 208 connects the appointment terminal 200 to the network and enables the appointment terminal 200 to communicate with the appointment server 100 and the like.

The display 209 is constituted by, for example, a liquid crystal display including a touch panel.

Moreover, in the appointment server 100 shown in FIG. 5, the appointment data manager 101 is realized by, for example, having a processor of the appointment server 100 execute an appointment server program that causes a computer to function as the appointment server 100. Furthermore, the appointment data storage 102 and the storage 103 are constituted by, for example, a rewritable non-volatile storage device. The communicating portion 105 is constituted by a communication device such as a modem.

In addition, in FIG. 5, the appointment screen generator 201 and the candidate appointment date selector 202 are realized by having a processor of the appointment terminal 200 execute an appointment application. Furthermore, the calendar screen generator 205 and the calendar data manager 206 are realized by having the processor of the appointment terminal 200 execute a calendar application.

In addition, the storage 203 and the calendar data storage 207 are constituted by, for example, a rewritable non-volatile storage device. Furthermore, the screen controller 204 is realized by, for example, having the processor of the appointment terminal 200 execute an operation system. The communicating portion 208 is constituted by a communication device such as a modem.

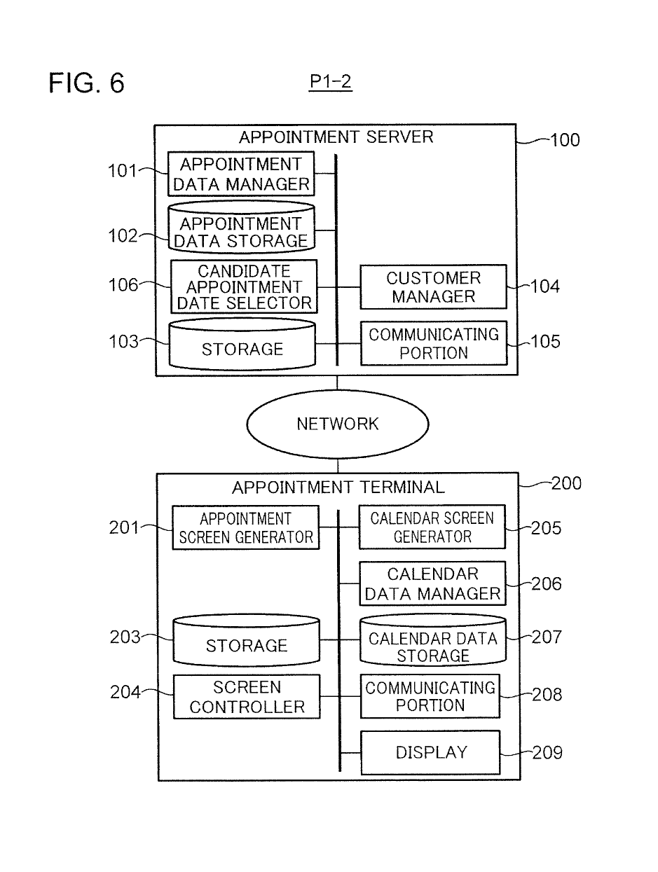

FIG. 6 is a block diagram showing a configuration pattern P1-2 of the appointment system according to the first example. In the configuration pattern P1-2, an extraction process of a candidate appointment date is performed by the appointment server 100 and management of schedule information is performed by the appointment terminal 200. To this end, the appointment server 100 includes a candidate appointment date selector 106.

FIG. 7 is a block diagram showing a configuration pattern P1-3 of the appointment system according to the first example. In the configuration pattern P1-3, an extraction process of a candidate appointment date is performed by the appointment terminal 200 and management of schedule information is performed by the appointment server 100. Therefore, the appointment terminal 200 includes the candidate appointment date selector 202 and the appointment server 100 includes a calendar data manager 107 and a calendar data storage 108. In this pattern, the calendar screen generator 205 is constituted by a browser which, for example, acquires schedule information that is described in a script language (for example, HTML and JavaScript (registered trademark)) from the appointment server 100 and displays the schedule information on the display 209.

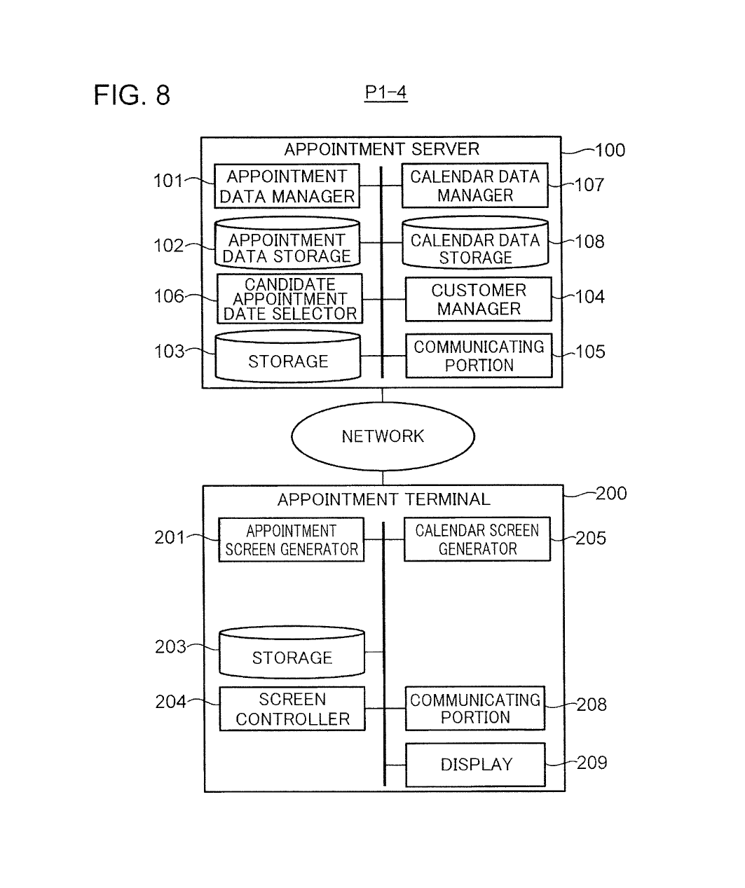

FIG. 8 is a block diagram showing a configuration pattern P1-4 of the appointment system according to the first example. In the configuration pattern P1-4, an extraction process of a candidate appointment date and management of schedule information are performed by the appointment server 100. Therefore, the appointment server 100 includes the candidate appointment date selector 106, the calendar data manager 107, and the calendar data storage 108.

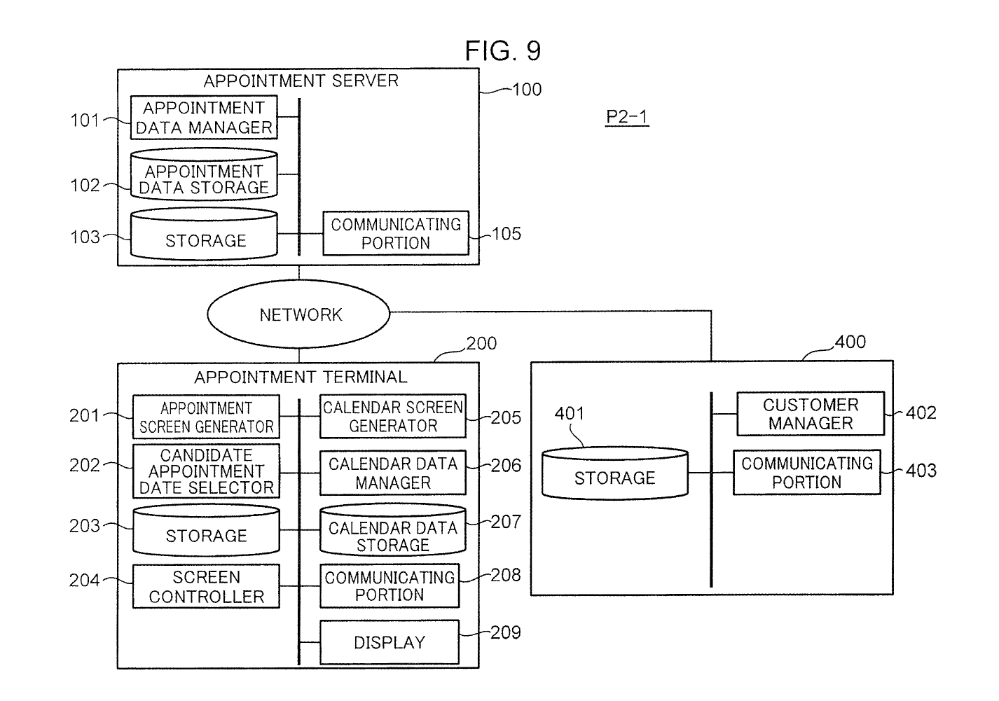

FIG. 9 is a block diagram showing a configuration pattern P2-1 of the appointment system according to the second example. In the configuration pattern P2-1, the customer management server 400 has been added to the configuration patterns P1-1 to P1-4. The customer management server 400 includes a storage 401, a customer manager 402, and a communicating portion 403.

The storage 401 stores, for example, customer information 3200 (FIG. 32) that is information related to a user.

The customer manager 402 stores customer information 3200 in the storage 401 and manages the customer information 3200.

The communicating portion 403 connects the customer management server 400 to the network.

In FIG. 9, the customer manager 402 is realized by, for example, having a processor of the customer management server 400 execute a customer management server program that causes a computer to function as the customer management server 400. Moreover, in FIG. 9, an extraction process of a candidate appointment date and management of schedule information are performed by the appointment terminal 200. However, this simply represents an example and even when the appointment system according to the second example is adopted, the extraction process of a candidate appointment date may be performed by any of the appointment server 100 and the appointment terminal 200 and the management of schedule information may be performed by any of the appointment server 100 and the appointment terminal 200.

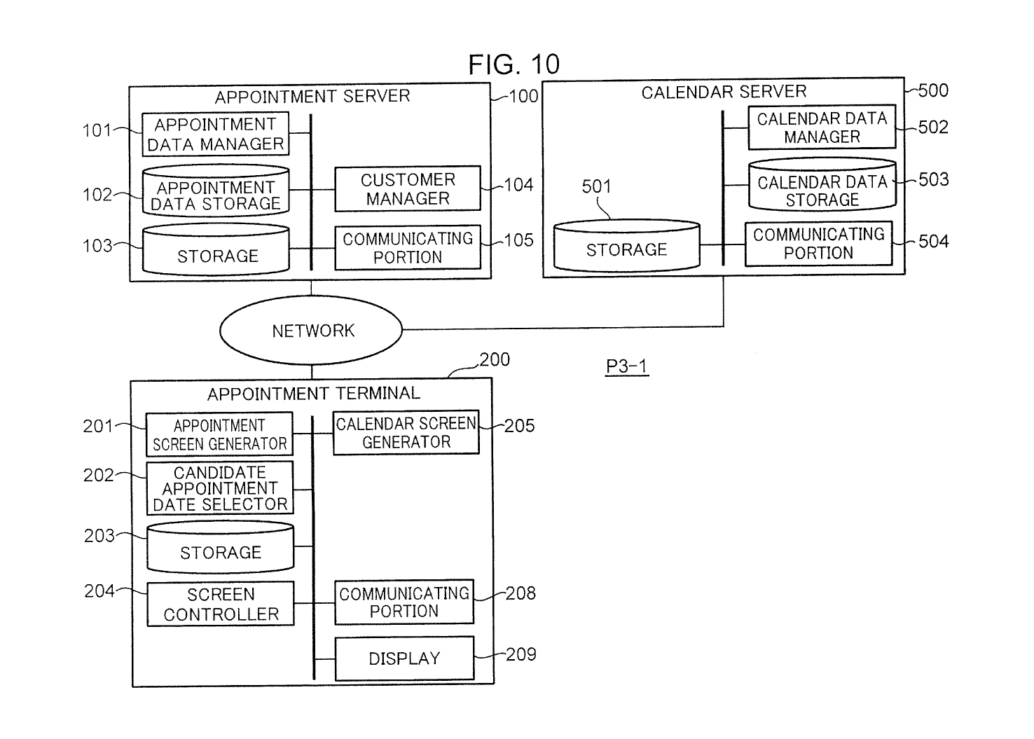

FIG. 10 is a block diagram showing a configuration pattern P3-1 of the appointment system according to the third example. In the configuration pattern P3-1, the calendar server 500 has been added to the configuration patterns P1-1 to P1-4.

The calendar server 500 includes a storage 501, a calendar data manager 502, a calendar data storage 503, and a communicating portion 504.

The storage 501 stores various types of data that are used by the calendar server 500 to perform various processes.

The calendar data manager 502 stores schedule information of each of one or more users in the calendar data storage 503 and manages the schedule information.

The calendar data storage 503 stores schedule information.

The communicating portion 504 connects the calendar server 500 to the network.

The calendar data manager 502 is realized by, for example, having a processor of the calendar server 500 execute a calendar server program that causes a computer to function as the calendar server 500. The storage 501 and the calendar data storage 503 are constituted by, for example, a rewritable non-volatile storage device. The communicating portion 504 is constituted by a communication device such as a modem. In the configuration pattern P3-1, an extraction process of a candidate appointment date is performed by the appointment terminal 200 and management of schedule information is performed by the calendar server 500. Therefore, calendar data managers and calendar data storages have been omitted from the appointment server 100 and the appointment terminal 200. Accordingly, the calendar screen generator 205 is constituted by a browser which generates image data of calendar data using the schedule information and which displays the image data on the display 209.

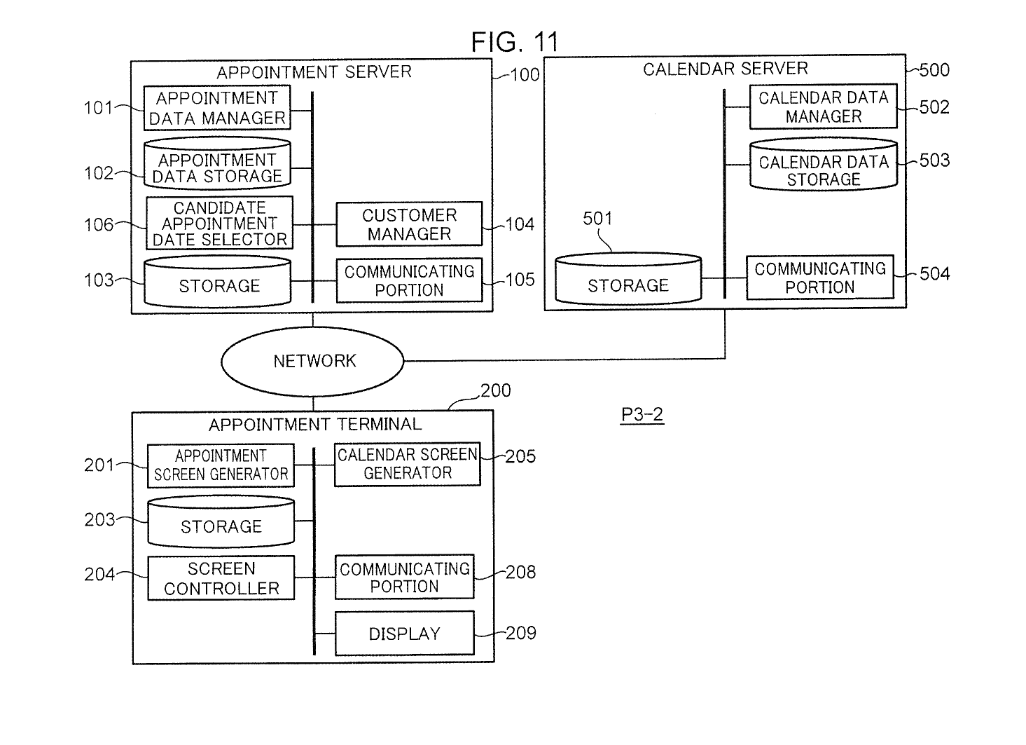

FIG. 11 is a block diagram showing a configuration pattern P3-2 of the appointment system according to the third example. The configuration pattern P3-2 differs from the configuration pattern P3-1 in that an extraction process of a candidate appointment date is performed by the appointment server 100. Therefore, the appointment server 100 includes the candidate appointment date selector 106.

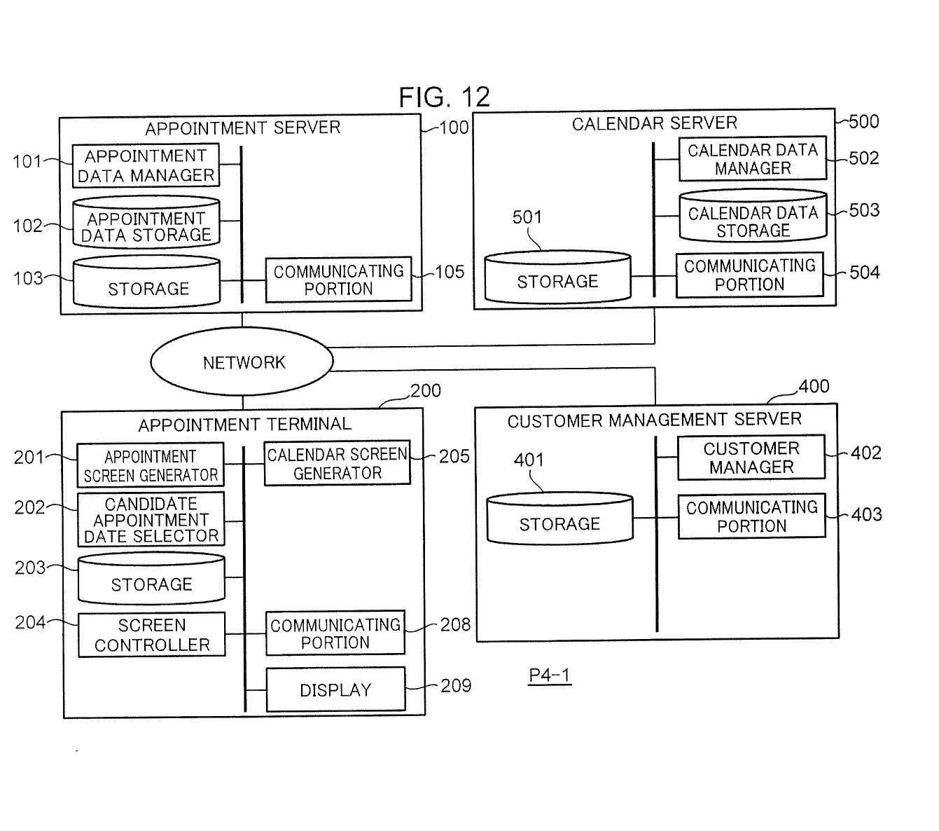

FIG. 12 is a block diagram showing a configuration pattern P4-1 of the appointment system according to the fourth example. In the configuration pattern P4-1, the calendar server 500 and the customer management server 400 have been added to the configuration patterns P1-1 to P1-4. In other words, in the configuration pattern P4-1, management of schedule information is performed by the calendar server 500 and management of customer information is performed by the customer management server 400. In addition, in the configuration pattern P4-1, an extraction process of a candidate appointment date is performed by the appointment terminal 200. To this end, the appointment terminal 200 includes the candidate appointment date selector 202.

Alternatively, in the configuration pattern P4-1, an extraction process of a candidate appointment date may be performed by the appointment server 100.

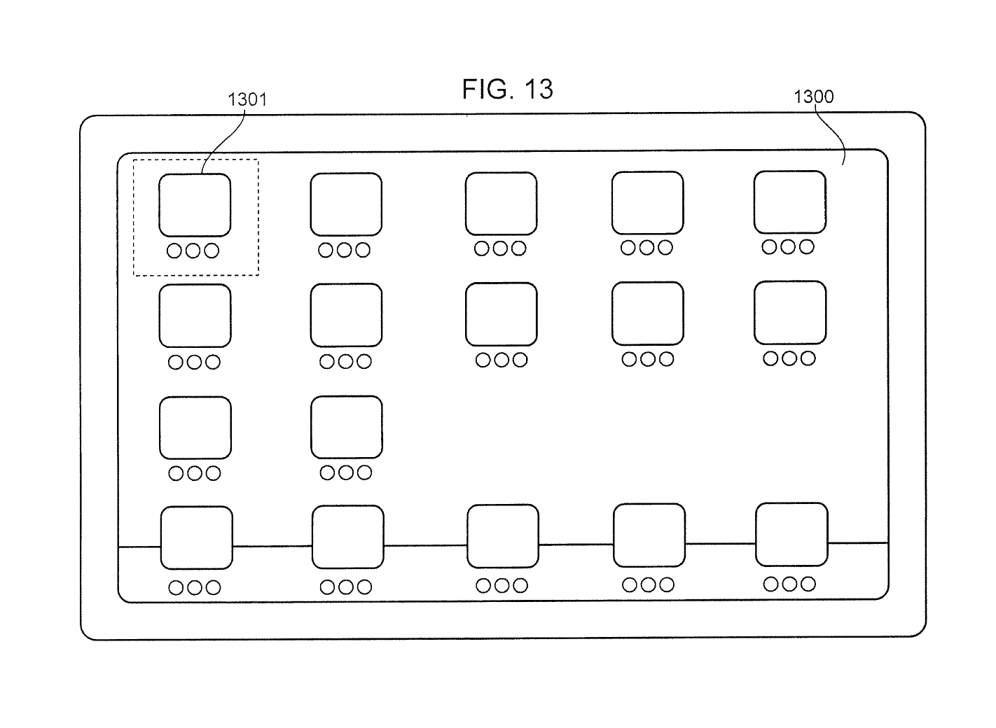

FIG. 13 is a diagram showing an example of a basic screen 1300. The basic screen 1300 is a basic screen that is displayed by an ordinary smartphone or a tablet terminal. The basic screen 1300 displays one or more icons for executing one or more applications in a matrix pattern. In addition, the one or more icons include an appointment application icon 1301 for executing an appointment application. In the example shown in FIG. 13, the appointment application icon 1301 is arranged at a top left position.

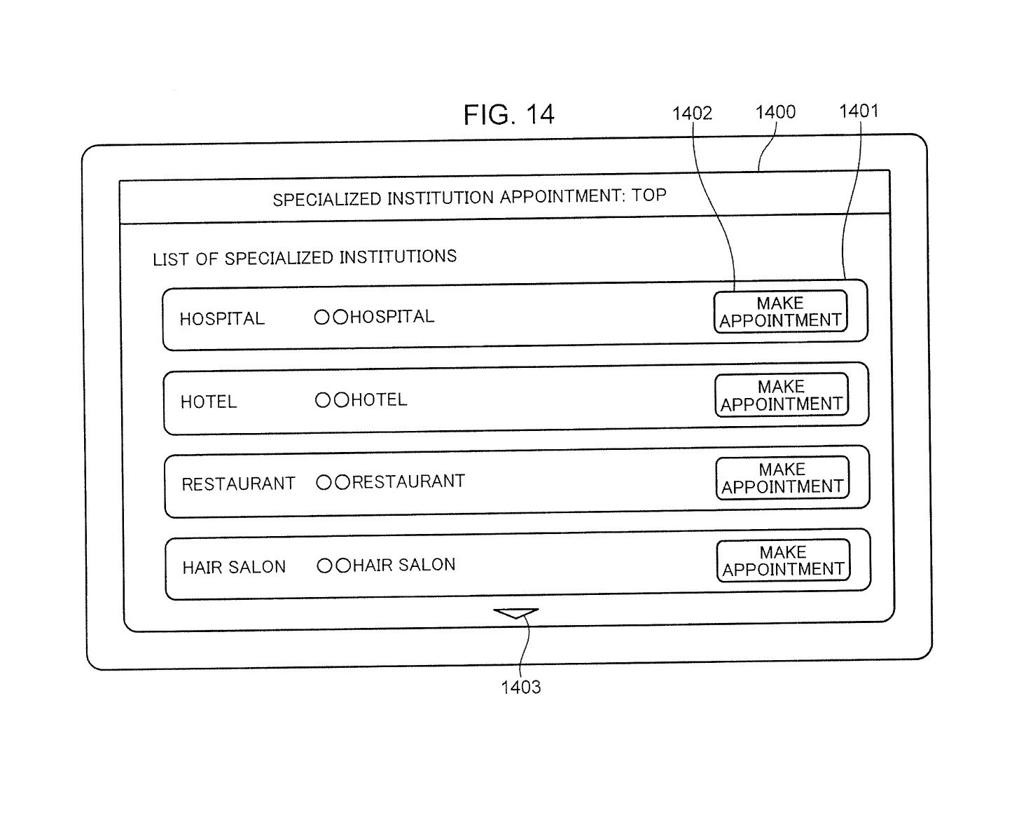

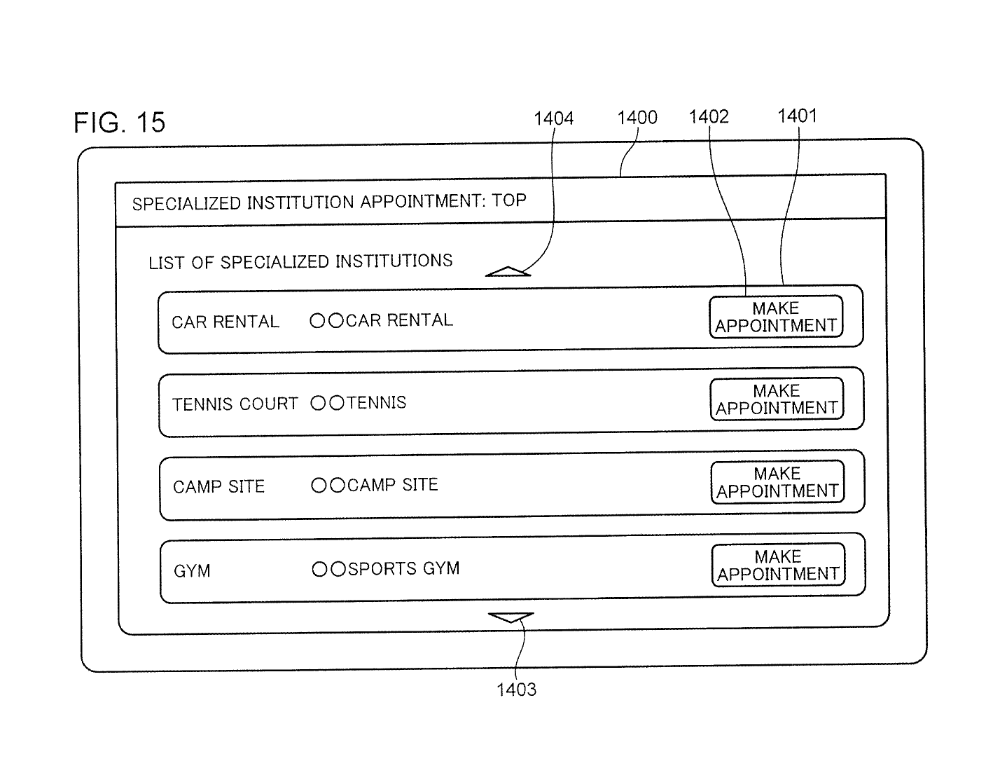

FIGS. 14 and 15 are diagrams showing examples of a top screen 1400. The top screen 1400 is a top screen of the appointment application and is a screen which is displayed on the display 209 when the appointment application icon 1301 is tapped on the basic screen 1300.

A heading that reads “Specialized institution appointment: Top” is displayed in an upper part of the top screen 1400 to explicitly indicate that the screen is a top screen of the appointment application. Characters reading “list of specialized institutions” are displayed below the heading to explicitly indicate that a list of specialized institutions at which appointments can be made is displayed below.

Specialized institution display fields 1401 representing specialized institutions at which appointments can be made are vertically aligned below the characters. The specialized institution display field 1401 displays a type of a specialized institution, a name of the specialized institution, and an appointment button 1402. In the example shown in FIG. 14, “hospital”, “hotel”, “restaurant”, and “hair salon” are displayed as specialized institution types. The topmost specialized institution display field 1401 displays “hospital” as a specialized institution type and “•• Hospital” as a specialized institution name.

A next page button 1403 is displayed in a lower part of the top screen 1400. When the next page button 1403 is tapped, the screen controller 204 detects the tapping. As a result, the appointment screen generator 201 displays a top screen 1400 for a second page which displays a list of specialized institution display fields 1401 that could not be displayed on the first page.

FIG. 15 shows an example of the top screen 1400 of the second page. In the example shown in FIG. 15, “car rental”, “tennis court”, “camp site”, and “gym” are displayed as specialized institution types. The second-from-top specialized institution display field 1401 displays “tennis court” as a specialized institution type and “•• Tennis” as a specialized institution name.

A previous page button 1404 is displayed in an upper part of the top screen 1400 shown in FIG. 15. When the previous page button 1404 is tapped in a state where the top screen 1400 shown in FIG. 15 is displayed, the appointment screen generator 201 displays the top screen 1400 of the first page that is shown in FIG. 14.

Moreover, the present disclosure is not limited to the specialized institutions shown in FIGS. 14 and 15. For example, a library may be included as a specialized institution. In this case, the user may make a reservation for borrowing a book from the library.

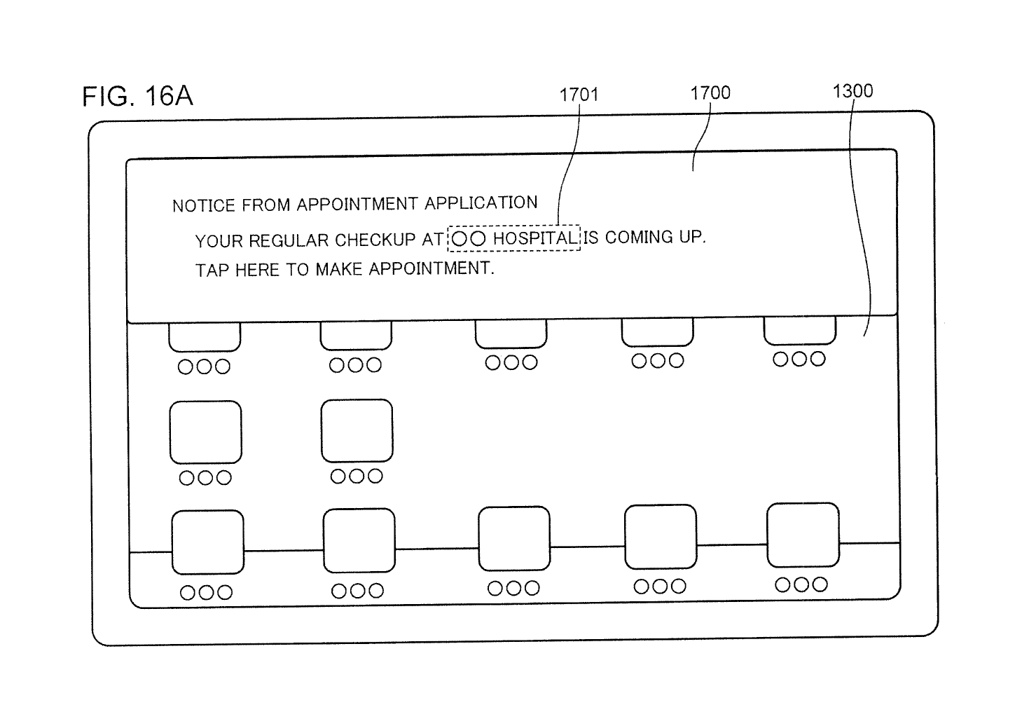

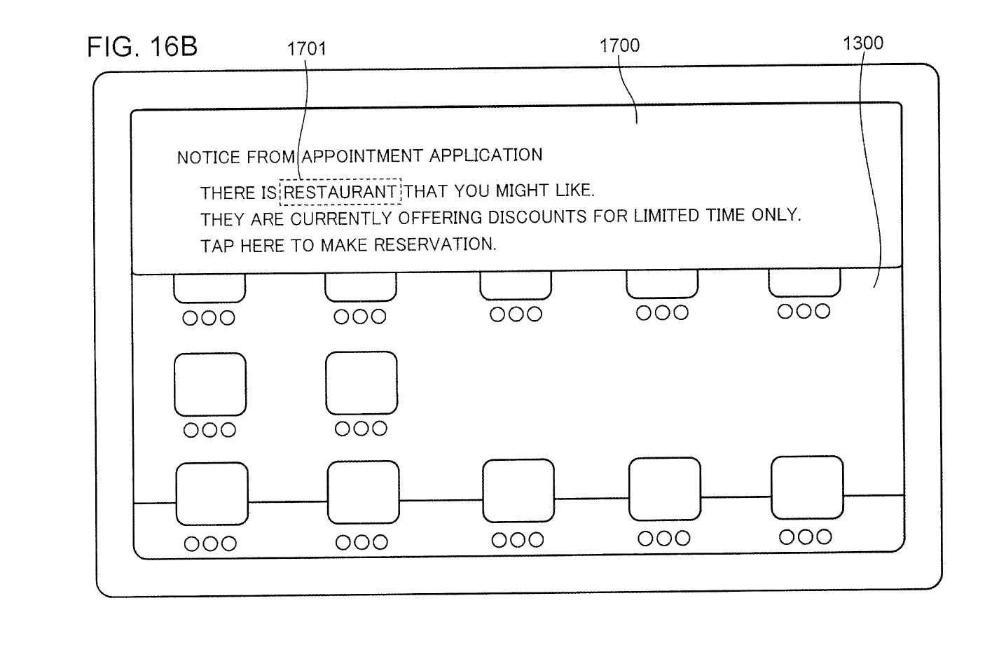

FIG. 16A is a diagram showing an example of an appointment guide notification screen 1700. The appointment guide notification screen 1700 is a notification screen of a push notification that is transmitted to the appointment terminal 200 of a user when the appointment system detects registration of a specialized institution that is in accordance with the preferences or history of the concerned user. In this case, the appointment guide notification screen 1700 is displayed overlaid on the basic screen 1300 in a region that occupies about a top one-third of the basic screen 1300.

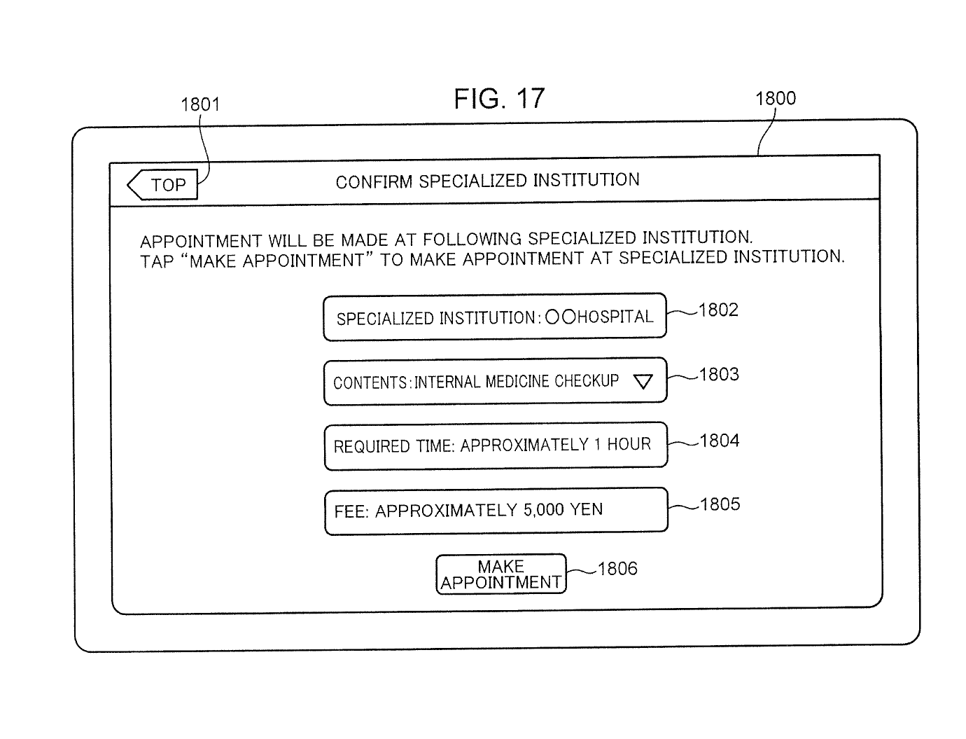

A text reading “Notice from appointment application. Your regular checkup at the •• Hospital is coming up. Tap here to make an appointment.” is presented on the appointment guide notification screen 1700 shown in FIG. 16A to explicitly indicate that a checkup time at the hospital is drawing near. A type or a name 1701 of a specialized institution is included in the text presented on the appointment guide notification screen 1700. In the example shown in FIG. 16A, since guidance for an appointment at a hospital is provided, “•• Hospital” is displayed as a name of a specialized institution. When the screen controller 204 detects that the user has tapped the appointment guide notification screen 1700, the appointment screen generator 201 causes a specialized institution confirmation screen 1800 (FIG. 17 to be described later) to be displayed on the display 209.

FIG. 16B is a diagram showing another example of the appointment guide notification screen 1700. A text reading “Notice from appointment application. There is a restaurant that you might like. They are currently offering discounts for a limited time only. Tap here to make a reservation.” is presented on the appointment guide notification screen 1700 shown in FIG. 16B to explicitly indicate that information on a new specialized institution has been registered. In the example shown in FIG. 16B, since guidance for a reservation at a restaurant is provided. “restaurant” is displayed as the type or the name 1701 of the specialized institution.

FIG. 17 is a diagram showing an example of the specialized institution confirmation screen 1800. The specialized institution confirmation screen 1800 is a screen for causing a user to confirm contents of an appointment at a specialized institution.

A heading that reads “Confirm specialized institution” is presented in an upper part of the specialized institution confirmation screen 1800 to explicitly indicate that the screen is a screen for causing the user to confirm contents of an appointment at a specialized institution.

In addition, a text reading “An appointment will be made at the following specialized institution. Tap “make appointment” to make an appointment at the specialized institution.” is displayed below the heading display field of the specialized institution confirmation screen 1800 to prompt the user to make an appointment at the specialized institution.

A name display field 1802, a content display field 1803, a required time display field 1804, and a fee display field 1805 are, for example, displayed vertically below the text.

The name display field 1802 displays a name of the specialized institution. In this case, since the specialized institution is a hospital, “specialized institution: •• Hospital” is displayed in the name display field 1802.

The content display field 1803 displays contents of the specialized institution. In this case, “contents: checkup, internal medicine” is displayed in the content display field 1803.

The required time display field 1804 displays a required time at the specialized institution. In this case, since the time required by a checkup of internal medicine at the •• Hospital is approximately one hour, “required time: approximately 1 hour” is displayed in the required time display field 1804.

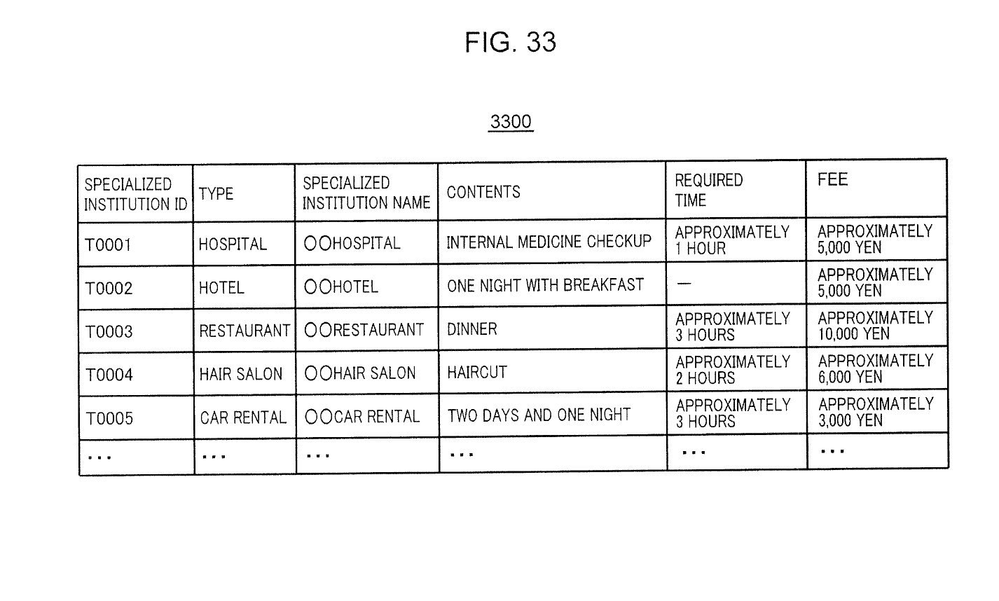

The fee display field 1805 displays a fee to be paid by the user to use the specialized institution. In this case, since the fee for a checkup is approximately 5,000 yen, “fee: approximately 5,000 yen” is displayed in the fee display field 1805. Moreover, a required time and a fee are registered in advance in the specialized institution list 3300 (FIG. 33) to be described later.

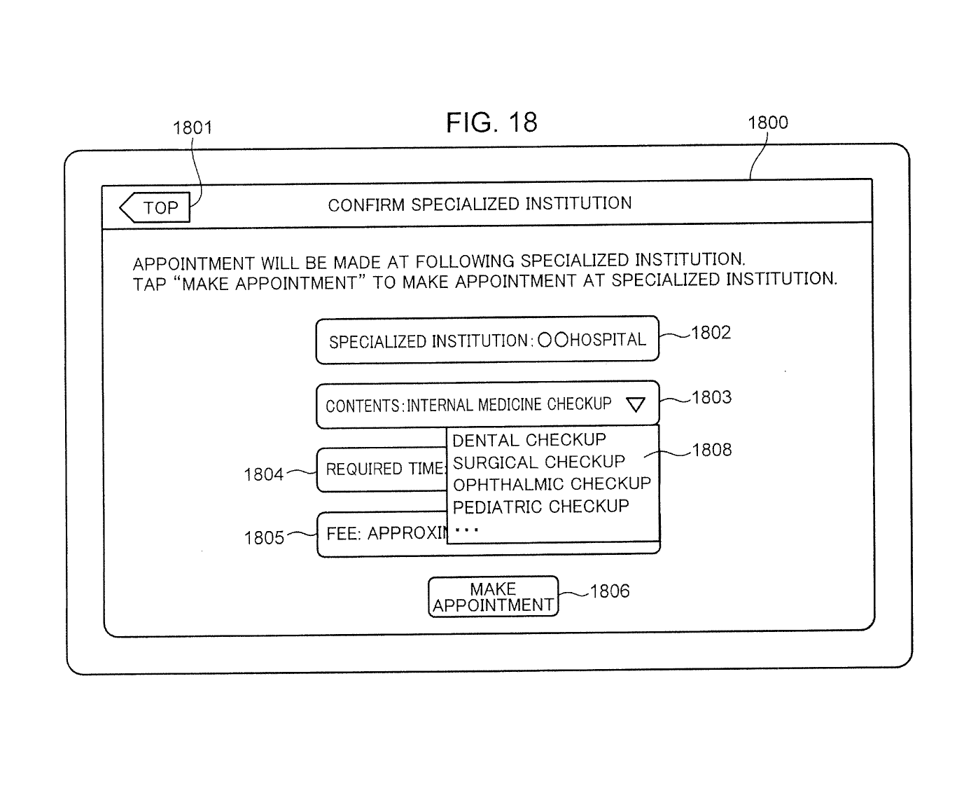

When the content display field 1803 is tapped by the user, the appointment screen generator 201 displays a pull down menu 1808 which displays contents of a specialized institution as a list as shown in FIG. 18.

FIG. 18 shows the specialized institution confirmation screen 1800 on which the pull down menu 1808 is displayed. In the example shown in FIG. 18, candidates of medical departments to be appointment objects such as a dental checkup, a surgical checkup, an ophthalmic checkup, and a pediatric checkup are displayed as a list. Moreover, while medical departments of a hospital are displayed as a list in the pull down menu 1808 in FIG. 18, when another specialized institution is selected, contents corresponding to the selected specialized institution are displayed as a list.

In addition, in a state shown in FIG. 17 prior to the pull down menu 1808 being displayed, default contents are displayed in the content display field 1803. For example, when a transition is made from the appointment guide notification screen 1700, contents for which a guidance to make an appointment has been provided are displayed as default contents in the content display field 1803. On the other hand, when a transition is made from the top screen 1400, for example, contents displayed at the top of the pull down menu 1808 are displayed as default contents in the content display field 1803.

When the user taps the pull down menu 1808 and changes contents thereof, in accordance with the changed contents, the appointment screen generator 201 also changes display contents of the required time display field 1804 and the fee display field 1805. The appointment screen generator 201 acquires a standard service table (not shown) that is provided for each specialized institution from the appointment server 100 and acquires necessary information from the standard service table.

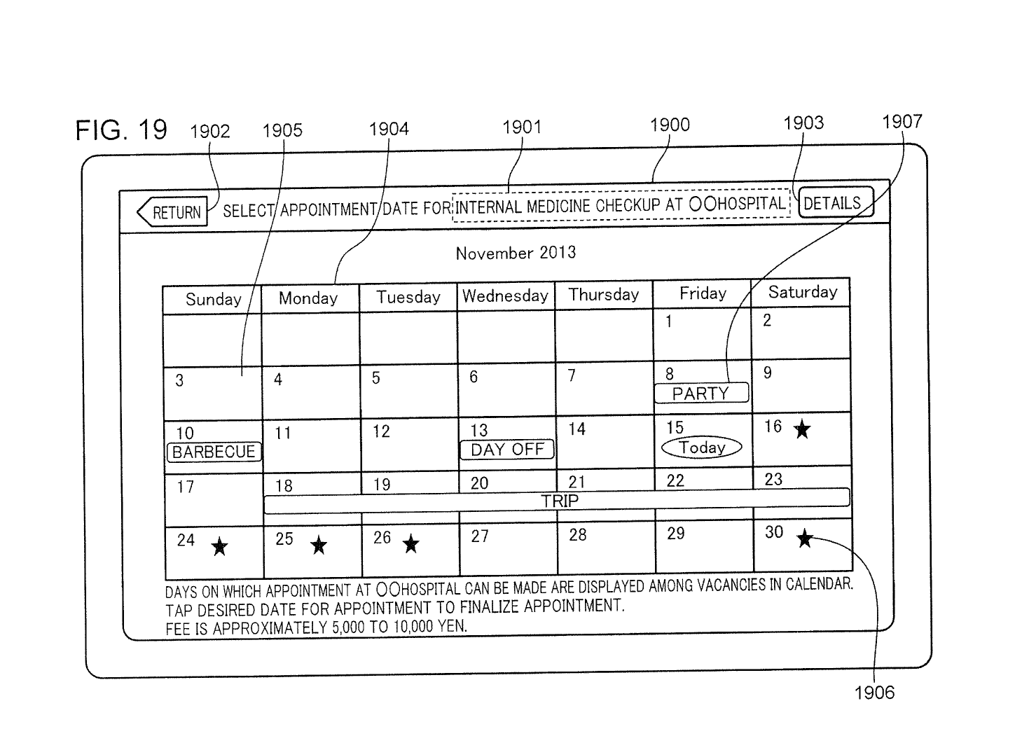

An appointment button 1806 with the description “make appointment” is displayed below the fee display field 1805. The appointment button 1806 is a button for switching the display screen of the display 209 to an appointment date selection screen 1900 (FIG. 19).

Moreover, a top button 1801 with the description “top” that is displayed in a top left part of the specialized institution confirmation screen 1800 is a button for switching the display screen of the display 209 to the top screen 1400 (FIG. 14).

FIG. 19 is a diagram showing a first example of the appointment date selection screen 1900. The appointment date selection screen 1900 is a screen for causing a user to select an appointment date at a specialized institution. A heading that reads “Select appointment date for internal medicine checkup at •• Hospital” is provided in an upper part of the appointment date selection screen 1900 to explicitly indicate that the screen is a screen for selecting an appointment date. The example shown in FIG. 19 presents the appointment date selection screen 1900 corresponding to a hospital. Therefore, “internal medicine checkup at •• Hospital” is described as a specialized institution name 1901 in the heading. In other words, a name of a specialized institution that is an appointment object and contents of use of the specialized institution are described in a field corresponding to the specialized institution name 1901 in the heading.

The appointment date selection screen 1900 is provided with a calendar data display field 1904 in which a plan of the user that is generated using schedule information is shown in a calendar format. In this case, the calendar data display field 1904 is a field that displays a calendar in which days are presented on a per month or per week basis. In the example shown in FIG. 19, a calendar in which days are presented on a per month basis is adopted.

The calendar data display field 1904 is constituted by 35 rectangular boxes 1905 divided in a matrix pattern by the seven days of the week from Sunday to Saturday which are arranged horizontally and five weeks arranged vertically. In this case, one box 1905 is a region representing a day. A numeral indicating a day is displayed in each box 1905. Moreover, in the example shown in FIG. 19, a numeral indicating a day is not displayed in boxes 1905 corresponding to days which do not belong to a display target month but belong to the previous month or the following month. However, this is simply an example and days may be displayed in boxes 1905 corresponding to days which belong to the previous month or the following month. A year and a month which are display objects are displayed above the calendar data display field 1904. In the example shown in FIG. 19, since calendar data for November 2013 is displayed in the calendar data display field 1904. “November 2013” is displayed above the calendar data display field 1904.

The calendar data display field 1904 displays a schedule icon 1907 representing a schedule of a user input by the user using the calendar application. The example shown in FIG. 19 displays schedule icons 1907 such as “party” on the 8th, “barbeque” on the 10th, “day off” on the 13th, and “trip” from the 18th to the 23rd. In addition, in the example shown in FIG. 19, “today” is displayed in the box 1905 corresponding to the present day to explicitly indicate the present day to the user.

Furthermore, the calendar data display field 1904 displays a candidate symbol 1906 for explicitly indicating that a given day is a candidate appointment date at the specialized institution in a box 1905 corresponding to the candidate appointment date. While a star-shaped graphic is adopted as the candidate symbol 1906 in the example shown in FIG. 19, any graphic such as a circle and a square may be adopted as long as a candidate appointment date can be recognized.

As described above, the calendar data display field 1904 which displays both a schedule of the user and a candidate appointment date at a specialized institution is provided on the appointment date selection screen 1900. Therefore, the user can select an appointment date at a specialized institution using only the appointment date selection screen 1900.

For example, let us consider a case where the calendar data display field 1904 is not provided on the appointment date selection screen 1900. In this case, the user must separately start up a calendar application and select an appointment date at a specialized institution by collating the display of calendar data provided by the calendar application with the display on the appointment date selection screen 1900. In particular, when the appointment terminal 200 is a tablet terminal or a smartphone, since a small size of the display 209 makes it difficult to display the calendar data and the appointment date selection screen 1900 at the same time, the user must collate both screens while inputting operations for switching between both displays.

In consideration thereof, the present disclosure aims to improve efficiency of an appointment operation for setting an appointment date at a specialized institution by providing the calendar data display field 1904 on the appointment date selection screen 1900.

Furthermore, the candidate appointment dates that are displayed in the calendar data display field 1904 are appointment available dates on which an appointment at the specialized institution can be made from which dates on which the user has plans have been excluded. Therefore, only candidate appointment dates that are likely to be selected by the user are displayed in the calendar data display field 1904. As a result, the number of displayed candidate appointment dates can be narrowed down and the user can smoothly perform an appointment operation for setting an appointment date at a specialized institution.

A text reading “Days on which an appointment at the •• Hospital can be made are displayed among vacancies in the calendar” is displayed below the calendar data display field 1904 to explicitly indicate that the dates with the candidate symbols 1906 are candidate appointment dates. This text is followed by a text reading “Tap a desired date for the appointment to finalize the appointment.” which prompts the user to select an appointment date from the candidate appointment dates. This text is, in turn, followed by a display of a text reading “The fee is approximately 5,000 to 10,000 yen” which explicitly indicates the fee for the specialized institution. Accordingly, information for making a determination on whether or not to make an appointment at the specialized institution is provided to the user.

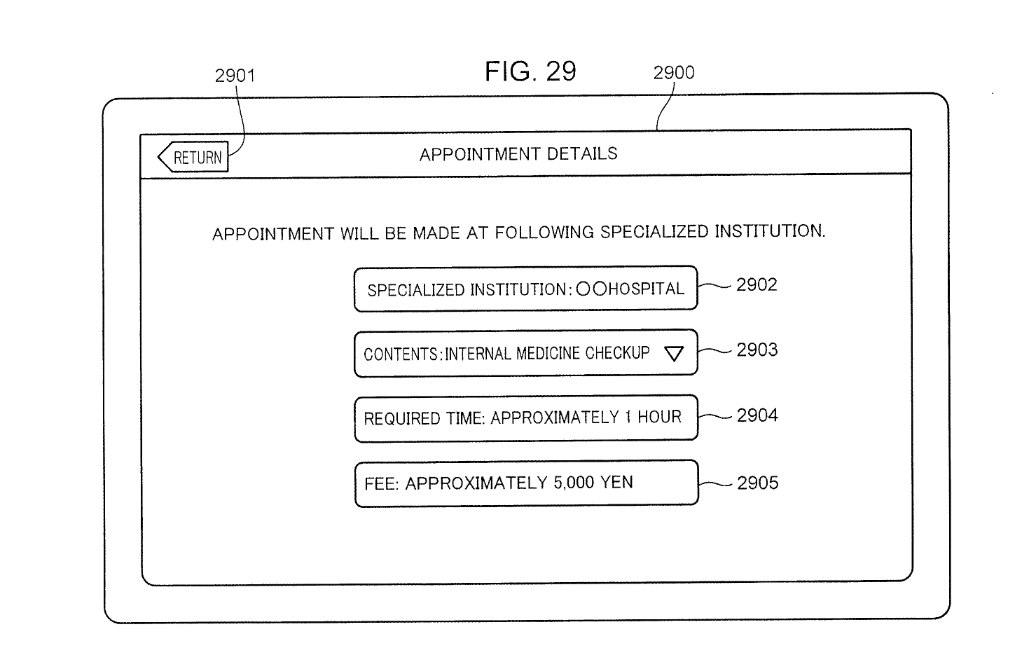

A return button 1902 with a description of “return” is displayed to the left of the display field of the specialized institution name 1901 on the appointment date selection screen 1900. The return button 1902 is a button for returning the display screen on the display 209 from the appointment date selection screen 1900 to the specialized institution confirmation screen 1800. In addition, a detail button 1903 with a description of “detail” is displayed to the right of the display field of the specialized institution name 1901 on the appointment date selection screen 1900. The detail button 1903 is a button for switching the display screen of the display 209 to an appointment detail confirmation screen 2900 (FIG. 29).

Moreover, while calendar data is displayed on a per month basis in the calendar data display field 1904 in FIG. 19, the calendar data may instead be displayed on a per week basis. In this case, the calendar data display field 1904 is constituted by, for example, 7 boxes 1905 divided in a matrix pattern by the seven days of the week from Sunday to Saturday which are arranged horizontally and one week arranged vertically.

In this case, days are displayed in the calendar data display field 1904 on a per week basis regardless of month even if the present week that is a display target is a week extends to the following month or the previous month. For example, in FIG. 19, the week in the first row is a week that extends from October to November, and when only this week is displayed in the calendar data display field 1904, a numeral indicating the day, the schedule icon 1907, and the candidate symbol 1906 are displayed for days which belong to October and which are blank fields.

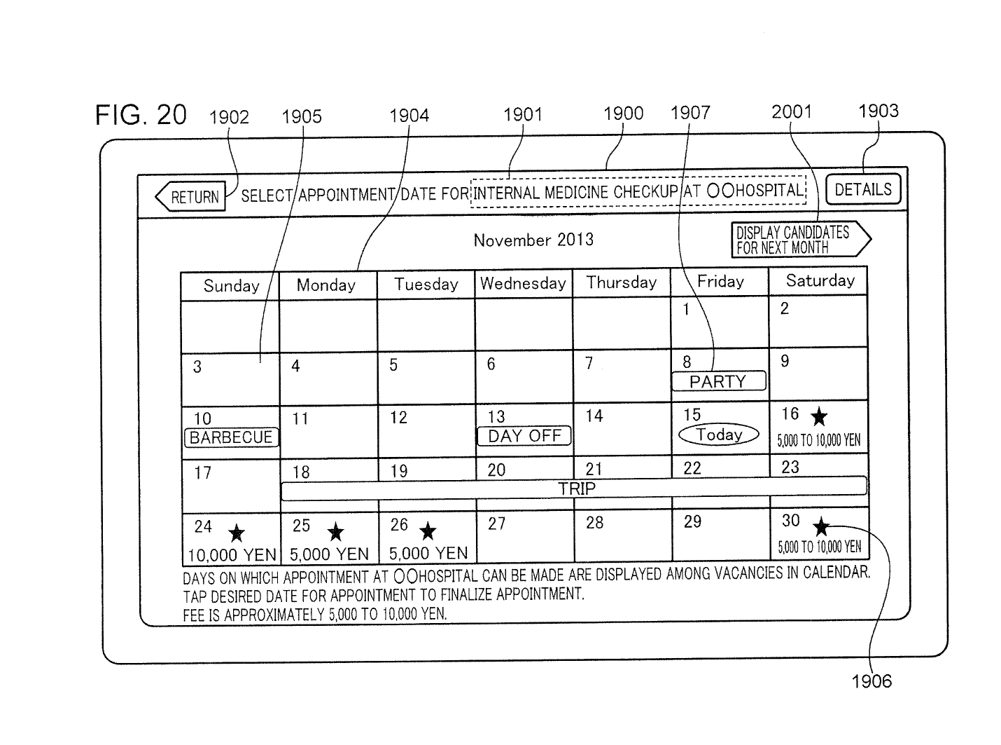

FIG. 20 is a diagram showing a second example of the appointment date selection screen 1900. On the appointment date selection screen 1900 according to the second example, a next month candidate display button 2001 has been added and a fee is displayed in the box 1905 corresponding to a candidate appointment date.

The next month candidate display button 2001 is a button for causing calendar data of a next month to be displayed in the calendar data display field 1904. The next month candidate display button 2001 is displayed when candidate appointment dates are extracted so as to extend from the present month to the following month. When the screen controller 204 detects that the next month candidate display button 2001 has been tapped, the appointment screen generator 201 displays the appointment date selection screen 1900 that displays calendar data for the following month on the display 209.

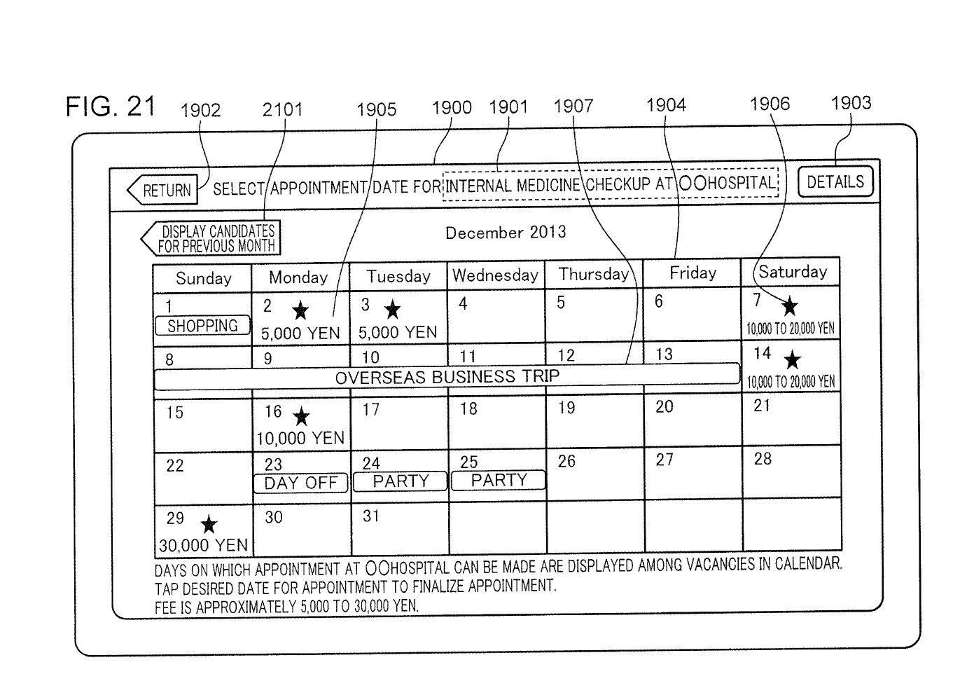

FIG. 21 is a diagram showing an example of the appointment date selection screen 1900 for the month following the appointment date selection screen 1900 shown in FIG. 20.

In the example shown in FIG. 21, since the present month is November 2013, calendar data for December 2013 that is the following month is displayed in the calendar data display field 1904. On the appointment date selection screen 1900 of the following month, a schedule of the user and a candidate appointment date are both displayed in the calendar data display field 1904 in a similar manner to the appointment date selection screen of the present month.

Therefore, even if the present day is at the end of the present month, by causing the appointment date selection screen 1900 displaying calendar data of the following month that is shown in FIG. 21 to be displayed, the user can select an appointment date without omitting candidate appointment dates of the following month.

In addition, a previous month candidate display button 2101 is displayed below the return button 1902 on the appointment date selection screen 1900 of the following month. The previous month candidate display button 2101 is a button for switching screen display of the display 209 to the appointment date selection screen 1900 of the present month that is shown in FIG. 20.

Therefore, when the screen controller 204 detects that the previous month candidate display button 2101 has been tapped, the appointment screen generator 201 switches screen display from the appointment date selection screen 1900 of the following month to the appointment date selection screen 1900 of the present month.

In addition, as shown in FIGS. 20 and 21, on the appointment date selection screen 1900 according to the second example, a fee for the specialized institution is displayed in the box 1905 that corresponds to a candidate appointment date. At this point, the fee for the specialized institution may differ between weekdays and weekends. In this case, explicitly indicating a fee for the specialized institution for each candidate appointment date makes it easier for the user to select a candidate appointment date. Therefore, in the example shown in FIG. 20, a fee for the specialized institution is displayed in the box 1905 that corresponds to a candidate appointment date. Accordingly, the user can select a candidate appointment date on which the fee is lower.

In the example shown in FIG. 20, the fee on Sunday the 24th is 10,000 yen, the fee on Saturdays the 16th and 30th is 5,000 to 10,000 yen, and the fees on Monday the 25th and Tuesday the 26th are 5,000 yen. This indicates that fees are set higher on Sundays and Saturdays than on weekdays. Therefore, information suggesting that selecting weekdays may result in lower fees is explicitly indicated to the user.

Moreover, while an example in which fees differ depending on the day of the week is shown in FIG. 20, there may be cases where fees differ depending on whether or not it is a busy period. In this case, for a candidate appointment date corresponding to the busy period, a fee that is higher than other candidate appointment dates is displayed. In Japan, December is customarily considered a busy period. Therefore, fees displayed on the appointment date selection screen 1900 of December that is shown in FIG. 21 are set relatively higher than the fees displayed on the appointment date selection screen 1900 of November that is shown in FIG. 20.

In addition, while the examples in FIGS. 20 and 21 represent cases where fees are constant on the same day, there may be cases where fees fluctuate depending on time slots even on the same day. For example, there may be cases where prices for a night performance are set higher than prices for a day performance. In such a case, fees depending on time slots may be displayed in the box 1905 of a candidate appointment date.

Moreover, when a mode in which calendar data is displayed on a per week basis is adopted in FIGS. 20 and 21, for example, a next week candidate display button is displayed in place of the next month candidate display button 2001 on the appointment date selection screen 1900. In this case, when the next week candidate display button is tapped, the appointment screen generator 201 may display the calendar data of the next week. Since a schedule of the user and candidate appointment dates are also displayed on the calendar data of the next week, the user can select an appointment date without omitting the candidate appointment dates of the next week.

Moreover, on the appointment date selection screens according to the first and second examples, the appointment screen generator 201 may display the schedule icon 1907 and the candidate symbol 1906 in different colors. Accordingly, the user can recognize the user's own schedule and candidate appointment dates in a more distinguishable manner.

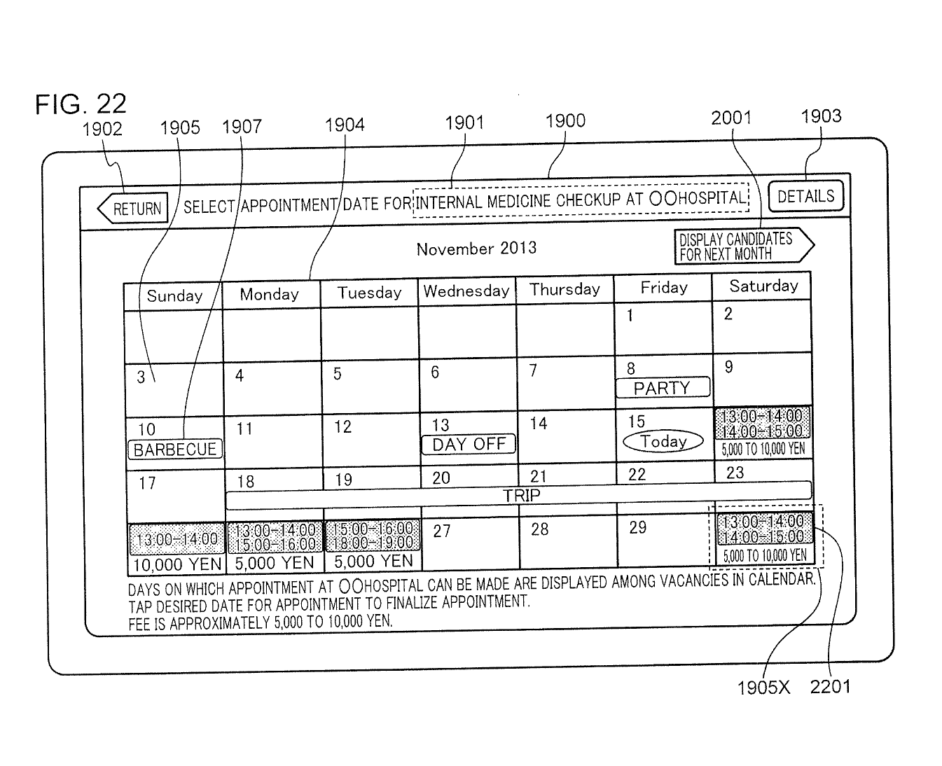

FIG. 22 is a diagram showing a third example of the appointment date selection screen 1900. The appointment date selection screen 1900 according to the third example differs from the appointment date selection screen 1900 according to the second example in that a candidate appointment date is indicated by a candidate appointment time 2201 instead of the candidate symbol 1906.

In FIG. 22, for example, a time slot of 13:00 to 14:00 and a time slot of 14:00 to 15:00 are displayed as the candidate appointment time 2201 in a box 1905X on the 30th.

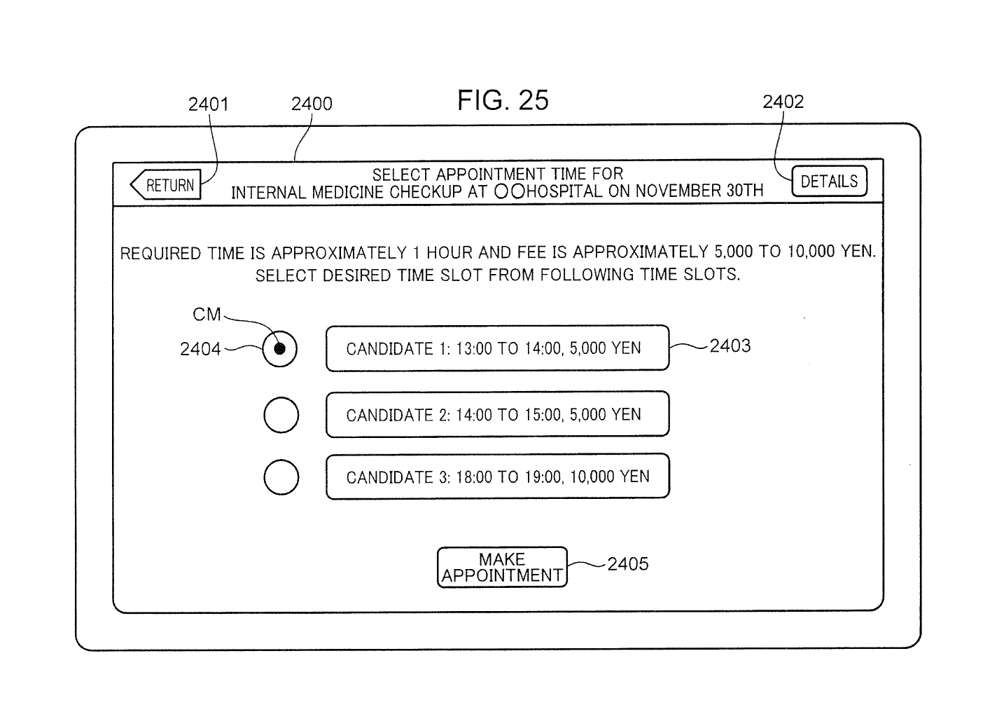

When the user taps a desired candidate appointment time 2201, an appointment time selection screen 2400 (FIG. 25) on which the candidate appointment time 2201 is initially selected is displayed on the display 209. For example, when the candidate appointment time 2201 of 13:00 to 14:00 is tapped, in FIG. 25, the appointment time selection screen 2400 is displayed on which a check mark CM is initially displayed in a check box 2404 corresponding to a time slot display field 2403 of 13:00 to 14:00.

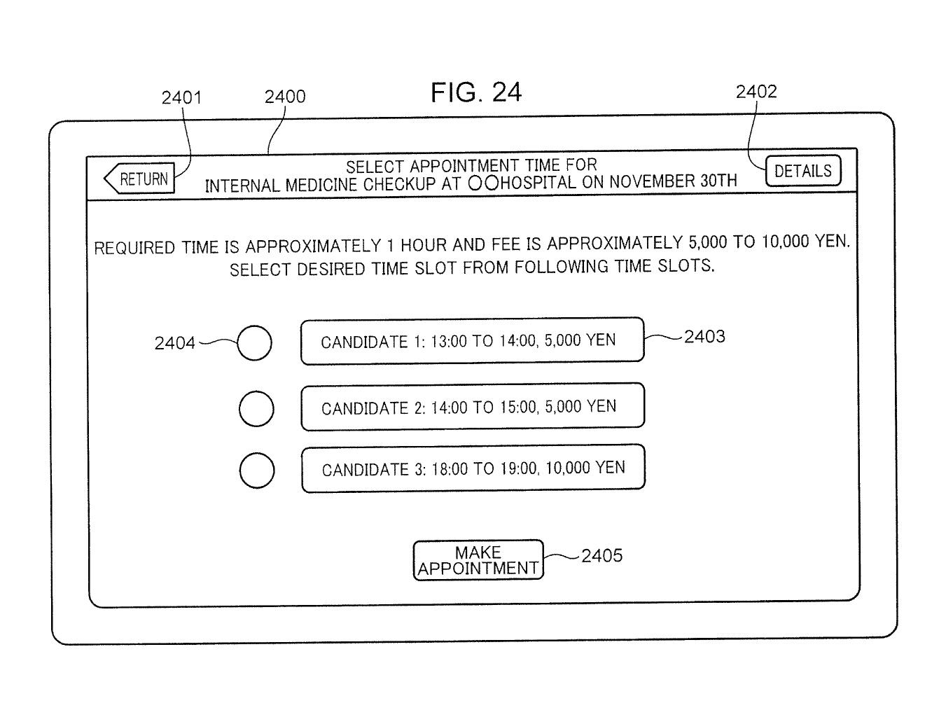

On the other hand, when the box 1905 corresponding to a candidate appointment date is tapped on the appointment date selection screens 1900 according to the first and second examples, the appointment time selection screen 2400 (FIG. 24) on which the check mark CM is not initially displayed is displayed. As a result, the user must tap the time slot display field 2403 that displays a desired candidate appointment time on the appointment time selection screen 2400 shown in FIG. 24.

Therefore, when the appointment date selection screen 1900 according to the third example is selected, the user need no longer tap a desired candidate appointment time on the appointment time selection screen 2400 and is saved the trouble of having to do so.

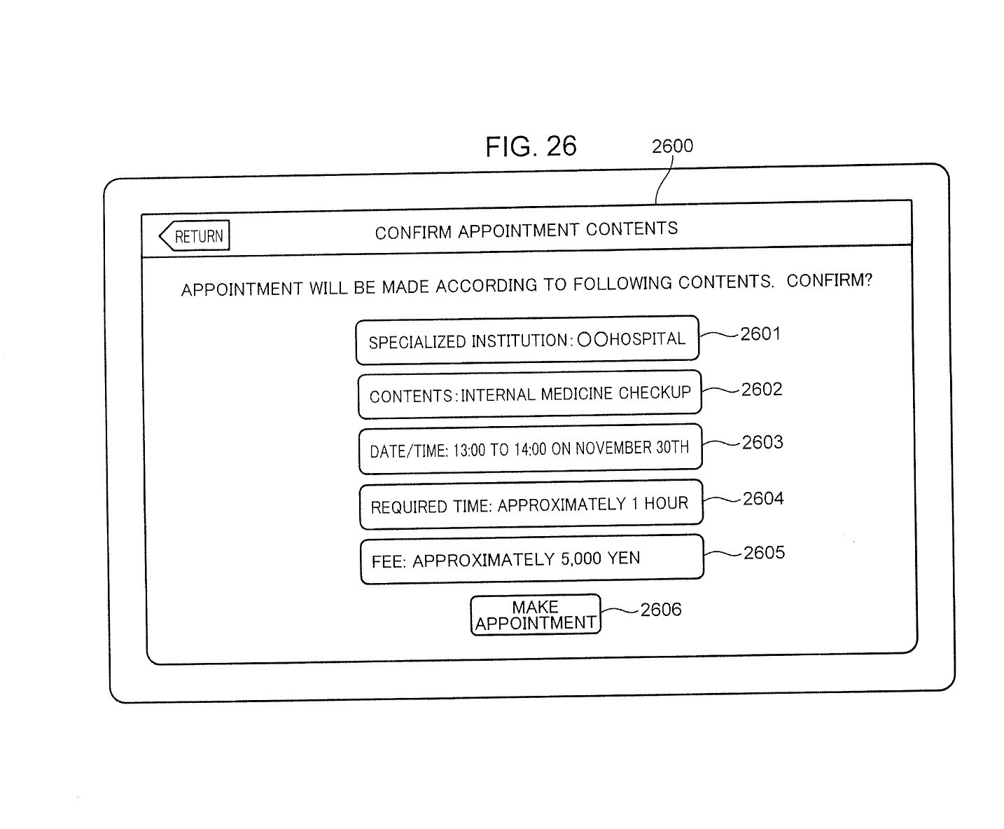

Alternatively, when the candidate appointment time 2201 is tapped on the appointment date selection screen 1900 according to the third example, the appointment screen generator 201 may cause a transition of the display screen to an appointment content confirmation screen 2600 (FIG. 26) without displaying the appointment time selection screen 2400. Accordingly, process steps of screen display are reduced and efficiency of the process can be improved.

In addition, in FIG. 22, when there is an excessive number of candidate appointment times 2201, the appointment screen generator 201 is unable to display all candidate appointment times 2201 in one box 1905 corresponding to a candidate appointment date. In such a case, the appointment screen generator 201 may not display the candidate appointment times 2201 in the box 1905. Specifically, the appointment screen generator 201 may be configured not to display the candidate appointment times 2201 in the box 1905 when the number of the candidate appointment times 2201 exceeds a prescribed upper limit value that can be displayed in the box 1905.

Alternatively, when all candidate appointment times 2201 cannot be displayed in one box 1905, the appointment screen generator 201 may only display candidate appointment times 2201 corresponding to the upper limit value in, for example, in an order of time slots from earliest to latest.

Moreover, when the candidate appointment times 2201 cannot be displayed in one box 1905, the appointment screen generator 201 may display the appointment time selection screen 2400 when the box 1905 is tapped. In addition, the appointment screen generator 201 may display the time slot display fields 2403 corresponding to all candidate appointment times on the appointment time selection screen 2400. Accordingly, the user can select the candidate appointment times 2201 that had been hidden on the appointment date selection screen 1900.

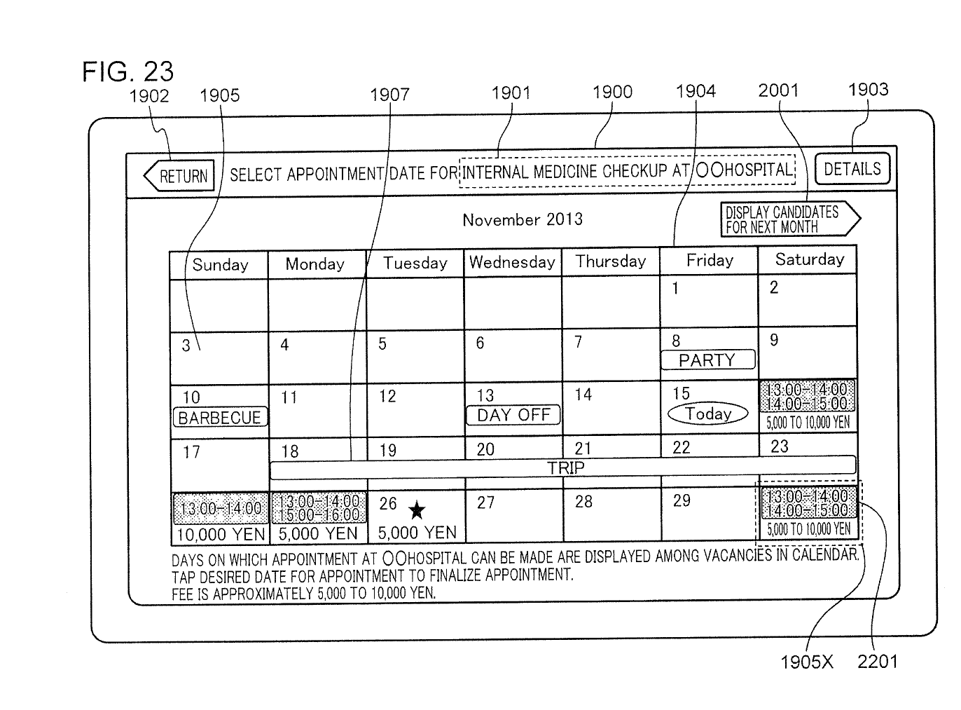

FIG. 23 is a diagram showing a fourth example of the appointment date selection screen 1900. The appointment date selection screen 1900 according to the fourth example is a combination of the appointment date selection screens 1900 according to the second and third examples. In other words, while the appointment screen generator 201 hides candidate appointment times 2201 when all candidate appointment times 2201 cannot be displayed in one box 1905 in the third example, the appointment screen generator 201 displays the candidate symbol 1906 in place of the candidate appointment time 2201 in the fourth example.

In FIG. 23, for example, since the number of candidate appointment times 2201 exceeds an upper limit value on the 26th, the appointment screen generator 201 displays the candidate symbol 1906 in the box 1905 corresponding to the 26th.

Moreover, on the appointment date selection screens according to the third and fourth examples, the appointment screen generator 201 may display the schedule icon 1907 and the candidate appointment times 2201 in different colors. Accordingly, the user can recognize the user's own schedule and candidate appointment dates in a more distinguishable manner.

FIG. 24 is a diagram showing an example of the appointment time selection screen 2400. The appointment time selection screen 2400 is a screen for having a user select an appointment time at a specialized institution. A heading that reads “Select appointment time for internal medicine checkup at •• Hospital on November 30th” is provided in an upper part of the appointment time selection screen to explicitly indicate that the screen is for selecting an appointment time. A return button 2401 that is displayed to the left of the heading is a button for returning the screen display from the appointment time selection screen 2400 to the appointment date selection screen 1900.

A detail button 2402 that is displayed to the right of the heading is a button for switching the screen display from the appointment time selection screen 2400 to an appointment detail confirmation screen 2900 (FIG. 29).

On the appointment time selection screen 2400, a text reading “Required time is approximately 1 hour and fee is approximately 5,000 to 10,000 yen. Select a desired time slot from the following time slots.” is displayed below the heading to prompt the user to select an appointment time.

One or more time slot display fields 2403 are vertically aligned below the text. In addition, a check box 2404 is displayed to the left of each time slot display field 2403. The time slot display field 2403 displays candidate appointment times at which an appointment can be made at a specialized institution on a candidate appointment date that is tapped by the user on the appointment date selection screen 1900.

In the example shown in FIG. 24, since the box 1905 of November 30th has been tapped on the appointment date selection screen 1900, candidate appointment times on November 30th are displayed. In this example, three time slot display fields 2403 representing a time slot of 13:00 to 14:00, a time slot of 14:00 to 15:00, and a time slot of 18:00 to 19:00 are displayed. In addition, candidate numbers from candidate 1 to candidate 3 are displayed in the time slot display fields 2403 in an order of time slots from earliest to latest. Furthermore, fees corresponding to candidate appointment times are displayed in the time slot display fields 2403. In this example, for example, since the time slot of 18:00 to 19:00 is a time slot that tends to be crowded, the fee is set higher than candidates 1 and 2 that represent other time slots.

The user selects a candidate appointment time by tapping a check box 2404 corresponding to the time slot display field 2403 that displays a desired candidate appointment time. For example, let us assume that the user taps the top check box 2404. As a result, the appointment screen generator 201 displays the check mark CM in the tapped check box 2404 as shown in FIG. 25.

FIG. 25 is a diagram showing the appointment time selection screen 2400 in a state in which a candidate appointment time is selected. Accordingly, the user can confirm the candidate appointment time selected by the user.

In addition, when an appointment button 2405 displayed at the bottom of the appointment time selection screen 2400 is tapped, the appointment screen generator 201 causes the appointment content confirmation screen 2600 (FIG. 26) to be displayed on the display 209.

FIG. 26 is a diagram showing an example of the appointment content confirmation screen 2600. The appointment content confirmation screen 2600 is a screen for the user to confirm appointment contents.

A heading that reads “Confirm appointment contents” is displayed at the top of the appointment content confirmation screen 2600 to explicitly indicate that the screen is a screen for confirming appointment contents. A text reading “An appointment will be made according to the following contents. Confirm?” is displayed below the heading to explicitly indicate that appointment contents are displayed in fields below.

A name display field 2601, a content display field 2602, a date and time display field 2603, a time display field 2604, and a fee display field 2605 are displayed vertically below the text. The name display field 2601 is a field that displays a name of the specialized institution that is an appointment object. In this case. “Specialized institution name: •• Hospital” is displayed.

The content display field 2602 is a field that displays contents of use of the specialized institution. In this case, since an appointment for a checkup of internal medicine has been made, “Contents: Internal medicine checkup” is displayed.

The date and time display field 2603 is a field that displays a candidate appointment date and a candidate appointment time selected by the user. In this case, since a candidate appointment date of November 30th has been selected on the appointment date selection screen 1900 and a candidate appointment time of 13:00 to 14:00 has been selected on the appointment time selection screen 2400, “Date and time: 13:00 to 14:00 on November 30th” is displayed.

The time display field 2604 is a field that displays a required time for using the specialized institution. In this case, “Required time: approximately 1 hour” is displayed.

The fee display field 2605 is a field that displays a fee for the specialized institution. In this case, “Fee: 5,000 yen” is displayed.

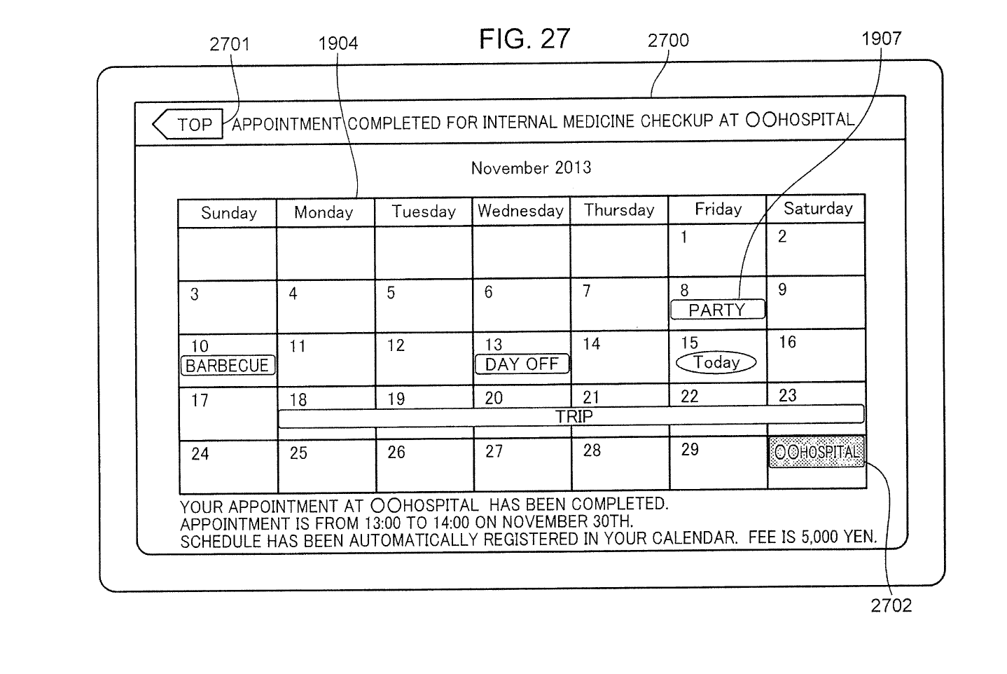

When the user consents to the appointment contents displayed on the appointment content confirmation screen 2600, the user taps the appointment button 2606. As a result, the appointment screen generator 201 displays an appointment completion screen 2700 (FIG. 27) on the display 209.

Moreover, in the case of a specialized institution that enables settlement, a purchasing process (settlement) may be performed in addition to making an appointment on the appointment content confirmation screen 2600. In this case, the appointment screen generator 201 may display a purchase button in place of the appointment button 2606. In addition, when the purchase button is tapped, the appointment screen generator 201 may display a payment method selection screen for inputting, for example, a card number of a credit card.

FIG. 27 is a diagram showing a first example of the appointment completion screen 2700. A heading that reads “Appointment completed for internal medicine checkup at •• Hospital” is provided in an upper part of the appointment completion screen 2700 to explicitly indicate that the screen is a screen for notifying the completion of an appointment.

The calendar data display field 1904 is displayed on the appointment completion screen 2700 in a similar manner to the appointment date selection screen 1900. An appointment icon 2702 indicating an appointment date is displayed in the box 1905 corresponding to the appointment date on which the user has made an appointment in the calendar data display field 1904. In the example shown in FIG. 27, “•• Hospital” is displayed on the appointment icon 2702 to explicitly indicate that the specialized institution at which an appointment has been made is the •• Hospital. In addition, in the example shown in FIG. 27, since the appointment date on which the user has made an appointment is the 30th, the appointment icon 2702 is displayed in the box 1905 corresponding to the 30th.

Furthermore, since there is no need to notify a candidate appointment date on the appointment completion screen 2700, the candidate symbol 1906 that represents a candidate appointment date and the candidate appointment time 2201 which have been displayed on the appointment date selection screen 1900 are hidden on the appointment completion screen 2700. Accordingly, the user can confirm an appointment date at a glance with the appointment icon 2702.

On the other hand, the schedule icon 1907 which is displayed on the appointment date selection screen 1900 is also displayed on the appointment completion screen 2700. Therefore, the user can confirm the user's own schedule on the appointment completion screen 2700 without having to separately start up a calendar application.

Moreover, on the appointment completion screen 2700, the appointment screen generator 201 may display the schedule icon 1907 and the appointment icon 2702 in different colors. Accordingly, the user can recognize the user's own schedule and appointment dates in a more distinguishable manner.

On the appointment completion screen 2700, a text reading “Your appointment at •• Hospital has been completed. The appointment is from 13:00 to 14:00 on November 30th. The schedule has been automatically registered in your calendar. The fee is 5,000 yen.” informing that an appointment has been made is displayed below the calendar data display field 1904. Accordingly, completion of the appointment is explicitly indicated to the user.

Moreover, in the calendar data display field 1904 displayed on the appointment date selection screen 1900 and the appointment completion screen 2700 displayed above, the user can also register a schedule. In this case, for example, when the user taps the box 1905 corresponding to a desired date in the calendar data display field 1904, the appointment screen generator 201 causes a screen for inputting details of a schedule to be displayed. Subsequently, the appointment screen generator 201 notifies information input using the screen to the calendar data managers 107 and 206. Accordingly, the schedule input by the user through the calendar data display field 1904 is registered in the calendar data storages 108 and 207.

Moreover, a top button 2701 with the description “top” that is displayed in a top left part of the appointment completion screen 2700 is a button for switching the display screen of the display 209 to the top screen 1400 (FIG. 14).

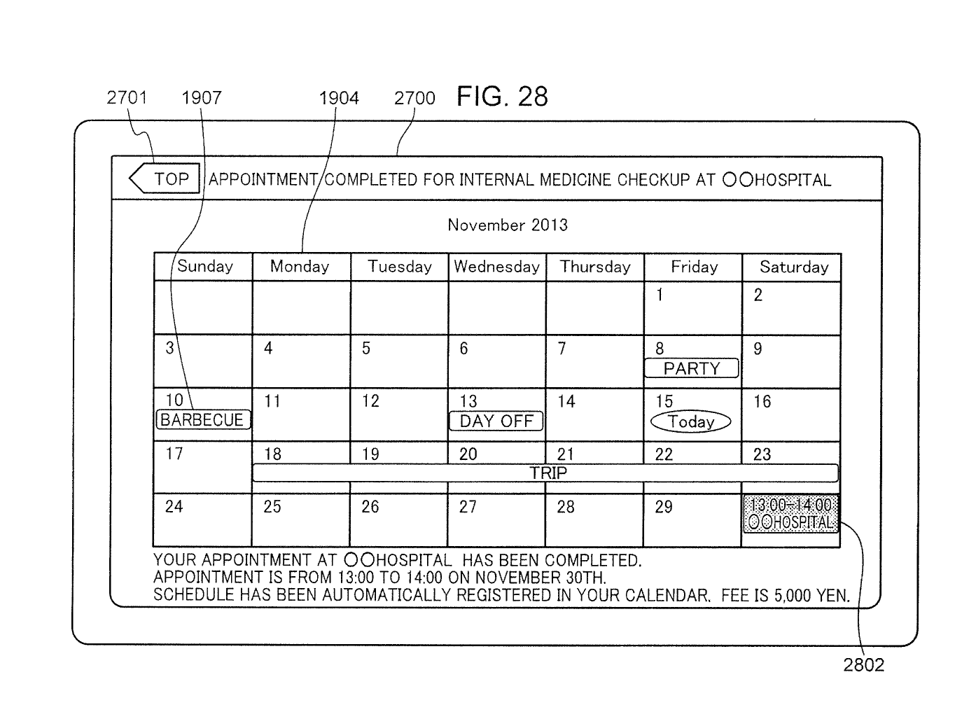

FIG. 28 is a diagram showing a second example of the appointment completion screen 2700. A difference from the first example is that an appointment time is displayed on the appointment icon 2702. In the example shown in FIG. 28, since the time slot of 13:00 to 14:00 is the appointment time. “13:00 to 14:00” is displayed in addition to a text reading “•• Hospital” on the appointment icon 2702. Accordingly, the user can confirm an appointment time in addition to an appointment date with the appointment icon 2702.

FIG. 29 is a diagram showing an example of the appointment detail confirmation screen 2900. The appointment detail confirmation screen 2900 is a screen that is displayed when the detail button 1903 is tapped on the appointment date selection screen 1900 or when the detail button 2402 is tapped on the appointment time selection screen 2400.

The appointment detail confirmation screen 2900 is a screen for causing the user to confirm details of appointment contents. A heading that reads “Appointment details” is displayed at the top of the appointment detail confirmation screen 2900 to explicitly indicate that the screen is a screen for confirming details of appointment contents. A text reading “An appointment will be made at the following specialized institution.” is displayed below the heading to explicitly indicate that details of appointment contents are displayed in fields below.

A name display field 2902, a content display field 2903, a time display field 2904, and a fee display field 2905 are displayed vertically below the text. These fields display the same contents as those displayed in the fields with the same names on the appointment content confirmation screen 2600 (FIG. 26).

Through the appointment detail confirmation screen 2900, information for making a determination on whether or not to make an appointment can be presented to the user.

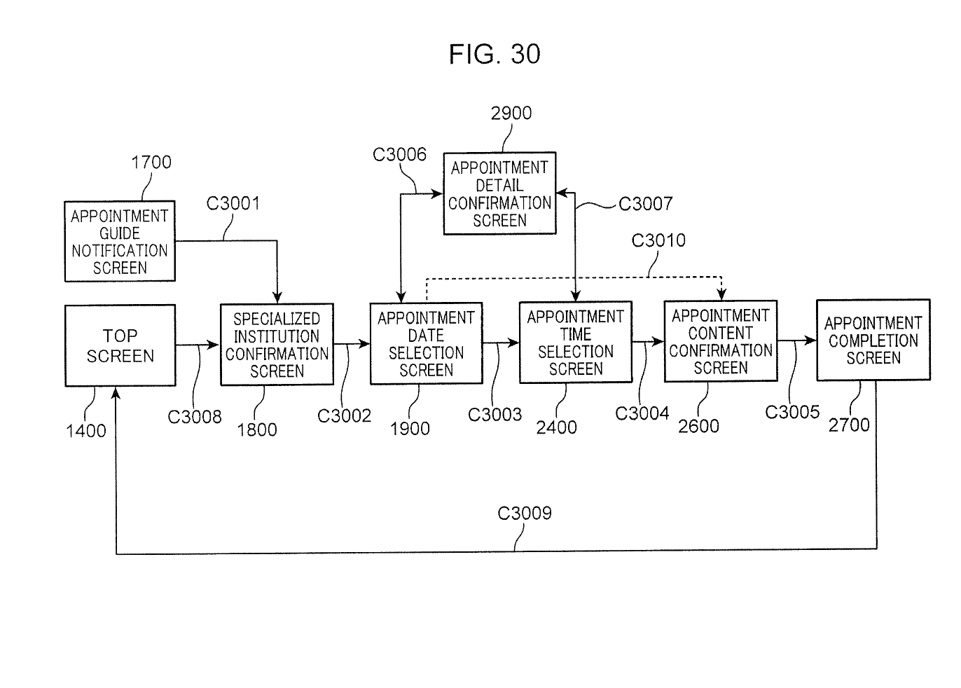

FIG. 30 is a diagram showing a screen flow according to the present disclosure. In the present disclosure, there are two start points in the screen flow. One start point is the appointment guide notification screen 1700 and another start point is the top screen 1400. The appointment guide notification screen 1700 is displayed when the appointment system detects registration of a specialized institution that is in accordance with the preferences or history of the user while the top screen 1400 is displayed when the user taps the appointment application icon 1301 on the basic screen 1300.

When the screen controller 204 detects that the appointment guide notification screen 1700 has been tapped, the appointment screen generator 201 switches the screen display to the specialized institution confirmation screen 1800 (C3001). When the screen controller 204 detects that the appointment button 1806 has been tapped on the specialized institution confirmation screen 1800, the appointment screen generator 201 switches the screen display to the appointment date selection screen 1900 (C3002).

When the screen controller 204 detects that the box 1905 representing a candidate appointment date has been tapped on the appointment date selection screen 1900, the appointment screen generator 201 switches the screen display to the appointment time selection screen 2400 (C3003). When the screen controller 204 detects that the time slot display field 2403 has been tapped on the appointment time selection screen 2400, the appointment screen generator 201 switches the screen display to the appointment content confirmation screen 2600 (C3004).

When the screen controller 204 detects that the appointment button 2606 has been tapped on the appointment content confirmation screen 2600, the appointment screen generator 201 switches the screen display to the appointment completion screen 2700 (C3005). When the screen controller 204 detects that the detail button 1903 has been tapped on the appointment date selection screen 1900, the appointment screen generator 201 switches the screen display to the appointment detail confirmation screen 2900 (C3006). In this case, when the screen controller 204 detects that the return button 2901 has been tapped on the appointment detail confirmation screen 2900, the appointment screen generator 201 returns the screen display to the appointment date selection screen 1900 (C3006).

In addition, when the screen controller 204 detects that the detail button 2402 has been tapped on the appointment time selection screen 2400, the appointment screen generator 201 switches the screen display to the appointment detail confirmation screen 2900 (C3007). In this case, when the screen controller 204 detects that the return button 2901 has been tapped on the appointment detail confirmation screen 2900, the appointment screen generator 201 returns the screen display to the appointment time selection screen 2400 (C3007).

When the screen controller 204 detects that the appointment button 1402 in the specialized institution display field 1401 has been tapped on the top screen 1400, the appointment screen generator 201 switches the screen display to the specialized institution confirmation screen 1800 (C3008).

When the screen controller 204 detects that the top button 2701 has been tapped on the appointment completion screen 2700, the appointment screen generator 201 switches the screen display to the top screen 1400 (C3009).

Moreover, in the case of the appointment date selection screen 1900 according to the third example (FIG. 22), when the screen controller 204 detects that the candidate appointment time 2201 has been tapped as described above, the appointment screen generator 201 may bypass the appointment time selection screen 2400 and display the appointment content confirmation screen 2600 (C3010).

FIG. 31 is a diagram showing an example of a data configuration of customer history 3100. The customer history 3100 is data indicating a history of activities of a customer. The customer history 3100 is periodically transmitted from the appointment terminal 200 to the appointment server 100 or the customer management server 400 which analyzes information on customers. In addition, the customer history 3100 is stored in plurality in the appointment server 100 or the customer management server 400 and is used when the appointment server 100 or the customer management server 400 analyzes the preferences of a customer. The appointment server 100 or the customer management server 400 stores the customer history 3100 of a plurality of customers.

The customer history 3100 includes a “header”, a “customer attribute”, and “history”. The “header” includes a “user ID” and a “transmission date and time”. The “user ID” is an identifier that is uniquely set for each user. The “transmission date and time” represents the time when the appointment terminal 200 transmits the customer history 3100 to the appointment server 100 or the customer management server 400.

The “customer attribute” includes a “gender”, an “age”, and a “region”. “Gender” represents the gender of the user. In the example shown in FIG. 31, “gender” includes the information of “male”. “Age” represents the age of the user. In the example shown in FIG. 31, “age” includes the information of “30 years old”. “Region” roughly represents a place of residence of the user. In the example shown in FIG. 31, “region” includes the information of “Osaka, Japan”.

“History” includes a “genre of recently viewed sites”, a “genre of recently used applications”, a “genre of recently viewed TV programs”, and the like. The “genre of recently viewed sites” represents a genre of a website that has been recently viewed by the user. In the example shown in FIG. 31, the “genre of recently viewed sites” includes the information of “travel”. The “genre of recently used applications” represents a genre of an application that has been recently used by the user. In the example shown in FIG. 31, the “genre of recently used applications” includes the information of “travel”. The “genre of recently viewed TV programs” represents a genre of a TV program that has been recently viewed by the user. In the example shown in FIG. 31, the “genre of recently viewed TV programs” includes the information of“cooking”.

The appointment server 100 or the customer management server 400 may, for example, assume a genre of a most frequently viewed website or a genre of a most frequently used application among a plurality of stored pieces of “history” of a customer to be a genre of preferences of the customer. The appointment server 100 or the customer management server 400 may analyze the preferences of a customer by any other method.

In addition, the appointment server 100 or the customer management server 400 may also collect customer history from terminals (for example, personal computers and so-called smartphones) other than the appointment terminal 200.

FIG. 32 is a diagram showing an example of a data configuration of customer information 3200. The customer information 3200 is data which represents information related to a customer and which is generated based on a result of an analysis of the customer history 3100 by the appointment server 100 or the customer management server 400. The appointment server 100 or the customer management server 400 generates the customer information 3200 based on the customer history 3100 that is transmitted from the appointment terminal 200 and manages the customer information 3200. The customer information 3200 that is managed by the appointment server 100 or the customer management server 400 includes information on a plurality of customers.

The customer information 3200 includes a “user ID”, a “gender”, an “age”, a “region”, a “preference”, a “service use history”, and a “periodical service use status”. The “user ID” is an identifier that is uniquely set for each user. “Gender” represents the gender of the user with a corresponding ID. “Age” represents the age of the user with a corresponding ID. “Region” roughly represents a place of residence of the user with a corresponding ID.

“Preferences” represents preferences of the user with a corresponding ID. The “preferences” include genres sorted in a descending order of interest. The example shown in FIG. 32 reveals that interests of a user with a “user ID” of “U0001” include, in a descending order of interest, “health”, “travel”, and “movies”.

“Service use history” represents a history of services used by the user with a corresponding ID. “Service use history” includes services used by the user which are sorted in reverse chronological order. The example shown in FIG. 32 reveals that the user with a “user ID” of “U0001” had most recently made an appointment at a hospital and had made a reservation for a rental car before that.

“Periodical service use status” represents a use status services that are periodically used by the user with a corresponding ID. The example shown in FIG. 32 reveals that the user with a “user ID” of “00001” periodically receives checkups at the •• Hospital.

FIG. 33 is a diagram showing an example of a data configuration of the specialized institution list 3300 that is managed by the appointment server 100. Specialized institutions at which the user can make appointments are registered in the specialized institution list 3300. The specialized institution list 3300 is, for example, stored in the storage 103 and managed by the appointment data manager 101 of the appointment server 100.

The appointment terminal 200 acquires the specialized institution list 3300 from the appointment server 100 when the appointment screen generator 201 displays the top screen 1400.

Information on one specialized institution is registered in one record in the specialized institution list 3300. Registered information includes a “specialized institution ID”, a “type”, a “specialized institution name”, “contents”, a “required time”, and a “fee”.

The “specialized institution ID” is an identifier that is uniquely set for each specialized institution. The “specialized institution ID” is assigned by the appointment data manager 101 when a specialized institution is registered in the appointment server 100.

The “type” represents a type of the specialized institution with a corresponding “specialized institution ID”. The example shown in FIG. 33 reveals that the “type” of the specialized institution with a “specialized institution ID” of “T0001” is a “hospital”.

The “specialized institution name” represents a name of the specialized institution with a corresponding “specialized institution ID”. The example shown in FIG. 33 reveals that the “specialized institution name” corresponding to a “specialized institution ID” of “T0001” is the “•• Hospital”.

The “contents” represent contents of the specialized institution with a corresponding “specialized institution ID”. The example shown in FIG. 33 reveals that the “contents” of the specialized institution with a “specialized institution ID” of “T0001” are “internal medicine checkup”.

The “required time” represents a required time when using the specialized institution with a corresponding “specialized institution ID”. The example shown in FIG. 33 reveals that the “required time” of the specialized institution with a “specialized institution ID” of “T0001” is “approximately 1 hour”. The “fee” represents a fee for the specialized institution with a corresponding “specialized institution ID”. The example shown in FIG. 33 reveals that the “fee” for the specialized institution with a “specialized institution ID” of “T0001” is “approximately 5,000 yen”.

Only main contents are included in the “contents”, the “required time”, and the “fee” of the specialized institution list 3300. Detailed contents of each specialized institution are described in a specialized institution service menu (not shown). The appointment data manager 101 of the appointment server 100 manages the specialized institution service menu. The appointment terminal 200 acquires the specialized institution service menu from the appointment server 100 when, for example, the specialized institution confirmation screen 1800 (FIG. 17) is displayed. When the content display field 1803 on the specialized institution confirmation screen 1800 is tapped, the appointment screen generator 201 displays the pull down menu 1808 based on the specialized institution service menu. Accordingly, the user can select other contents.

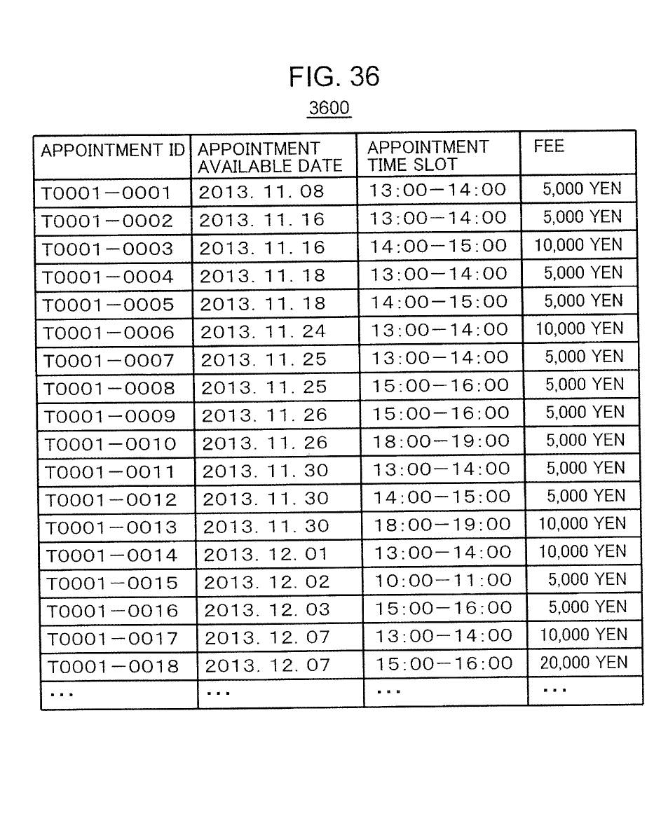

Moreover, a plurality of candidate dates are included for each specialized institution. The user can acquire the plurality of candidate dates from an appointment available date list 3600 (FIG. 36).

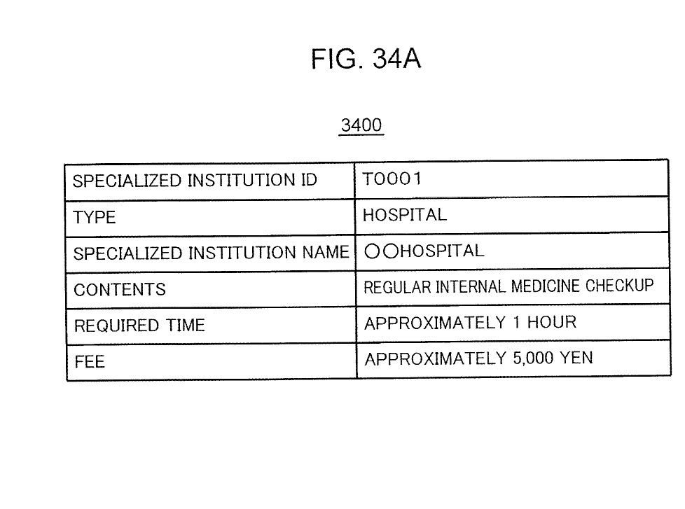

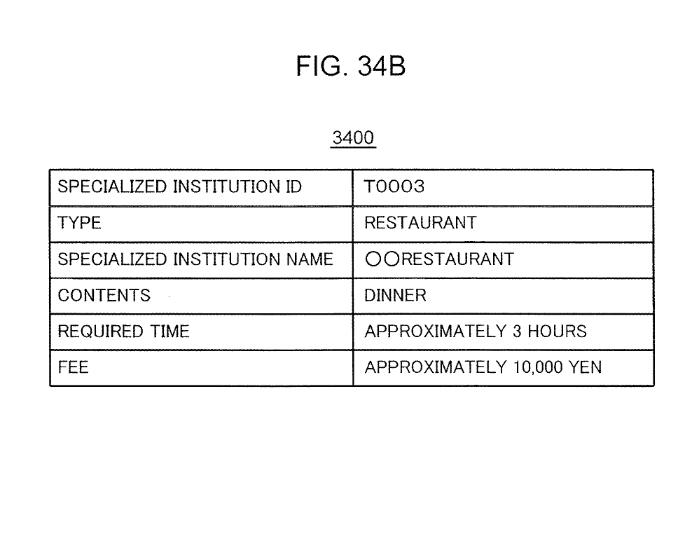

FIG. 34A is a diagram showing an example of a data configuration of recommended appointment information 3400. The recommended appointment information 3400 is data indicating contents of an appointment at a specialized institution which is in accordance with the preferences or history of the user. When appointment information in accordance with the preferences or history of the user is registered by a specialized institution in the appointment server 100, the appointment server 100 generates the recommended appointment information 3400. The appointment server 100 transmits the generated recommended appointment information 3400 to the appointment terminal 200 of a corresponding user.

The recommended appointment information 3400 includes a “specialized institution ID”, a “type”, a “specialized institution name”, “contents”, a “required time”, and a “fee” in a similar manner to the specialized institution list 3300.

In the example shown in FIG. 34A, the recommended appointment information 3400 includes information in which the “specialized institution list” is the “•• Hospital” and the “contents” are “periodic checkup of internal medicine”. The appointment server 100 refers to the customer information 3200 (FIG. 32) and transmits the recommended appointment information 3400 to, for example, the appointment terminal 200 of a user with a “user ID” of “U0001” and for which “periodic checkup at •• Hospital” is set in the “periodical service use status” field.

FIG. 34B is a diagram showing another example of a data configuration of the recommended appointment information 3400. In the example shown in FIG. 34B, the recommended appointment information 3400 includes information in which the “specialized institution list” is the “•• Restaurant” and the “contents” are “dinner”. The appointment server 100 refers to the customer information 3200 (FIG. 32) and transmits the recommended appointment information 3400 to, for example, the appointment terminal 200 of a user with a “user ID” of “U0002” and for which “cooking” is set in the “preference” field and “reservation at restaurant” is set in the “service use history” field.

FIG. 35 is a diagram showing an example of a data configuration of the calendar plan list 3500. The calendar plan list 3500 (an example of the schedule information) is data in which schedules input by the user using an appointment application or a calendar application are registered. The calendar plan list 3500 is used when the appointment screen generator 201 generates the calendar data display field 1904 described earlier. Moreover, the calendar plan list 3500 is also used when the calendar screen generator 205 displays a calendar screen. In addition, the calendar plan list 3500 is provided for each user.

Specifically, the calendar plan list 3500 is data in which one or more records are allocated to one plan and to which a “day”, a “time”, and “plan contents” are registered. The “day” represents the day on which a concerned plan is to be carried out. The “time” represents the time at which a concerned plan is to be carried out. The “plan contents” represent contents of a concerned plan.

For example, a plan for a “party” to be held between 13:00 and 18:00 on November 8. 2013 is registered to the record in the first row. Moreover, since the plan of the “party” ends on the same day, one record is allocated to the plan.

On the other hand, while a plan of a “trip” registered to the fourth to ninth rows is one plan, since the plan extends over six days, six records are allocated.

FIG. 36 is a diagram showing an example of a data configuration of the appointment available date list 3600. The appointment available date list 3600 is a list created by expanding the “specialized institution ID” of the specialized institution list 3300 (FIG. 33) with respect to an appointment available date. The appointment available date list 3600 is data that is generated by the appointment data manager 101 based on data registered in the appointment server 100 by a specialized institution. In the example shown in FIG. 36, the appointment available date list 3600 represents appointment available dates and times at a specialized institution corresponding to a “specialized institution ID” of “T0001”.

Specifically, the appointment available date list 3600 is data in which one record is allocated to one appointment available date and time and to which an “appointment ID”, an “appointment available date”, an “appointment time slot”, and a “fee” are registered.

The “appointment ID” is an identifier that is assigned by the appointment data manager 101 for each appointment available date and time of the “specialized institution ID” in the specialized institution list 3300. The “appointment available date” represents a corresponding appointment available date and time. The “appointment time slot” represents a time slot of a corresponding appointment available date and time. A fee as of the corresponding appointment available date and time is registered in the “fee”.

For example, an appointment available date and time with a fee of 5,000 yen is registered for 13:00 to 14:00 on Nov. 8, 2013 as data with an “appointment ID” of “T0001-0001” in the record of the first row.

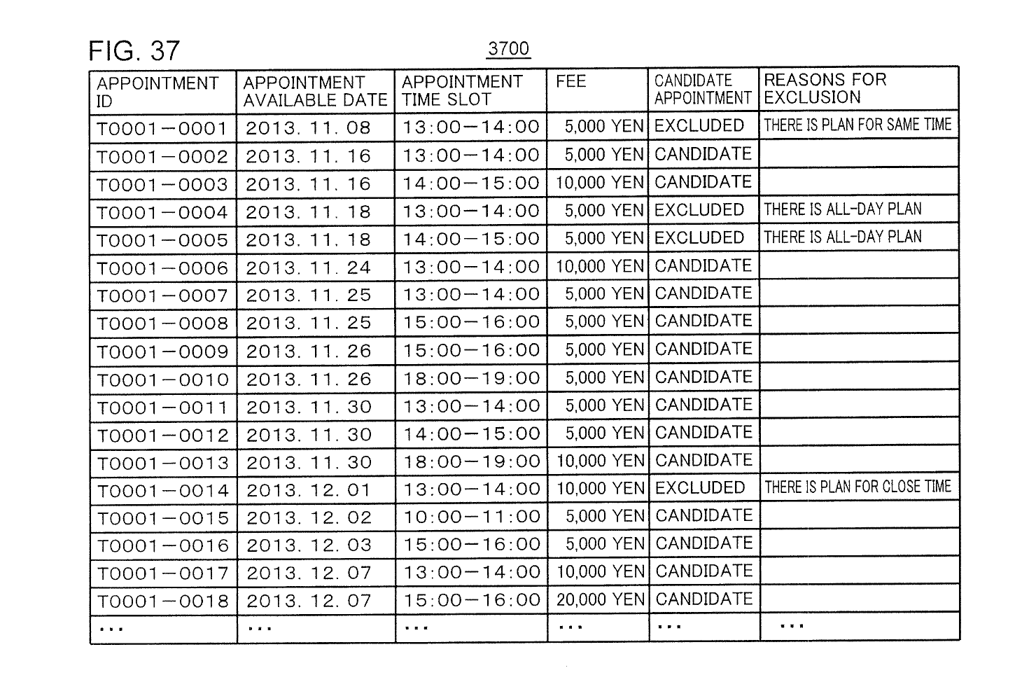

FIG. 37 is a diagram showing an example of a data configuration of a candidate appointment date list 3700. The candidate appointment date list 3700 is data which is created based on the appointment available date list 3600 and in which candidate appointment dates and times of a corresponding user are registered in the appointment available date list 3600. The candidate appointment date list 3700 is created for each user by the candidate appointment date selector 202 by referring to the calendar plan list 3500 and the appointment available date list 3600 of each user.

The candidate appointment date list 3700 is data in which one record is allocated to one appointment available date and time. An “appointment ID”, an “appointment available date”, an “appointment time slot”, a “fee”, a “candidate appointment”, and “reasons for exclusion” are registered in the candidate appointment date list 3700. The “appointment ID”, the “appointment available date”, the “appointment time slot”, and the “fee” are the same as data with the same names in the appointment available date list 3600.

In the “candidate appointment”, “candidate” is registered if a corresponding appointment available date and time is extracted as a candidate appointment date and time and “excluded” is registered if the corresponding appointment available date and time is excluded from the candidate appointment dates and times. The “reasons for exclusion” represents reasons for exclusion in a case where a corresponding appointment available date and time is excluded from the candidate appointment dates and times.

Hereinafter, assuming that the calendar plan list 3500 belongs to a user A, an extraction process of a candidate appointment date and time of the user A will be described.

For example, “13:00 to 14:00” on “Nov. 8, 2013” is registered as an appointment available date and time in a first row (with an “appointment ID” of “T0001-0001”) in the candidate appointment date list 3700. On the other hand, a plan of “party” is registered in the calendar plan list 3500 for the same time slot. Therefore, the candidate appointment date selector 202 excludes the appointment available date and time of the first row from the candidate appointment dates and times with respect to the user A. Therefore, “excluded” is registered as the “candidate appointment” in the record of the first row in the candidate appointment date list 3700 and “there is plan for concerned time” is registered as the “reasons for exclusion”. At this point, if a plan of the user is registered in a part of a time slot indicated by an appointment available date and time, the candidate appointment date selector 202 may exclude the appointment available date and time from the candidate appointment dates and times.

For example, “13:00 to 14:00” on “Nov. 16, 2013” is registered as an appointment available date and time in a second row (with an “appointment ID” of “T0001-0002”) in the candidate appointment date list 3700. On the other hand, there are no plans registered in the calendar plan list 3500 for the same time slot. Therefore, the candidate appointment date selector 202 extracts the appointment available date and time of the second row as a candidate appointment dates and times with respect to the user A. Therefore, “candidate” is registered as the “candidate appointment” in the record of the second row in the candidate appointment date list 3700 and nothing is registered as the “reasons for exclusion”.

For example, “there is all-day plan” is registered as the “reasons for exclusion” in a record of a fourth row (with an “appointment ID” of “T0001-0004”) in the candidate appointment date list 3700. This is because a plan is registered for 24 hours in the calendar plan list 3500 on the day to which the appointment available date and time of the record in the fourth row belongs.

For example, “plans for close time” is registered as the “reasons for exclusion” in a record of a 14th row (with an “appointment ID” of “T0001-0014”) in the candidate appointment date list 3700. This is because, while the appointment available date and time of this record is “13:00 to 14:00” on “Dec. 1, 2013”, a finish time for a plan to do shopping is registered one hour prior to “13:00” in the calendar plan list 3500 and an interval between the finish time of a time slot for this plan and a start time of the appointment available date and time is short. In this manner, even if a time slot represented by an appointment available date and time and a time slot represented by a plan of the user do not overlap each other, the candidate appointment date selector 202 may exclude the appointment available date and time from candidate appointment dates and times if an interval between the time slots is shorter than a specified value. Accordingly, the user can use the specialized institution without being rushed.

In this case, while the candidate appointment date selector 202 extracts a candidate appointment date and time by comparing a time slot represented by an appointment available date and time with a time slot represented by a candidate appointment date and time, the present disclosure is not limited thereto. For example, the candidate appointment date selector 202 may extract a candidate appointment date by comparing an appointment available date with a candidate appointment date.

For example, let us assume that a plan is registered in a time slot of 9:00 to 10:00 on Nov. 16, 2013 in the calendar plan list 3500. In this case, since an appointment available date and time of a second row in the candidate appointment date list 3700 is “13:00 to 14:00” on “Nov. 16, 2013”, although the time slots do not overlap each other, the appointment available date and time is excluded from the candidate appointment dates and times because the dates overlap each other.

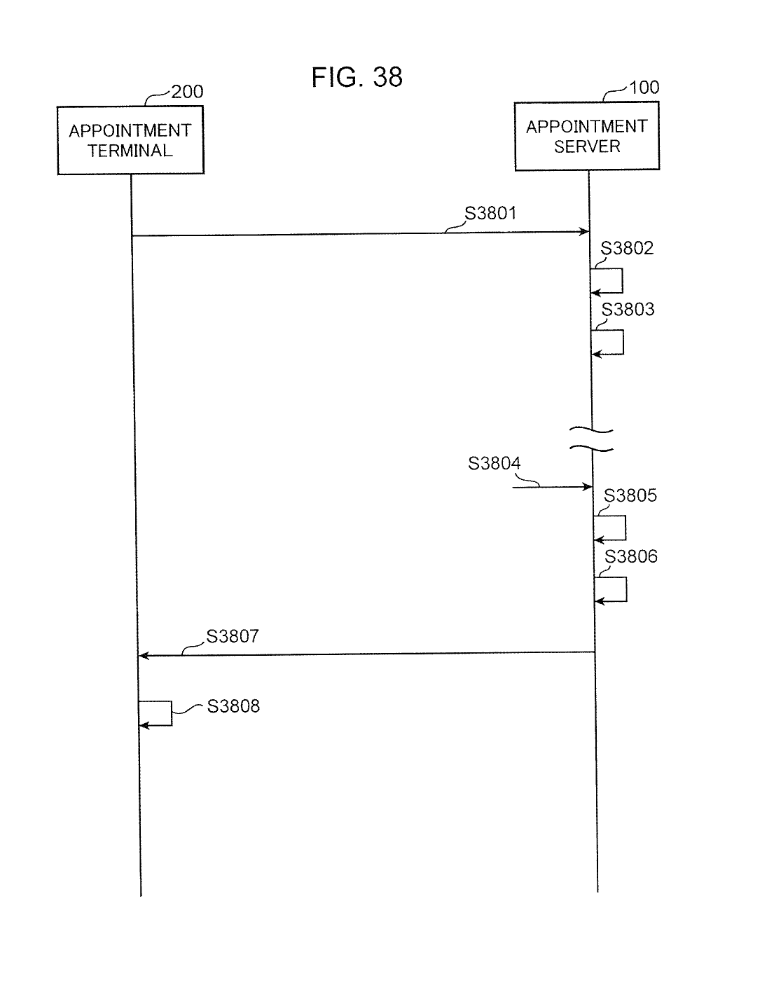

FIG. 38 is a sequence diagram showing a first example of an automatic startup process of an appointment application. In this case, the automatic startup process refers to a process for automatically starting up the appointment application without causing the user to input an operation to start up the appointment application. In the first example, the appointment server 100 stores customer history 3100 (FIG. 31) and manages customer information 3200 (FIG. 32).

First, the appointment terminal 200 transmits customer history 3100 (FIG. 31) to the appointment server 100 (S3801). At this point, for example, the appointment terminal 200 may transmit the customer history 3100 at regular time intervals or may transmit the customer history 3100 when new history is created.

Next, the appointment server 100 stores the transmitted customer history 3100 (S3802). In this case, the customer history 3100 is received by the communicating portion 105 and stored in the storage 103.

Subsequently, the appointment server 100 analyzes preferences or history of a customer based on the customer history 3100 and updates the customer information 3200 based on a result of the analysis (S3803).

Next, at a given timing, new appointment information is registered in the appointment server 100 by a specialized institution (S3804). Based on the registration, the specialized institution list 3300 (FIG. 33) is updated by the appointment data manager 101 (S3805).

Subsequently, based on the customer information 3200, the appointment data manager 101 determines whether or not there is a customer whose preferences or history are in accordance with the appointment information registered in S3804 (S3806). When it is determined that there is a customer whose preferences or history are in accordance with the appointment information registered in S3804, the appointment data manager 101 generates the recommended appointment information 3400 and transmits the generated recommended appointment information 3400 to the appointment terminal 200 of the determined customer (when there are a plurality of determined customers, to the appointment terminals 200 of the determined customers) via the communicating portion 105 (S3807). In this case, the communicating portion 105 of the appointment server 100 transmits the recommended appointment information 3400 to the appointment terminal 200 to which a user ID in the customer information 3200 has been registered.

For example, when discount information of a restaurant is registered in S3804, in the example shown in FIG. 32, recommended appointment information is transmitted to the appointment terminals 200 of three users whose “user IDs” are “U0001”, “U0002”, and “U0004” and for which “cooking” is registered among top three preferences in the “preference” field in the customer information 3200.

For example, when discount information of a tennis court is registered in S3804, in the example shown in FIG. 32, recommended appointment information is transmitted to the appointment terminals 200 of two users whose “user IDs” are “U0004” and “U0005” and for which “sports” is registered among top three preferences in the “preference” field in the customer information 3200.

Next, the appointment terminal 200 starts up the appointment application (S3808). In this case, the appointment screen generator 201 displays the appointment guide notification screen 1700 on the display 209. Moreover, the processes of S3807 and S3808 are not executed if it is determined that there are no customers whose preferences or history are in accordance with the appointment information registered in S3804. Accordingly, when there is a customer whose preferences or history are in accordance with the appointment information registered in S3804, the appointment application is automatically started up.

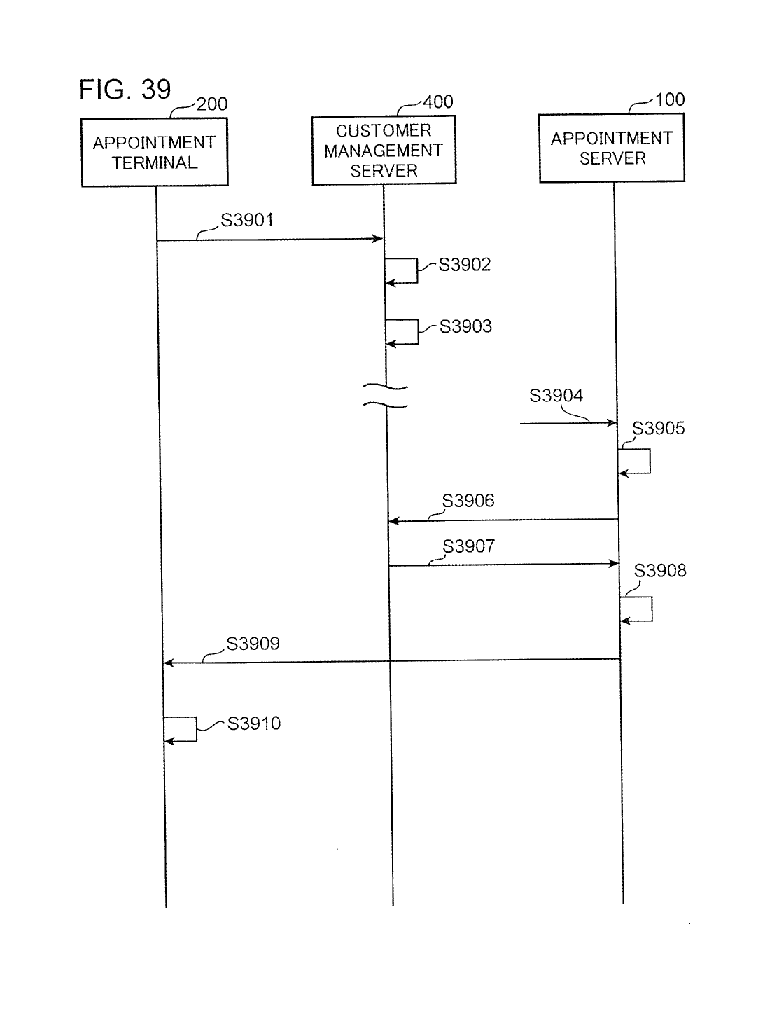

FIG. 39 is a sequence diagram showing a second example of an automatic startup process of the appointment application. In the second example, the customer management server 400 stores the customer history 3100 (FIG. 31) and manages the customer information 3200 (FIG. 32).

First, the appointment terminal 200 transmits the customer history 3100 (FIG. 31) to the customer management server 400 (S3901). Next, the customer management server 400 stores the transmitted customer history 3100 (S3902). In this case, the communicating portion 403 receives the customer history 3100 and the customer manager 402 stores the customer history 3100 in the storage 401.

Subsequently, the customer management server 400 analyzes preferences or history of a customer based on the customer history 3100 and updates the customer information 3200 based on a result of the analysis (S3903).

Next, at a given timing, new appointment information is registered in the appointment server 100 by a specialized institution (S3904). Then, the specialized institution list 3300 (FIG. 33) is updated by the appointment data manager 101 (S3905).

Subsequently, the appointment data manager 101 issues a request to the customer management server 400 for information on a customer whose preferences or history are in accordance with the appointment information registered in S3904 (S3906). In this case, the appointment data manager 101 identifies a genre such as “restaurant” and “travel” from the appointment information registered in S3904 and requests information on a customer whose preferences or history are in accordance with the identified genre.

Next, if there is a customer in accordance with the genre that has been requested in S3906 based on the customer information 3200, the customer management server 400 transmits the information on the customer to the appointment server 100 (S3907).

Subsequently, when information on a customer is transmitted in S3907, the appointment data manager 101 generates the recommended appointment information 3400 (S3908). Subsequent processes S3909 and S3910 are the same as S3807 and S3808 in FIG. 38. Moreover, the processes of S3908 to S3910 are not executed if information on a customer is not transmitted in S3907. Accordingly, when information on a customer whose preferences or history are in accordance with the appointment information registered in S3904 is transmitted in S3907, the appointment application is automatically started up.

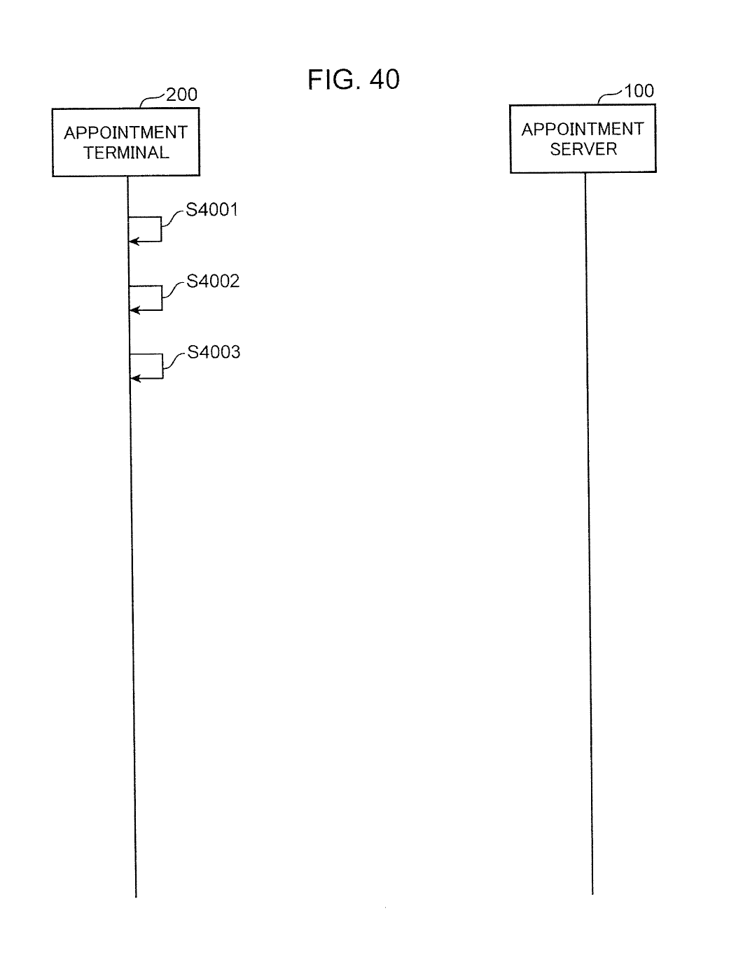

FIG. 40 is a sequence diagram showing a startup process of the appointment application when the appointment application is an embedded application. In this case, an embedded application refers to an application which is stored in a local memory (for example, a rewritable non-volatile storage device) of the appointment terminal 200 and which is read out from the local memory upon each startup.

First, the appointment terminal 200 starts up the appointment application (S4001). In this case, startup of the appointment application is triggered by an input of an operation for starting up the appointment application by the user or by transmission of the recommended appointment information 3400.

Next, the appointment terminal 200 reads the appointment application from the local memory (S4002). In this case, the appointment application is read from the local memory by, for example, a processor of the appointment terminal 200.

Subsequently, the appointment terminal 200 displays a screen of the appointment application on the display 209 (S4003). At this point, the top screen 1700 is displayed when the startup of the appointment application is triggered by the input of an operation by the user and the appointment guide notification screen 1700 is displayed when the startup of the appointment application is triggered by the transmission of the recommended appointment information 3400.

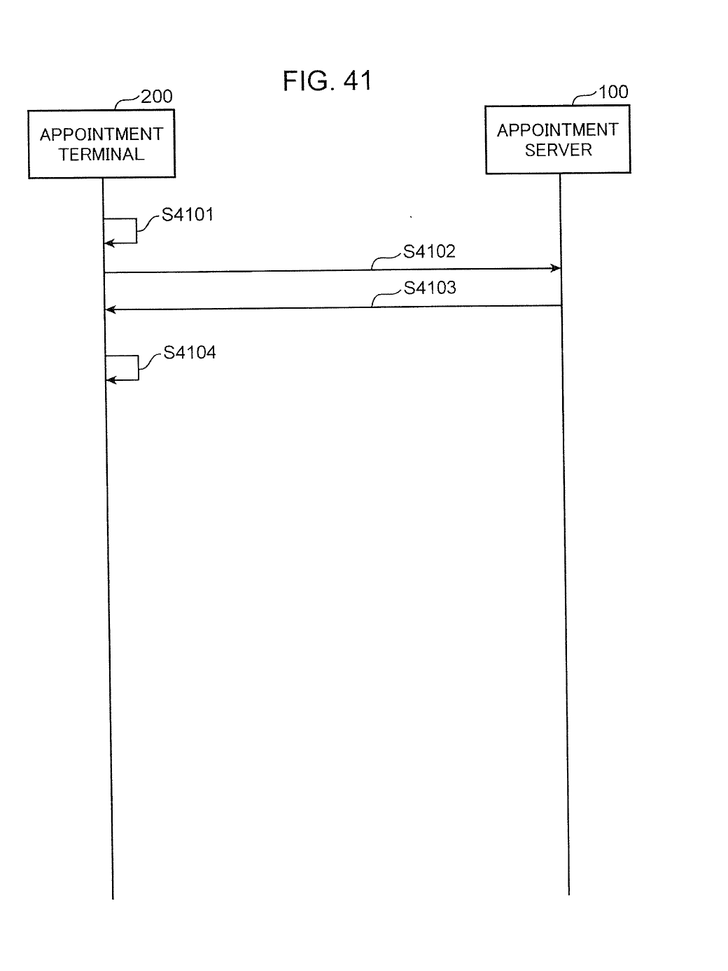

FIG. 41 is a sequence diagram showing a startup process of the appointment application when the appointment application is an HTML application. In this case, an HTML (Hyper Text Markup Language) application refers to, for example, an application which is described in a script language such as HTML and JavaScript that is executable by a browser and which is downloaded by the appointment terminal 200 from the appointment server 100 upon each startup of the application.

First, the appointment terminal 200 starts up the appointment application (S4101). The triggers for the startup of the appointment application are the same as in S4001. Next, the appointment terminal 200 transmits an acquisition request for the appointment application to the appointment server 100 (S4102). Subsequently, the appointment server 100 transmits the appointment application to the appointment terminal 200 (S4103). Next, the appointment terminal 200 displays a screen of the appointment application (S4104). Details of the display at this point are the same as in S4003.

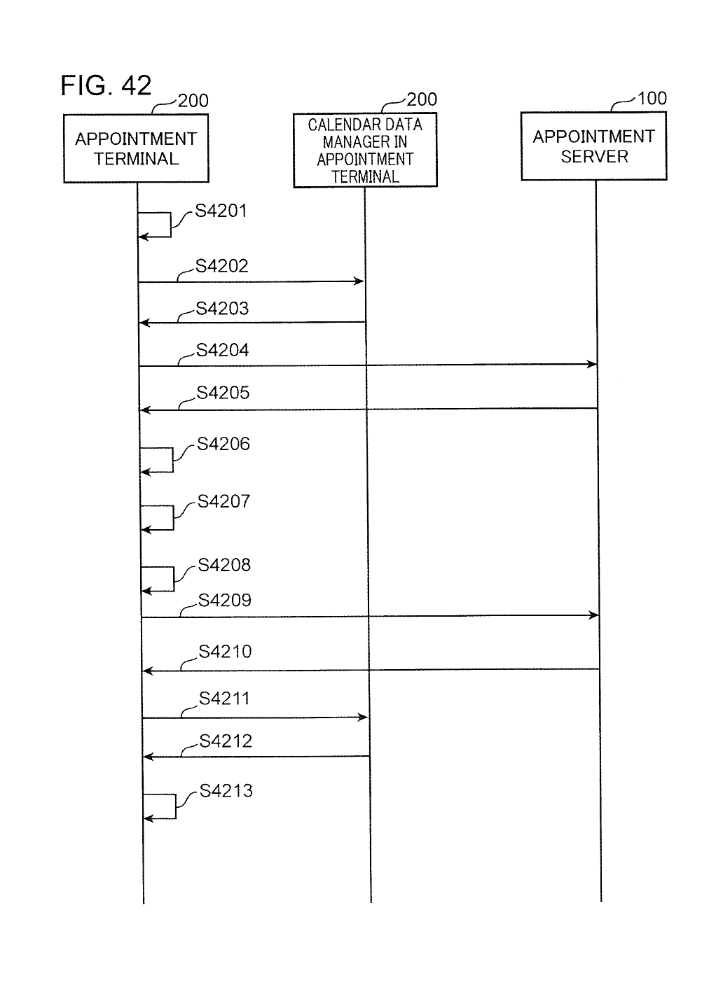

FIG. 42 is a sequence diagram of a process sequence S1-1 that is an overall process sequence of a first example of the appointment system according to the present disclosure. In this case, in the process sequence S1-1, the calendar data manager 206 is included in the appointment terminal 200 and the appointment terminal 200 executes an extraction process of a candidate appointment date. In addition, “S1” in the process sequence S1-1 denotes that a configuration of the appointment system is any of those shown in FIGS. 5 to 9.

First, the appointment terminal 200 displays a screen of the appointment application on the display 209 (S4201). At this point, the appointment date selection screen 1900 is displayed on which no candidate appointment dates are shown.

Next, the appointment screen generator 201 of the appointment terminal 200 notifies an acquisition request for the calendar plan list 3500 to the calendar data manager 206 (S4202). Subsequently, the calendar data manager 206 notifies the calendar plan list 3500 to the appointment screen generator 201 (S4203).

Next, using the communicating portion 208, the appointment screen generator 201 of the appointment terminal 200 transmits an acquisition request for appointment available dates and times to the appointment server 100 (S4204). Subsequently, the appointment server 100 transmits appointment available dates and times to the appointment terminal 200 (S4205).

Next, the candidate appointment date selector 202 of the appointment terminal 200 executes an extraction process of a candidate appointment date using the calendar plan list 3500 and the appointment available dates and times (S4206). Subsequently, using an extraction result, the appointment screen generator 201 displays a candidate appointment date and time or a candidate appointment date in the calendar data display field 1904 (S4207). For example, when a mode is adopted in which a candidate appointment date is displayed, the candidate symbol 1906 is displayed in the box 1905 corresponding to the candidate appointment date on the appointment date selection screen 1900. Alternatively, when a mode is adopted in which a candidate appointment date and time is displayed, the candidate appointment time 2201 is displayed in the box 1905 corresponding to the candidate appointment date and time on the appointment date selection screen 1900. Moreover, when a mode is adopted in which a fee is displayed together with a candidate appointment date and time or a candidate appointment date, a fee is displayed in the box 1905 corresponding to the candidate appointment date and time or the candidate appointment date. In this case, the candidate appointment date selector 202 may acquire a fee corresponding to the appointment available date and time in S4205 and display the fee in the corresponding box 1905.

Next, the screen controller 204 of the appointment terminal 200 accepts an operation for selecting a candidate appointment date and time by the user (S4208). In this case, the user may input an operation for selecting a candidate appointment date and time on the appointment date selection screen 1900 and the appointment time selection screen 2400.

Subsequently, the appointment screen generator 201 transmits an appointment request to the appointment server 100 using the communicating portion 208 (S4209). The appointment request includes the candidate appointment date and time selected by the user and is transmitted when the appointment button 2606 is tapped on the appointment content confirmation screen 2600.

At this point, the appointment data manager 101 of the appointment server 100 registers the candidate appointment date and time indicated in the appointment request as an appointment date and time in the appointment available date list 3600 that is stored in the appointment data storage 102. In this case, an “appointment accepted” (not shown) field may be provided in the appointment available date list 3600 and the appointment data manager 101 may register a user ID of a user having made an appointment in the “appointment accepted” field of an appointment available date and time corresponding to the appointment date and time indicated by the appointment request. Accordingly, the appointment server 100 can manage the appointment date and time of an appointment made by the user.

Next, the appointment data manager 101 of the appointment server 100 transmits an appointment result that represents the accepted appointment date and time to the appointment terminal 200 using the communicating portion 105 (S4210).

Subsequently, the candidate appointment date selector 202 notifies a registration request for the appointment date and time represented by the transmitted appointment result to the calendar data manager 206 (S4211). Accordingly, the calendar data manager 206 registers the appointment date and time represented by the appointment result in the calendar plan list 3500 stored in the calendar data storage 207.

Next, the calendar data manager 206 notifies the calendar plan list 3500 in which the appointment date and time has been registered to the appointment screen generator 201 (S4212).

Subsequently, the appointment screen generator 201 generates the appointment completion screen 2700 using the notified calendar plan list 3500 and displays the appointment completion screen 2700 on the display 209 (S4213). In this case, as shown in FIG. 27 or 28, the appointment completion screen 2700 on which the appointment icon 2702 is displayed in the box 1905 corresponding to the appointment date and time is displayed on the display 209.

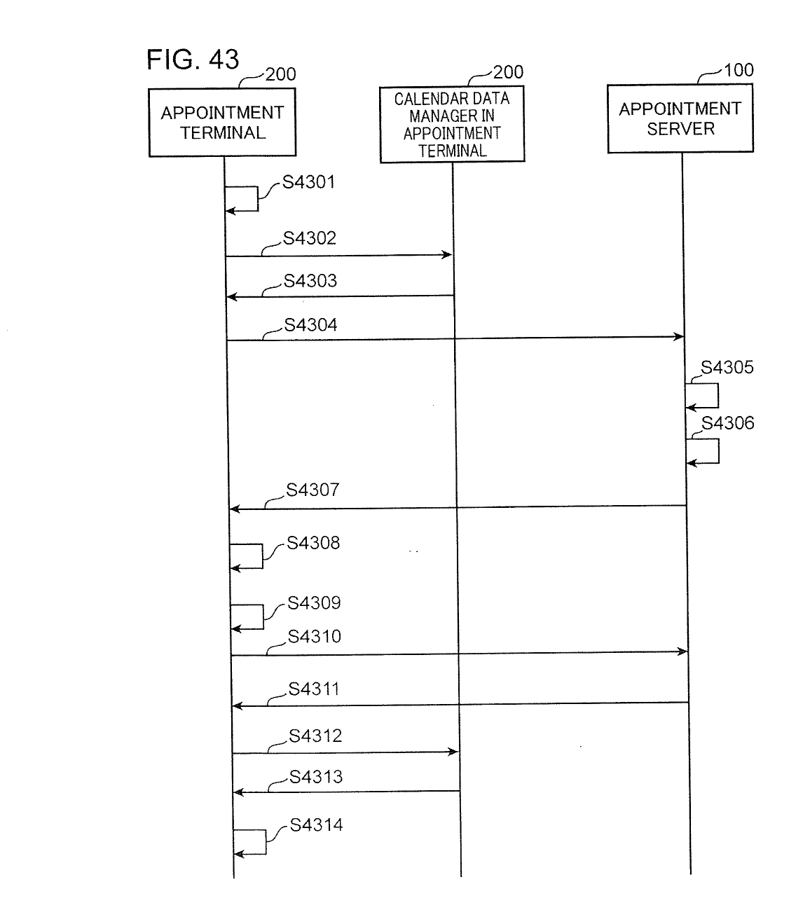

FIG. 43 is a sequence diagram of a process sequence S1-2 that is an overall process sequence of a second example of the appointment system according to the present disclosure. In this case, in the process sequence S1-2, the calendar data manager 206 is included in the appointment terminal 200 and the appointment server 100 executes an extraction process of a candidate appointment date.

S4301 to S4303 are the same as S4201 to S4203 in FIG. 42. In S4304, the appointment terminal 200 transmits an acquisition request for a candidate appointment date and time or a candidate appointment date to the appointment server 100 (S4304). In this case, the calendar plan list 3500 is included in the acquisition request. Accordingly, the appointment server 100 can acquire the calendar plan list 3500.

Next, the appointment data manager 101 of the appointment server 100 acquires appointment available dates and times from the appointment available date list 3600 stored in the appointment data storage 102 (S4305). Subsequently, the candidate appointment date selector 106 executes an extraction process of a candidate appointment date using the calendar plan list 3500 and the acquired appointment available dates and times (S4306). Details of the extraction process are the same as in S4206 in FIG. 42.

Next, the candidate appointment date selector 106 transmits an extraction result to the appointment terminal 200 using the communicating portion 105 (S4307). S4308 to S4314 are the same as S4207 to S4213 in FIG. 42.

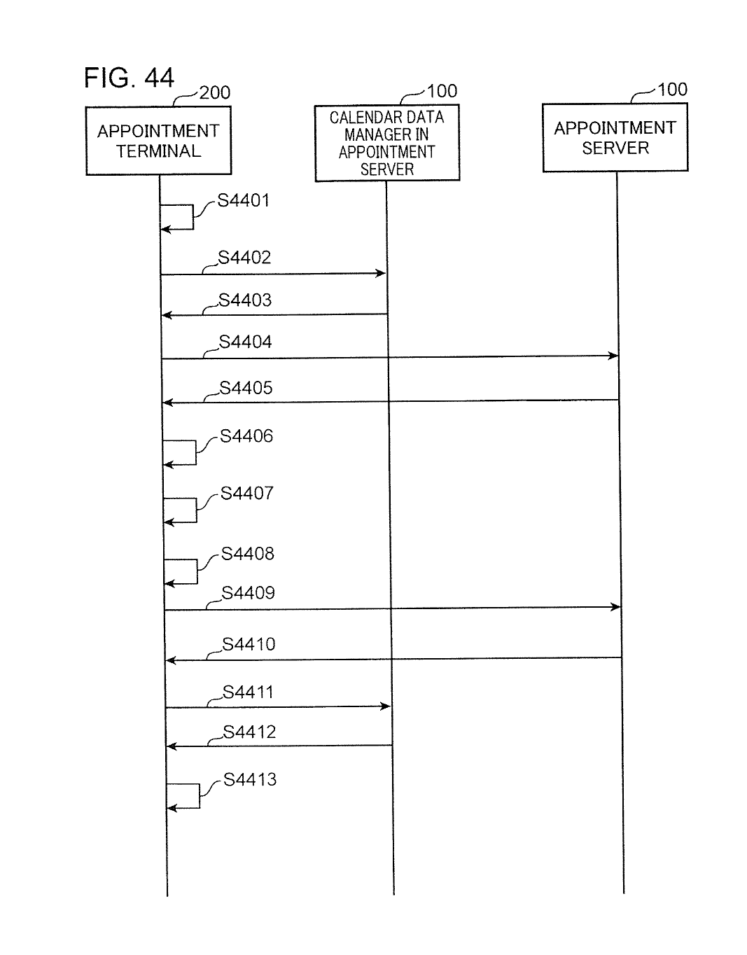

FIG. 44 is a sequence diagram of a process sequence S1-3 that is an overall process sequence of a third example of the appointment system according to the present disclosure. In this case, in the process sequence S1-3, the calendar data manager 107 is included in the appointment server 100 and the appointment terminal 200 executes an extraction process of a candidate appointment date.

S4401 is the same as S4201 in FIG. 42. Next, the appointment screen generator 201 of the appointment terminal 200 transmits an acquisition request for the calendar plan list 3500 to the appointment server 100 (S4402). Subsequently, the calendar data manager 107 of the appointment server 100 acquires the calendar plan list 3500 of the user who owns the appointment terminal 200 which had transmitted the acquisition request from the calendar data storage 108 and transmits the calendar plan list 3500 to the appointment terminal 200 (S4103).

S4404 to S4413 are the same as S4204 to S4213 in FIG. 42.

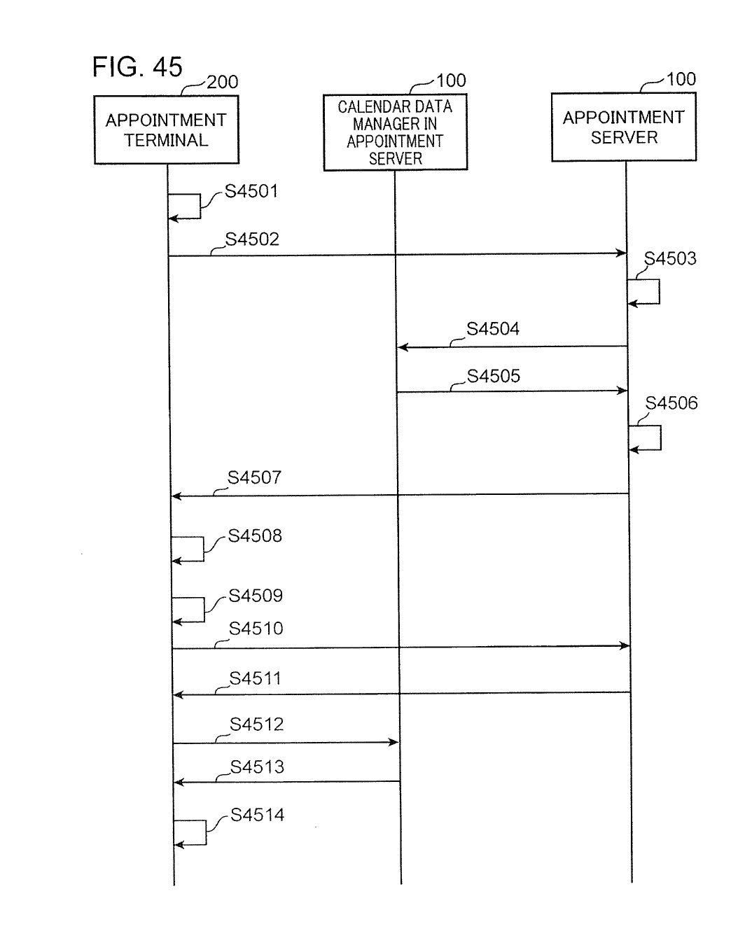

FIG. 45 is a sequence diagram of a process sequence S1-4 that is an overall process sequence of a fourth example of the appointment system according to the present disclosure. In this case, in the process sequence S1-4, the calendar data manager 107 is included in the appointment server 100 and the appointment server 100 executes an extraction process of a candidate appointment date.

S4501 is the same as S4201 in FIG. 42. Next, the appointment screen generator 201 of the appointment terminal 200 transmits an acquisition request for appointment available dates and times to the appointment server 100 (S4502).

Subsequently, the candidate appointment date selector 106 of the appointment server 100 acquires appointment available dates and times from the appointment available date list 3600 stored in the appointment data storage 102 (S4503). Next, the candidate appointment date selector 106 notifies an acquisition request for the calendar plan list 3500 of the user who owns the appointment terminal 200 which had transmitted the acquisition request to the calendar data manager 107 (S4504).

Subsequently, the calendar data manager 107 acquires the calendar plan list 3500 of the corresponding user and notifies the calendar plan list 3500 to the candidate appointment date selector 106 (S4505). S4506 to S4514 are the same as S4306 to S4314 in FIG. 43.

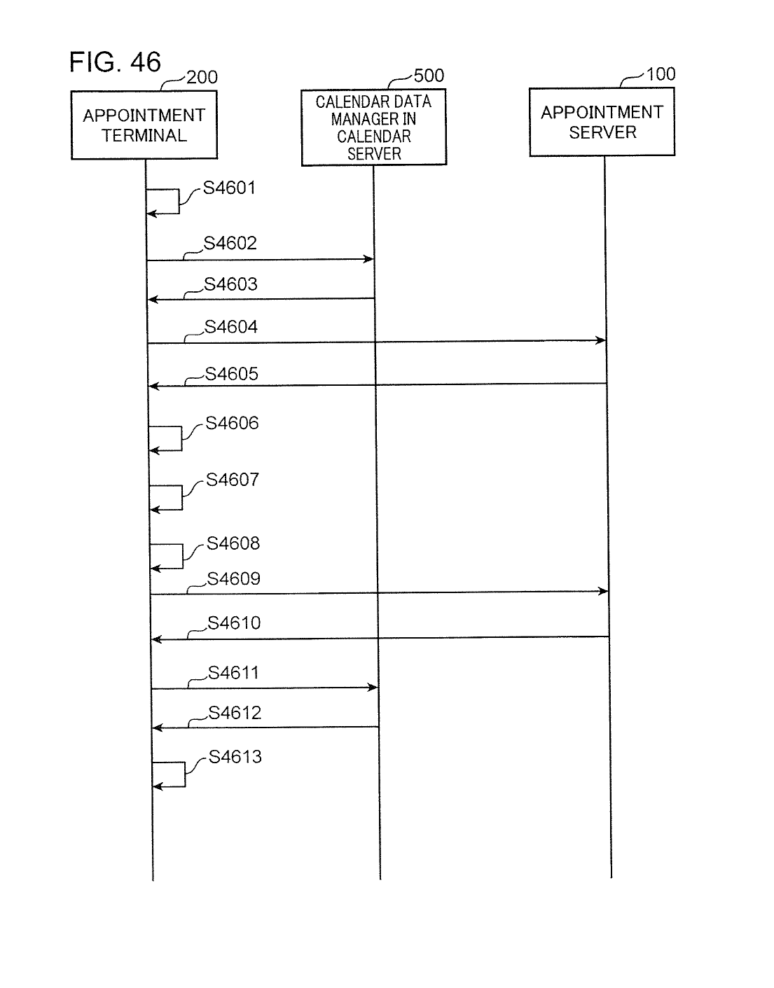

FIG. 46 is a sequence diagram of a process sequence S2-1 that is an overall process sequence of a fifth example of the appointment system according to the present disclosure. In this case, in the process sequence S2-1, the calendar data manager 502 is included in the calendar server 500 and the appointment terminal 200 executes an extraction process of a candidate appointment date. In addition, “S2” in the process sequence S2-1 denotes that a configuration of the appointment system is any of those shown in FIGS. 10 to 12.

S4601 is the same as S4201 in FIG. 42. Next, the appointment screen generator 201 of the appointment terminal 200 transmits an acquisition request for the calendar plan list 3500 to the calendar server 500 (S4602). Subsequently, the calendar data manager 502 of the calendar server 500 acquires the calendar plan list 3500 of the user who owns the appointment terminal 200 which had transmitted the acquisition request from the calendar data storage 108 and transmits the calendar plan list 3500 to the appointment terminal 200 (S4603). S4604 to S4613 are the same as S4404 to S4413 in FIG. 44.

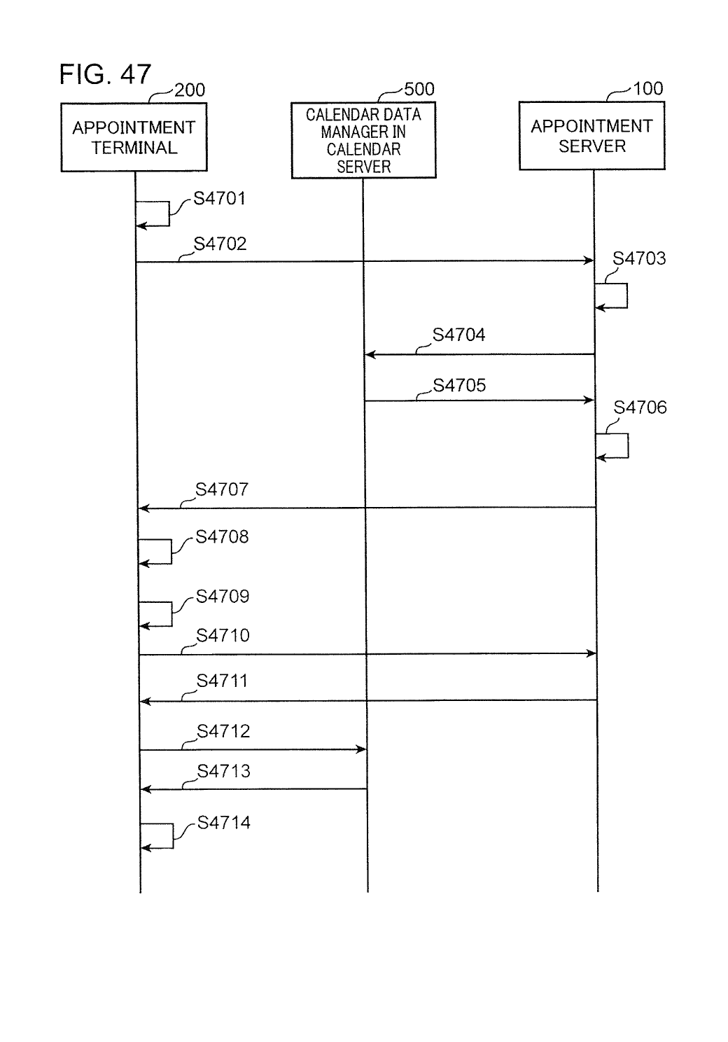

FIG. 47 is a sequence diagram of a process sequence S2-2 that is an overall process sequence of a sixth example of the appointment system according to the present disclosure. In this case, in the process sequence S2-2, the calendar data manager 502 is included in the calendar server 500 and the appointment server 100 executes an extraction process of a candidate appointment date.

S4701 is the same as S4201 in FIG. 42. S4702 and S4703 are the same as S4502 and S4503 in FIG. 45. Next, the candidate appointment date selector 106 notifies an acquisition request for the calendar plan list 3500 of the user who owns the appointment terminal 200 which had transmitted the acquisition request to the calendar server 500 (S4704).

Subsequently, the calendar data manager 502 of the calendar server 500 acquires the calendar plan list 3500 of the corresponding user from the calendar data storage 503 and notifies the calendar plan list 3500 to the appointment server 100 (S4705). S4706 to S4714 are the same as S4506 to S4514 in FIG. 45.

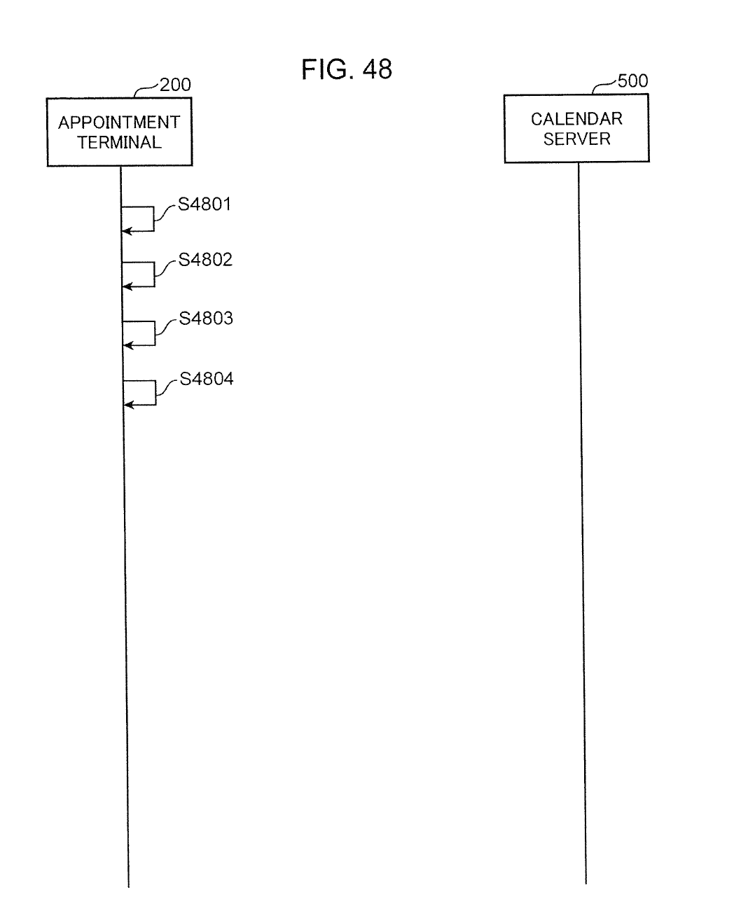

FIG. 48 is a sequence diagram showing a startup process of a calendar application when the calendar application is an embedded application. First, the appointment terminal 200 starts up the calendar application (S4801). In this case, the startup of the calendar application by the appointment terminal 200 is triggered by an input of an operation for starting up the calendar application by the user.

Next, the appointment terminal 200 reads the calendar application from the local memory (S4802). In this case, the calendar application is read from the local memory by, for example, a processor of the appointment terminal 200.

Subsequently, the calendar screen generator 205 acquires the calendar plan list 3500 from the calendar data manager 206 (S4803).

Next, the calendar screen generator 205 displays a screen of the calendar application on the display 209 (S4804).

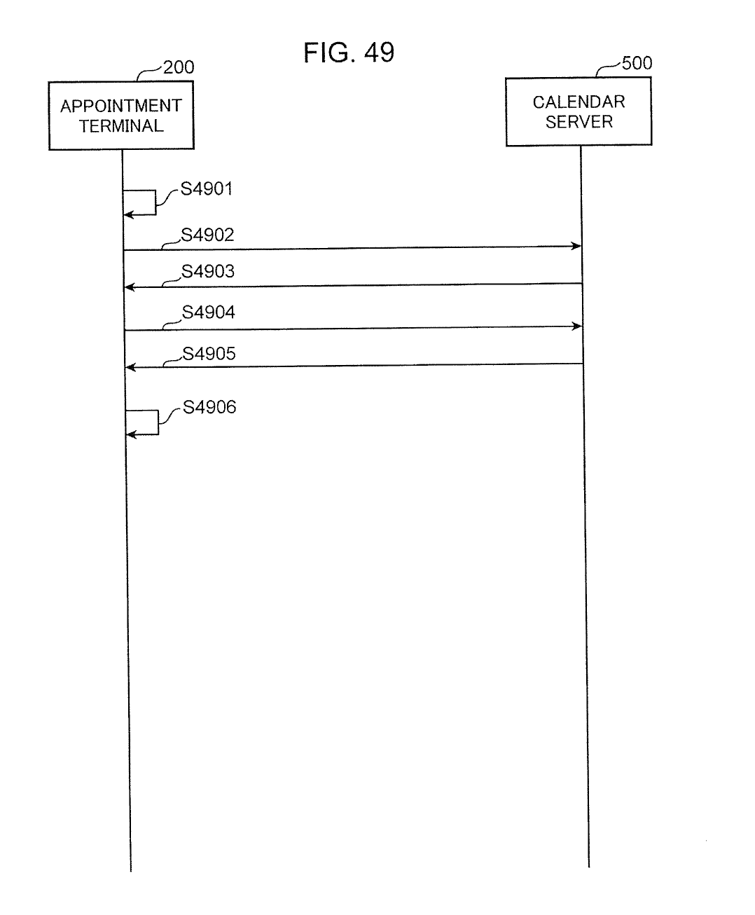

FIG. 49 is a sequence diagram showing a startup process of the calendar application when the calendar application is an HTML application.

First, the appointment terminal 200 starts up the calendar application (S4901). The trigger for the startup of the calendar application is the same as in S4801. Next, the appointment terminal 200 transmits an acquisition request for the calendar application to the calendar server 500 (S4902). Subsequently, the calendar server 500 transmits the calendar application to the appointment terminal 200 (S4903). Next, the calendar screen generator 205 of the appointment terminal 200 transmits an acquisition request for the calendar plan list 3500 of the user who owns the appointment terminal 200 to the calendar server 500 (S4904). Subsequently, the calendar server 500 transmits the calendar plan list 3500 of the corresponding user to the appointment terminal 200 (S4905). Next, the calendar screen generator 205 displays a screen of the calendar application using the transmitted calendar plan list 3500 (S4906).

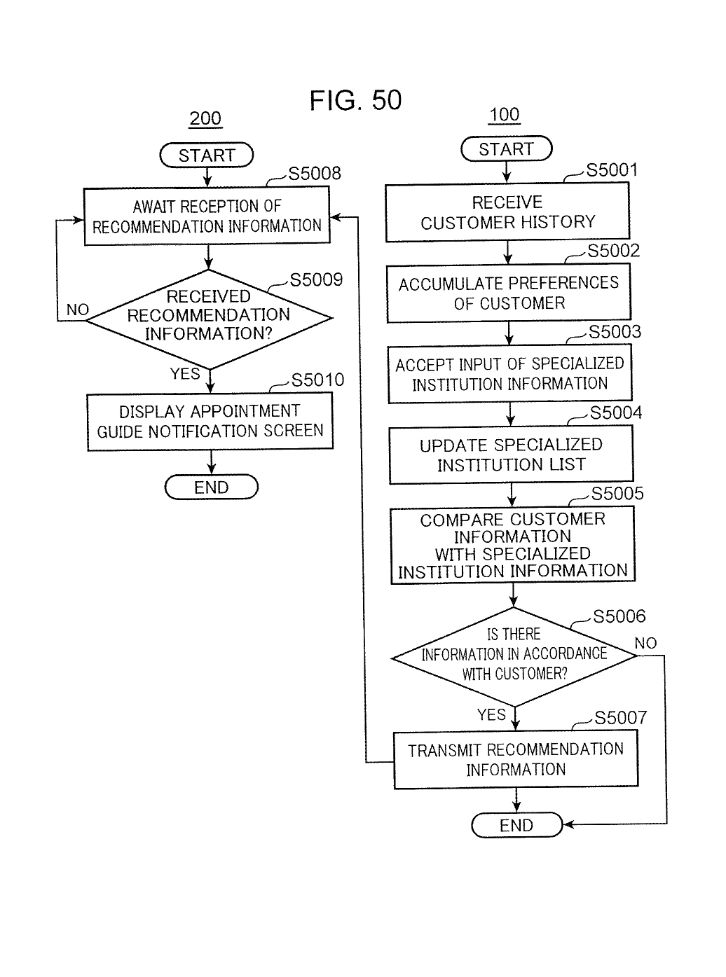

FIG. 50 is a flow chart showing a first example of an automatic startup process of the appointment application. In FIG. 50, the appointment server 100 manages the customer information 3200 (FIG. 32). The flow chart in FIG. 50 corresponds to the sequence diagram shown in FIG. 38.

First, the appointment server 100 receives the customer history 3100 (FIG. 31) from the appointment terminal 200 (S5001). Next, the appointment server 100 manages the customer information 3200 generated by accumulating preferences and history of a customer (S5002).

Subsequently, the appointment server 100 accepts an input of appointment information from an outside specialized institution and registers the appointment information (S5003). Next, the appointment server 100 updates the specialized institution list 3300 (FIG. 33) by incorporating the accepted appointment information (S5004). Subsequently, the appointment server 100 compares the managed customer information 3200 and the specialized institution list 3300 with each other (S5005).

Next, the appointment server 100 determines whether or not there is information in accordance with the customer in the specialized institution list 3300 (S5006). When there is no information in accordance with the customer (NO in S5006), the process by the appointment server 100 is ended.

On the other hand, when there is information in accordance with the customer in S5006 (YES in S5006), the appointment server 100 generates the recommended appointment information 3400, transmits the generated recommended appointment information 3400 to the appointment terminal 200 of the corresponding user (S5007), and the process by the appointment server 100 is ended.

Meanwhile, the appointment terminal 200 is standing by to receive the recommended appointment information 3400 (S5008 and NO in S5009). Subsequently, when the recommended appointment information 3400 is received (YES in S5009), the appointment screen generator 201 displays the appointment guide notification screen 1700 on the display 209 (S5010) and the process by the appointment terminal 200 is ended.

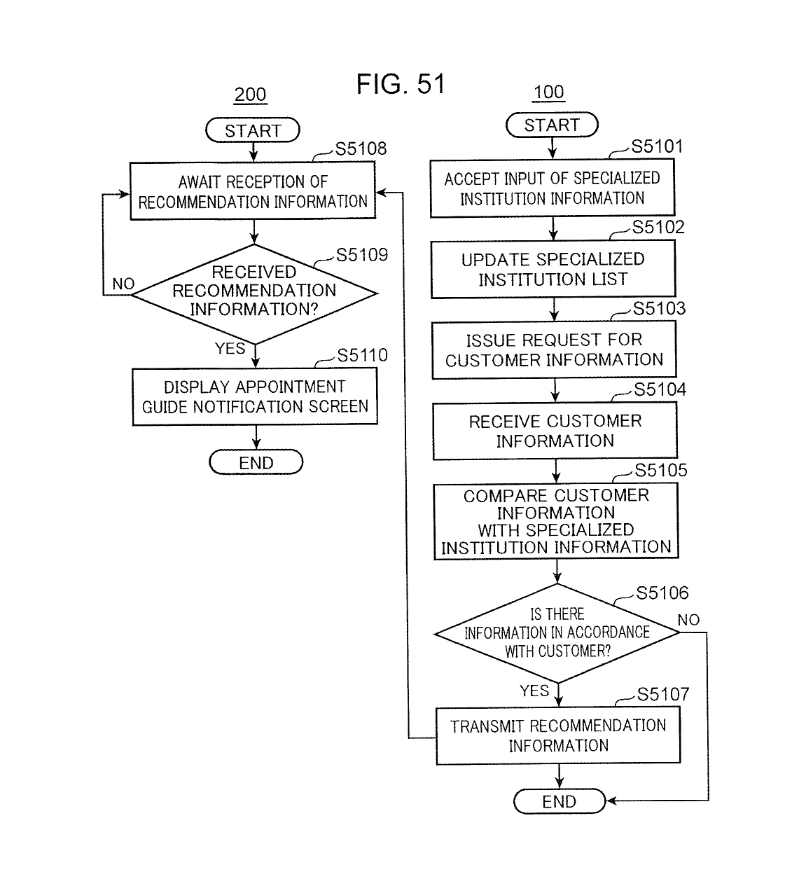

FIG. 51 is a flow chart showing a second example of the automatic startup process of the appointment application. In FIG. 51, the customer management server 400 manages the customer information 3200 (FIG. 32). The flow chart in FIG. 51 corresponds to the sequence diagram shown in FIG. 39.

S5101 and S5102 are the same as S5003 and S5004 in FIG. 50. Subsequent to S5102, the appointment server 100 transmits a request for the customer information 3200 (FIG. 32) to the customer management server 400 (S5103). Next, the appointment server 100 receives the customer information 3200 from the customer management server 400 (S5104).

S5105 to S5107 subsequent to S5104 are the same as S5005 to S5007 in FIG. 50. S5108 to S5110 performed by the appointment terminal 200 are the same as S5008 to S5010 in FIG. 50.

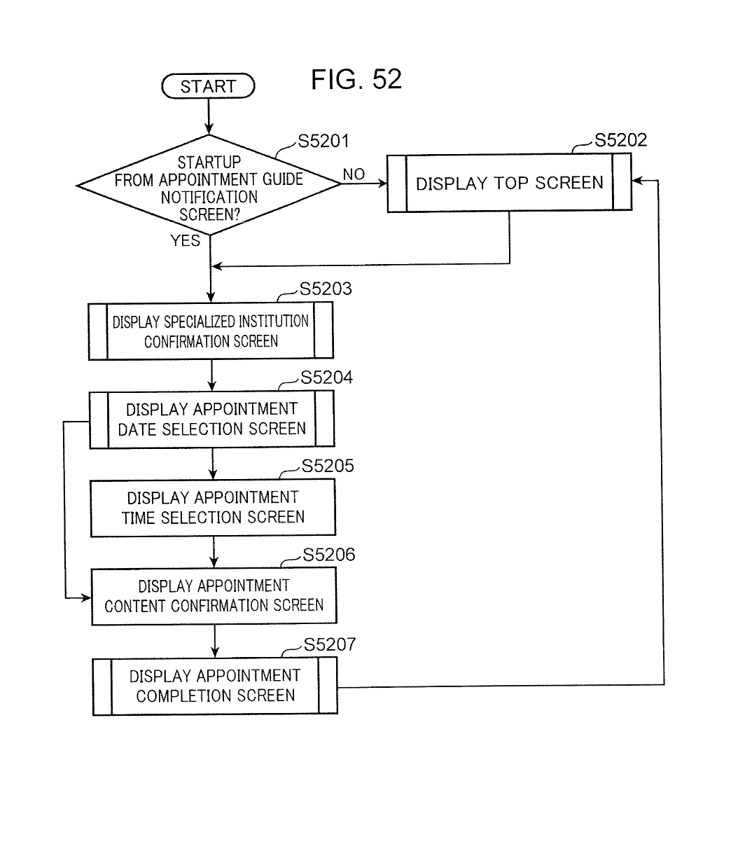

FIG. 52 is a flow chart showing an example of an overall process of the appointment application. First, in a case of a startup from the appointment guide notification screen 1700 (YES in S5201), the appointment screen generator 201 executes a display process of the specialized institution confirmation screen 1800 (S5203). On the specialized institution confirmation screen 1800, the appointment screen generator 201 advances the process to S5202 when the top button 1801 is tapped and advances the process to S5204 when the appointment button 1806 is tapped. Details of the display process of the specialized institution confirmation screen 1800 will be described later.

On the other hand, when the startup is not from the appointment guide notification screen 1700 (NO in S5201), the appointment screen generator 201 executes a display process of the top screen 1400 (S5202) and advances the process to S5203. Details of the display process of the top screen 1400 will be described later.

For example, when the appointment guide notification screen 1700 is tapped, the appointment screen generator 201 makes a determination of YES in S5201. In addition, when the appointment application icon 1301 is tapped on the basic screen 1300, the appointment screen generator 201 makes a determination of NO in S5201.

Next, the appointment screen generator 201 executes a display process of the appointment date selection screen 1900 (S5204). Details of the display process of the appointment date selection screen 1900 will be described later.

Subsequently, the appointment screen generator 201 displays the appointment time selection screen 2400 on the display 209 (S5205). When the appointment button 2405 is tapped on the appointment time selection screen 2400, the appointment screen generator 201 displays the appointment content confirmation screen 2600 on the display 209 (S5206). Next, the appointment screen generator 201 executes a display process of the appointment completion screen 2700 (S5207). When the top button 2701 is tapped on the appointment completion screen 2700, the appointment screen generator 201 advances the process to S5202. Details of the display process of the appointment completion screen 2700 will be described later.

Moreover, as described earlier, in the case of the appointment date selection screen 1900 according to the third example (FIG. 22), when the candidate appointment time 2201 is tapped, the appointment screen generator 201 may skip S5205 and advance the process to S5206.

Moreover, the appointment application may be ended at an arbitrary timing by an operation such as tapping a home button of the appointment terminal 200.

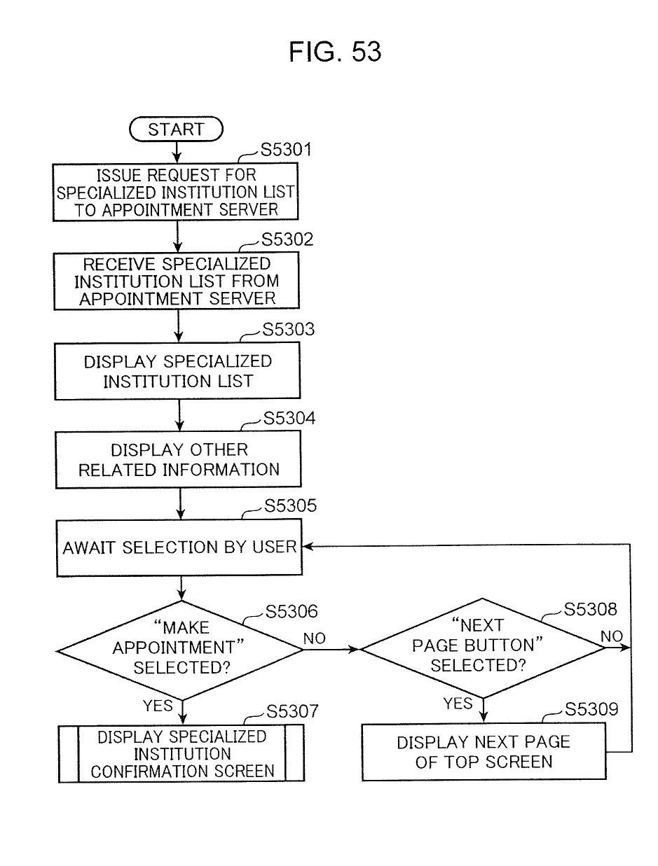

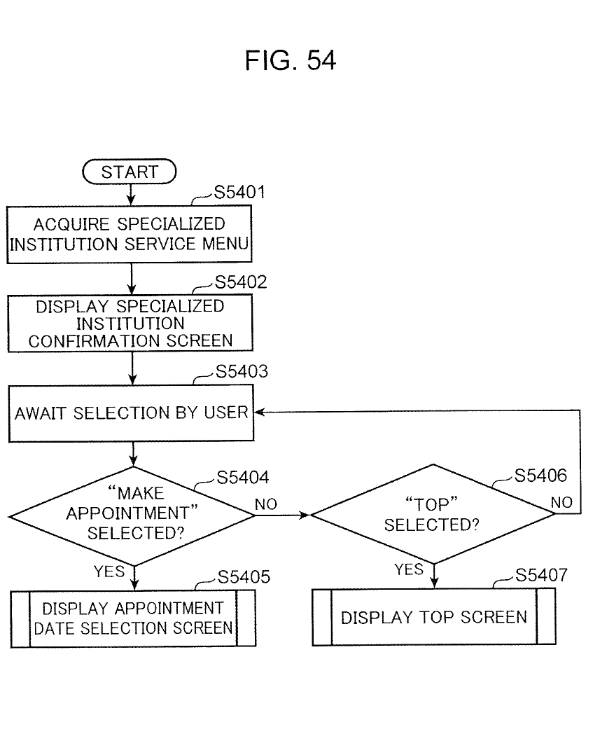

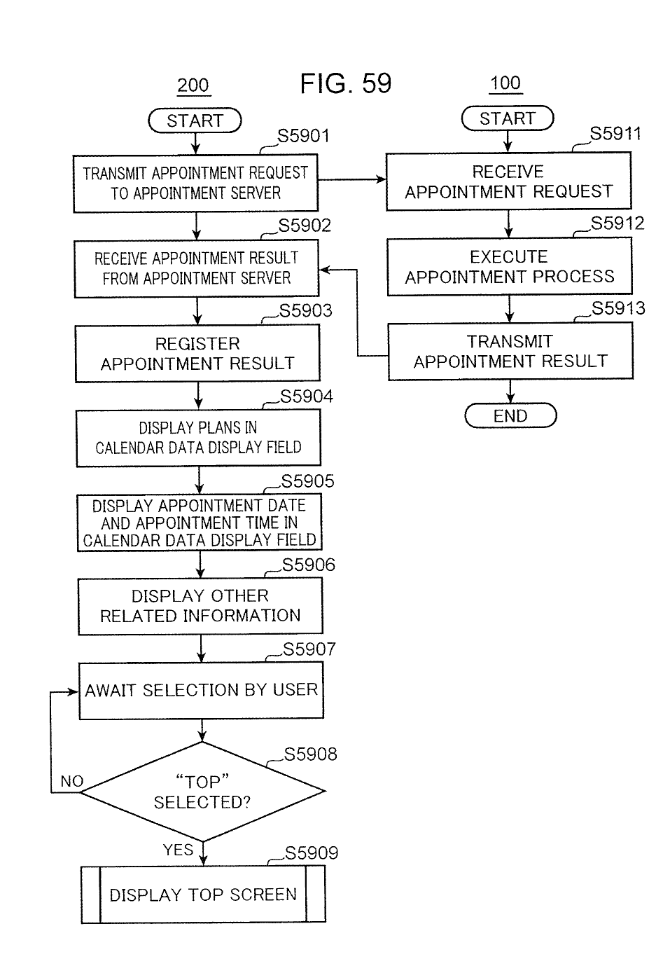

FIG. 53 is a flow chart showing details of the display process of the top screen 1400 (S5202 in FIG. 52, S5407 in FIG. 54 (to be described later), and S5909 in FIG. 59 (to be described later)).

First, the appointment terminal 200 transmits a request for the specialized institution list 3300 to the appointment server 100 (S5301). Next, the appointment terminal 200 receives the specialized institution list 3300 from the appointment server 100 (S5302).

Subsequently, the appointment screen generator 201 displays the top screen 1400 displaying a specialized institution list as shown in FIG. 14 on the display 209 (S5303). Accordingly, a list of specialized institutions registered in the specialized institution list 3300 is displayed on the top screen 1400.

Next, the appointment screen generator 201 displays other related information on the top screen 1400 (S5304). In this case, examples of related information include screen components such as the appointment button 1402, the next page button 1403, and characters that form headings.

Consequently, the top screen 1400 shown in FIG. 14 is completed.

Next, the appointment screen generator 201 enters a standby state for a selection operation by the user (S5305). Subsequently, when the appointment button 1402 is tapped (YES in S5306), the appointment screen generator 201 executes a display process of the specialized institution confirmation screen 1800 (S5307).

Alternatively, when the next page button 1403 is tapped (selected) (NO in S5306 and YES in S5308), the appointment screen generator 201 displays the top screen 1400 of the next page on the display 209 (S5309) and returns the process to S5305. Moreover, when both S5306 and S5308 are NO or, in other words, when no operation is input by the user, the process is returned to S5305 and the standby state for a selection operation by the user is maintained.

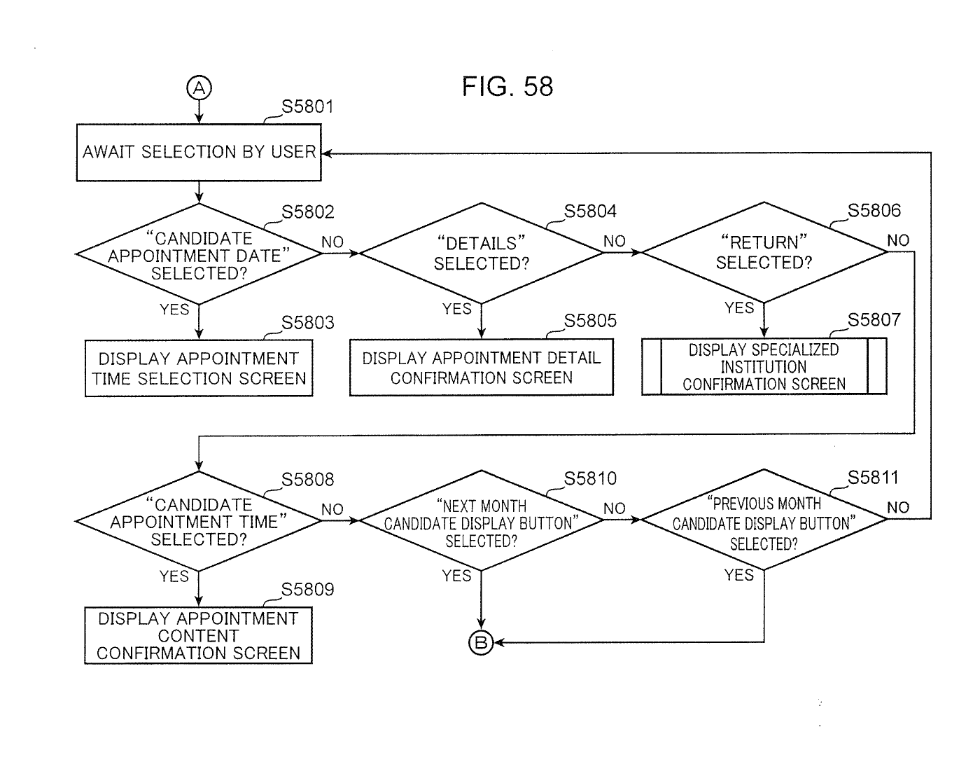

FIG. 54 is a flow chart showing an example of a display process of the specialized institution confirmation screen 1800 (S5203 in FIG. 52, S5307 in FIG. 53, and S5807 in FIG. 58 (to be described later)).

First, the appointment screen generator 201 acquires a specialized institution service menu of a specialized institution of concern from the appointment server 100 (S5401). At this point, in a case of a startup from the appointment guide notification screen 1700, a specialized institution indicated in the recommended appointment information 3400 corresponds to the specialized institution of concern, and in a case of a startup from the top screen 1400, a specialized institution selected by the user corresponds to the specialized institution of concern.

Next, the appointment screen generator 201 displays the specialized institution confirmation screen 1800 on the display 209 based on the information on the specialized institution service menu (S5402).

Subsequently, the appointment screen generator 201 enters a standby state for a selection operation by the user (S5403).

When the appointment button 1806 is tapped and “make appointment” is selected by the user (YES in S5404), the appointment screen generator 201 executes a display process of the appointment date selection screen 1900 (S5405).

In addition, when the top button 1801 is tapped and “top” is selected by the user (NO in S5404 and YES in S5406), the appointment screen generator 201 executes a display process of the top screen 1400 (S5407). Moreover, when both S5404 and S5406 are NO or, in other words, when no operation is input by the user, the process is returned to S5403 and the standby state for a selection operation by the user is maintained.

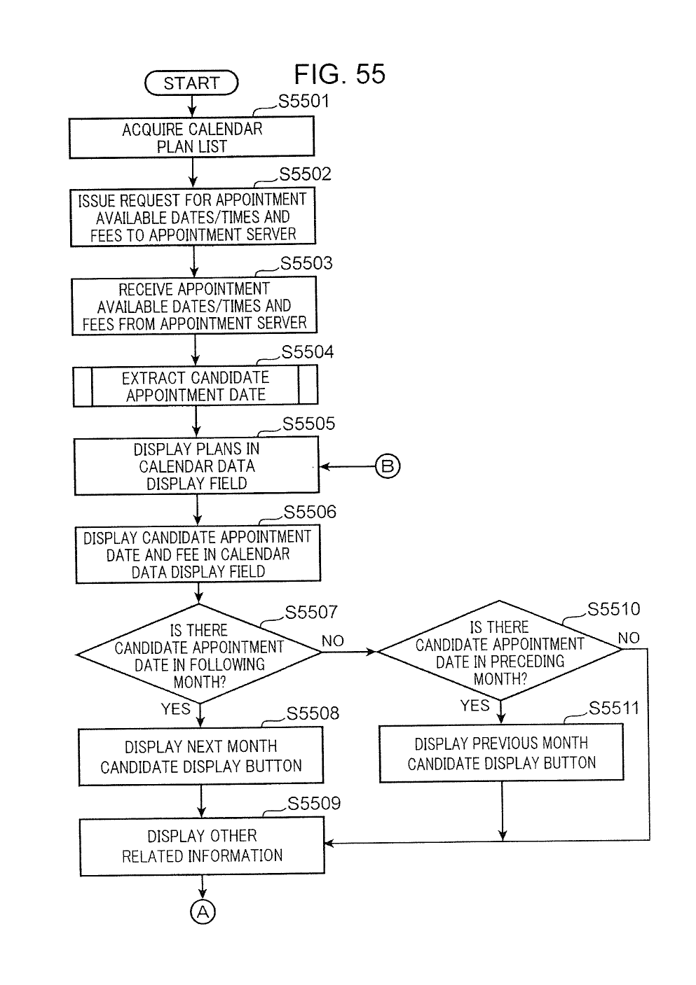

FIGS. 55 and 58 are flow charts showing a first example of a display process of the appointment date selection screen 1900 (S5204 in FIG. 52 and S5405 in FIG. 54). The flow charts correspond to the process sequences S1-1, S1-3, and S2-1 in which the appointment terminal 200 performs an extraction process of a candidate appointment date.

First, the appointment screen generator 201 of the appointment terminal 200 acquires the calendar plan list 3500 from the appointment server 100, the calendar server 500, or the appointment terminal 200 (S5501). In the process sequence S1-1, since the calendar plan list 3500 is managed by the appointment terminal 200, the appointment screen generator 201 may acquire the calendar plan list 3500 from the calendar data storage 207. In the process sequence S1-3, since the calendar plan list 3500 is managed by the appointment server 100, the appointment screen generator 201 may acquire the calendar plan list 3500 from the appointment server 100. In the process sequence S2-1, since the calendar plan list 3500 is managed by the calendar server 500, the appointment screen generator 201 may acquire the calendar plan list 3500 from the calendar server 500.

Next, the appointment screen generator 201 transmits an acquisition request for appointment available dates and times and a fee to the appointment server 100 (S5502). Subsequently, the appointment screen generator 201 receives appointment available dates and times and a fee from the appointment server 100 (S5503). Next, the candidate appointment date selector 202 executes an extraction process of a candidate appointment date (S5504).

Subsequently, the appointment screen generator 201 displays plans of the user in the calendar data display field 1904 (S5505). In this case, the appointment screen generator 201 displays the schedule icon 1907 in the box 1905 corresponding to an appointment available date and time on which a plan of the user is registered in the calendar plan list 3500. At this point, the appointment screen generator 201 may describe the text that is registered in “plan contents” in the calendar plan list 3500 on the schedule icon 1907.

Next, using an extraction result of a candidate appointment date, the appointment screen generator 201 displays a candidate appointment date and a fee for a specialized institution in the calendar data display field 1904 (S5506). In this case, the appointment screen generator 201 displays the candidate symbol 1906 or the candidate appointment time 2201 in the box 1905 corresponding to an appointment available date and time for which “candidate” is registered as the “candidate appointment” in the candidate appointment date list 3700 that is obtained by the extraction process. In addition, the appointment screen generator 201 displays a fee in the corresponding box 1905 using a fee calculated from the “fee” registered in the candidate appointment date list 3700.

Subsequently, if there is a candidate appointment date in the month following the month of the appointment date selection screen 1900 that is currently being displayed (YES in S5507), the appointment screen generator 201 displays the next month candidate display button 2001 on the appointment date selection screen 1900 (S5508). On the other hand, if there is a candidate appointment date in the month preceding the month of the appointment date selection screen 1900 that is currently being displayed (NO in S5507 and YES in S5510), the appointment screen generator 201 displays the previous month candidate display button 2101 on the appointment date selection screen 1900 (S5511). If there are no candidate appointment dates in the previous month (NO in S5510), the process advances to S5509.

Next, the appointment screen generator 201 displays other related information on the appointment date selection screen 1900 (S5509) and advances the process to S5801 in FIG. 58. In this case, related information includes screen components such as the return button 1902, the detail button 1903, and headings.

In S5801 in FIG. 58, the appointment screen generator 201 enters a standby state for an input of a selection operation by the user (S5801). Next, when the box 1905 corresponding to a candidate appointment date is tapped and a “candidate appointment date” is selected by the user (YES in S5802), the appointment screen generator 201 displays the appointment time selection screen 2400 on the display 209 (S5803). Moreover, when the candidate appointment date is selected by the user by tapping the candidate appointment time 2201 in a case where the appointment date selection screen 1900 displaying the candidate appointment time 2201 is adopted, the appointment time selection screen 2400 is displayed on which a time slot that is indicated by the candidate appointment time 2201 is selected by default.

In addition, when the detail button 1903 is tapped and “detail” is selected by the user on the appointment date selection screen 1900 (NO in S5802 and YES in S5804), the appointment screen generator 201 displays the appointment detail confirmation screen 2900 on the display 209 (S5805).

Furthermore, when the return button 1902 is tapped and “return” is selected by the user on the appointment date selection screen 1900 (NO in S5804 and YES in S5806), the appointment screen generator 201 executes a display process (FIG. 54) of the specialized institution confirmation screen 1800 (S5807).

Next, when the candidate appointment time 2201 is tapped and “candidate appointment time” is selected by the user (NO in S5806 and YES in S5808), the appointment screen generator 201 displays the appointment content confirmation screen 2300 on the display 209 (S5809). S5809 is the same as S5206 in FIG. 52 and the process returns to FIG. 52. Moreover, when the appointment date selection screen 1900 displaying the candidate symbol 1906 is adopted. S5808 is omitted because the candidate appointment time 2201 is not displayed.

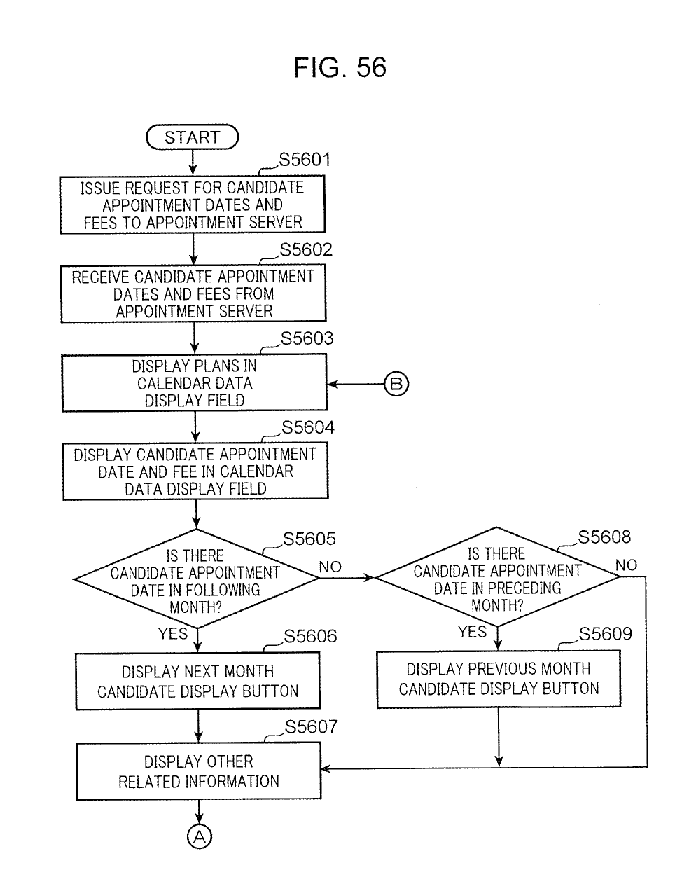

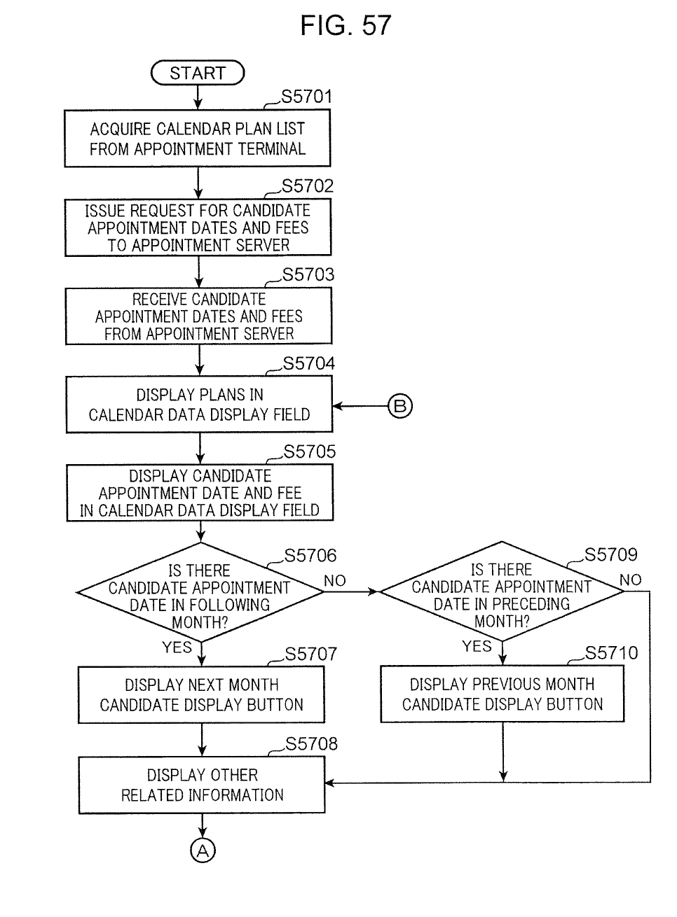

Subsequently, when the next month candidate display button 2001 is tapped (selected) (NO in S5808 and YES in S5810), the process advances to S5505 in FIG. 55, S5603 in FIG. 56 (to be described later), or S5704 in FIG. 57 (to be described later). In addition, when the previous month candidate display button 2101 is tapped (selected) (NO in S5810 and YES in S5811), the process advances to S5505 in FIG. 55. S5603 in FIG. 56 (to be described later), or S5704 in FIG. 57 (to be described later). On the other hand, when no operation is input by the user on the appointment date selection screen 1900 (NO in S5811), the process is returned to S5801 and the standby state for a selection operation by the user is maintained.

FIG. 56 is a flow chart showing a second example of the display process of the appointment date selection screen 1900 (S5204 in FIG. 52 and S5405 in FIG. 54). This flow chart corresponds to the process sequences S1-4 and S2-2 in which the appointment server 100 performs an extraction process of a candidate appointment date.

In FIG. 56, acquisition of the calendar plan list 3500 is performed by the appointment server 100 and an extraction process of a candidate appointment date is also performed by the appointment server 100.

To this end, the appointment terminal 200 first transmits a request for a candidate appointment date and a fee to the appointment server 100 (S5601). Subsequently, the appointment terminal 200 receives a candidate appointment date and a fee from the appointment server 100 (S5602). Subsequent processes S5603 to S5609 are the same as S5505 to S5511 in FIG. 55.

FIG. 57 is a flow chart showing a third example of the display process of the appointment date selection screen 1900 (S5204 in FIG. 52 and S5405 in FIG. 54). This flow chart corresponds to the process sequence S1-2 in which the appointment server 100 performs an extraction process of a candidate appointment date and the appointment terminal 200 manages the calendar plan list 3500.

First, the appointment screen generator 201 acquires the calendar plan list 3500 from the storage 203 (S5701). Subsequent processes S5702 to S5710 are the same as S5601 to S5609 in FIG. 56. However, in S5702, the appointment terminal 200 additionally transmits the calendar plan list 3500 acquired in S5701.

FIG. 59 is a flow chart showing a display process of the appointment completion screen 2700 (S5207 in FIG. 52). First, the appointment terminal 200 transmits an appointment request to the appointment server 100 (S5901). In this case, the appointment terminal 200 transmits the appointment request when the appointment button 2606 is tapped on the appointment content confirmation screen 2600. The appointment request includes, for example, a user ID, contents of a specialized institution that is an appointment object, and candidate appointment dates and times.

Next, the appointment server 100 receives the appointment request (S5911). Subsequently, the appointment server 100 executes an appointment process (S5912). At this point, the appointment server 100 may register information such as candidate appointment dates that are included in the appointment request in association with, for example, corresponding appointment available dates and times that are registered in the appointment available date list 3600. Accordingly, the candidate appointment dates and times specified in the appointment request are registered as appointment dates and times in the appointment server 100.

Subsequently, the appointment server 100 transmits an appointment result to the appointment terminal 200 (S5913). In this case, the appointment result includes information such as contents of the specialized institution that is an appointment object and appointment dates and times.

Next, the appointment terminal 200 receives the appointment result from the appointment server 100 (S5902). Subsequently, the appointment terminal 200 registers the appointment result in the calendar plan list 3500 (S5903).

In this case, when the appointment system adopts the process sequences S1-1 and S1-2, the appointment terminal 200 registers the appointment result in the calendar plan list 3500 that is managed by the appointment terminal 200. In addition, when the appointment system adopts the process sequences S1-3 and S1-4, the appointment terminal 200 transmits the appointment result to the appointment server 100 and causes the appointment result to be registered in the calendar plan list 3500 that is managed by the appointment server 100. Furthermore, when the appointment system adopts the process sequences S2-1 and S2-2, the appointment terminal 200 transmits the appointment result to the calendar server 500 and causes the appointment result to be registered in the calendar plan list 3500 that is managed by the calendar server 500.

Next, the appointment terminal 200 displays the schedule icon 1907 representing a plan of the user in the calendar data display field 1904 on the appointment completion screen 2700 (S5904).

Subsequently, the appointment terminal 200 displays an appointment date and time in the calendar data display field 1904 on the appointment completion screen 2700 (S5905).

Next, the appointment terminal 200 displays other related information on the appointment completion screen 2700 (S5906).

Subsequently, the appointment terminal 200 enters a standby state for a selection operation by the user on the appointment completion screen 2700 (S5907).

Next, when the top button 2701 is tapped and “top” is selected by the user (YES in S5908), the appointment terminal 200 executes the display process (FIG. 53) of the top screen 1400 (S5909).

On the other hand, when no operation is input by the user on the appointment completion screen 2700 (NO in S5908), the process is returned to S5907 and the standby state is maintained.

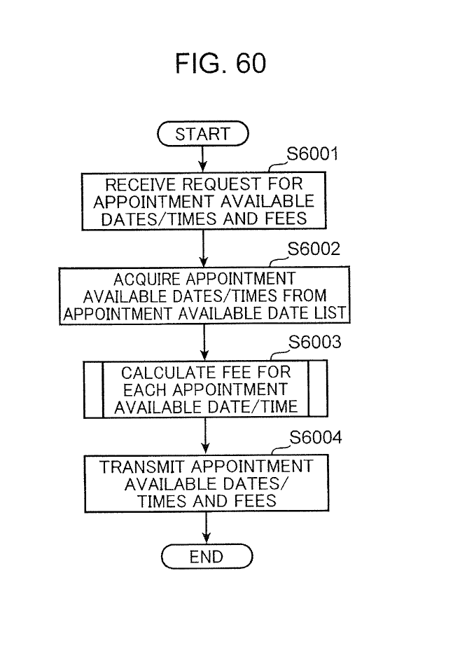

FIG. 60 is a flow chart showing a process of a first example of the appointment server 100. Moreover, this flow chart shows a process in a case where the appointment system adopts the process sequences S1-1. S1-3, and S2-1.

First, the appointment server 100 receives an acquisition request for appointment available dates and times and a fee from the appointment terminal 200 (S6001). Subsequently, the appointment server 100 acquires appointment available dates and times from the appointment available date list 3600 (S6002). In this case, for example, the appointment server 100 may acquire appointment available dates and times in a month including the present day and a following month among the appointment available dates and times registered in the appointment available date list 3600.

Next, the appointment server 100 calculates a fee for each of the acquired appointment available dates and times (S6003). Subsequently, the appointment server 100 transmits the appointment available dates and times and the fees to the appointment terminal 200 (S6004).

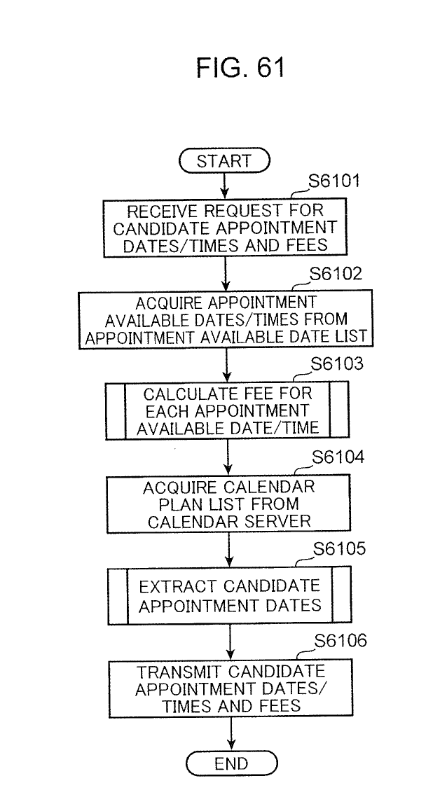

FIG. 61 is a flow chart showing a process of a second example of the appointment server 100. Moreover, this flow chart shows a process in a case where the appointment system adopts the process sequences S1-4 and S2-2. S6101 to S6103 are the same as S6001 to S6003 in FIG. 60.

In this flow chart, the calendar plan list 3500 is managed by the calendar server 500. Therefore, in S6104, the calendar plan list 3500 is acquired from the calendar server 500. In addition, in the flow chart, an extraction process of candidate appointment dates and times is performed by the appointment server 100. Therefore, in S6105, the appointment server 100 performs the extraction process of candidate appointment dates and times. Subsequently, the appointment server 100 transmits the extracted appointment available dates and times and fees to the appointment terminal 200 (S6106).

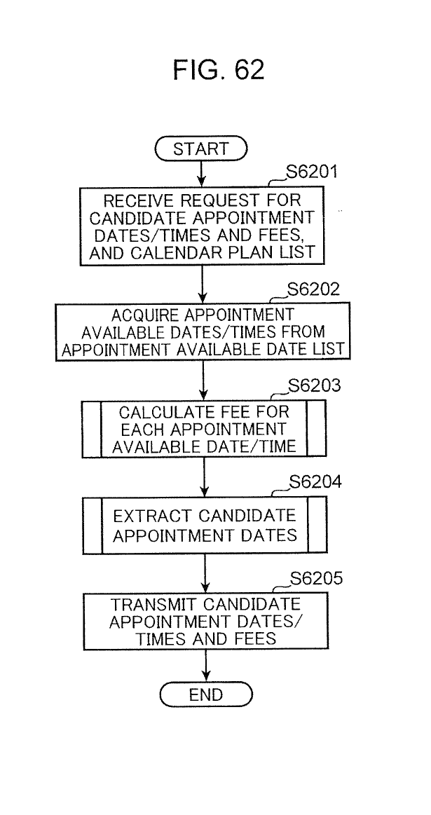

FIG. 62 is a flow chart showing a process of a third example of the appointment server 100. Moreover, this flow chart shows a process in a case where the appointment system adopts the process sequence S1-2.

In this flow chart, the calendar plan list 3500 is managed by the appointment terminal 200. Therefore, in S6201, the appointment server 100 receives the calendar plan list 3500 in addition to an acquisition request for candidate appointment dates and times and fees.

Subsequent processes S6202, S6203, S6204, and S6205 are the same as S6102, S6103, S6105, and S6106 in FIG. 61.

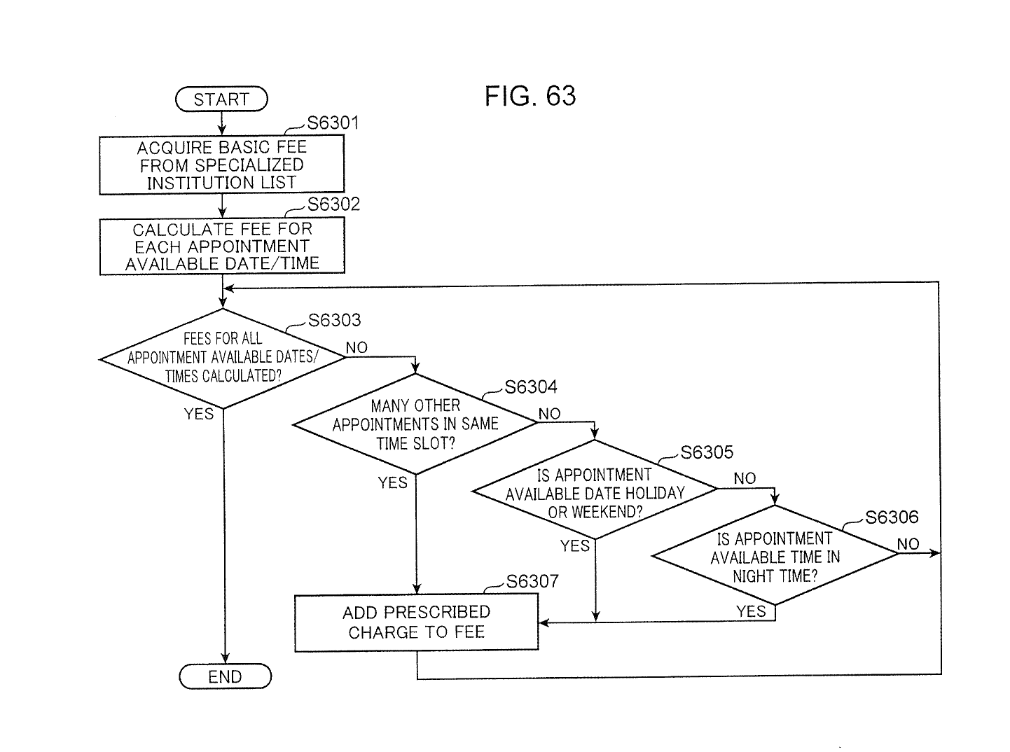

FIG. 63 is a flow chart showing an example of a process of calculating a fee for each appointment available date and time (S6003 in FIG. 60. S6103 in FIG. 61, and S6203 in FIG. 62). First, the appointment server 100 acquires a basic fee with respect to each specialized institution (in this case, a hospital is assumed) from the specialized institution list 3300 (S6301). Next, the appointment server 100 calculates a fee for each acquired appointment available date and time using the acquired basic fee (S6302). At this point, a basic fee is calculated for each of the respective appointment available dates and times acquired in S6002 in FIG. 60. S6102 in FIG. 61, or S6202 in FIG. 62.

Next, when the calculation of fees with respect to all appointment available dates and times is completed (YES in S6303), the appointment server 100 ends the process. On the other hand, when the calculation of fees with respect to all appointment available dates and times is not completed (NO in S6303), the appointment server 100 determines whether or not there is a large number of appointments for a same time slot (S6304). At this point, when the number of appointments at the hospital is not smaller than a specified value, the appointment server 100 may make a determination of YES in S6304, and when the number of appointments at the hospital is smaller than the specified value, the appointment server 100 may make a determination of NO in S6304. When a determination of YES is made in S6304, the process advances to S6307, and when a determination of NO is made in S6304, the process advances to S6305.

Subsequently, the appointment server 100 determines whether or not an appointment available date to which an appointment available date and time that is a fee calculation object belongs corresponds to a holiday or a weekend (S6305). In this case, for example, a Sunday or a public holiday is adopted as the holiday. In addition, for example, a Saturday is adopted as the weekend.

The appointment server 100 makes a determination of YES in S6305 when the corresponding appointment available date is a holiday or a weekend and makes a determination of NO in S6305 when the corresponding appointment available date is not a holiday or a weekend. When a determination of YES is made in S6305, the process advances to S6307, and when a determination of NO is made in S6305, the process advances to S6306.

In S6306, a determination is made on whether the corresponding appointment available date and time is in the night time (S6306). When the corresponding appointment available date and time is in the night time (YES in S6306), the process is advanced to S6307, and when the corresponding appointment available date and time is not in the night time (NO in S6306), the process is returned to S6303. In addition, in S6303, a next appointment available date and time is decided as a fee calculation object and subsequent processes are to be performed. In this case, for example, 18:00 and thereafter or 19:00 and thereafter correspond to the night time.

In S6307, the appointment server 100 adds a prescribed charge to the fee calculated in S6302 with respect to the corresponding appointment available date and time and returns the process to S6303. In this case, for example, the appointment server 100 may add addition values respectively determined in advance for each of a case where YES is determined in S6304, a case where YES is determined in S6305, and a case where YES is determined in S6306 to the fee calculated in S6302.

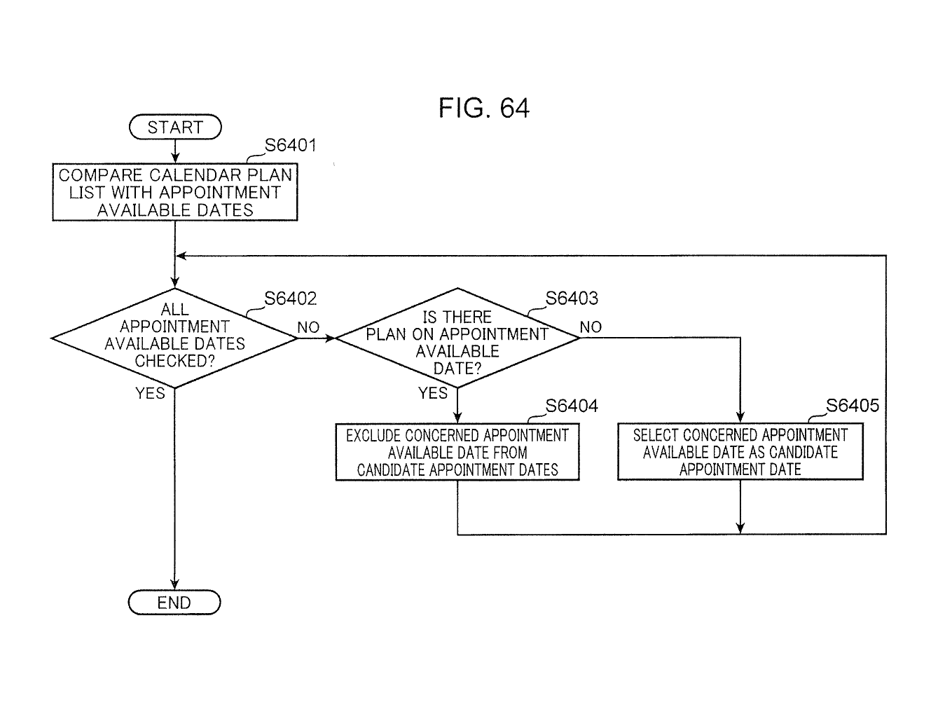

FIG. 64 is a flow chart showing a first example of an extraction process of a candidate appointment date by the appointment server 100 or the appointment terminal 200. A processing entity of the flow chart is the candidate appointment date selector 106 when the process is executed by the appointment server 100 and the candidate appointment date selector 202 when the process is executed by the appointment terminal 200.

First, the calendar plan list 3500 and appointment available dates are compared with each other (S6401). In this case, appointment available dates refer to the appointment available dates to which appointment available dates and times acquired in S5503 in FIG. 55, S6002 in FIG. 60, S6102 in FIG. 61, or S6202 in FIG. 62 belong.

When all appointment available dates are checked (YES in S6402), the process is ended, and when all appointment available dates are not checked (NO in S6402), the process advances to S6403.

In S6403, a determination is made on whether or not there is a plan of the user on an appointment available date. When there is a plan of the user (YES in S6403), the concerned appointment available date is excluded from candidate appointment dates (S6404) and the process is returned to S6402. In S6402, a next appointment available date is decided as a processing object.

When there are no plans of the user on the appointment available date (NO in S6403), the concerned appointment available date is selected as a candidate appointment date (S6405) and the process is returned to S6402.

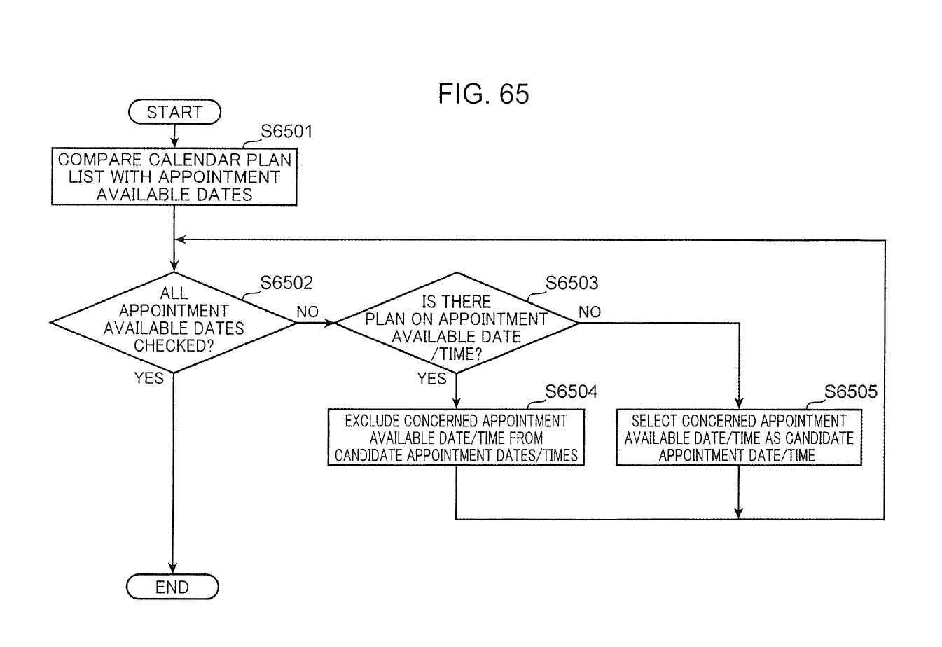

FIG. 65 is a flow chart showing a second example of the extraction process of a candidate appointment date by the appointment server 100 or the appointment terminal 200. S6501 and S6502 are the same as S6401 and S6402 in FIG. 64.

When a determination of NO is made in S6502, a determination is made on whether or not there is a plan of the user at an appointment available date and time belonging to an appointment available date (S6503). When there is a plan of the user at the appointment available date and time (YES in S6503), the concerned appointment available date and time is excluded from candidate appointment dates and times (S6504) and the process is returned to S6502. On the other hand, when there are no plans of the user on the appointment available date and time (NO in S6503), the concerned appointment available date and time is selected as a candidate appointment date and time (S6505) and the process is returned to S6502.

In other words, in S6503 to S6505, even when there is a plan of the user on an appointment available date, as long as an appointment available date and time does not overlap with a time slot of the plan of the user, the appointment available date and time is extracted as a candidate appointment date and time.

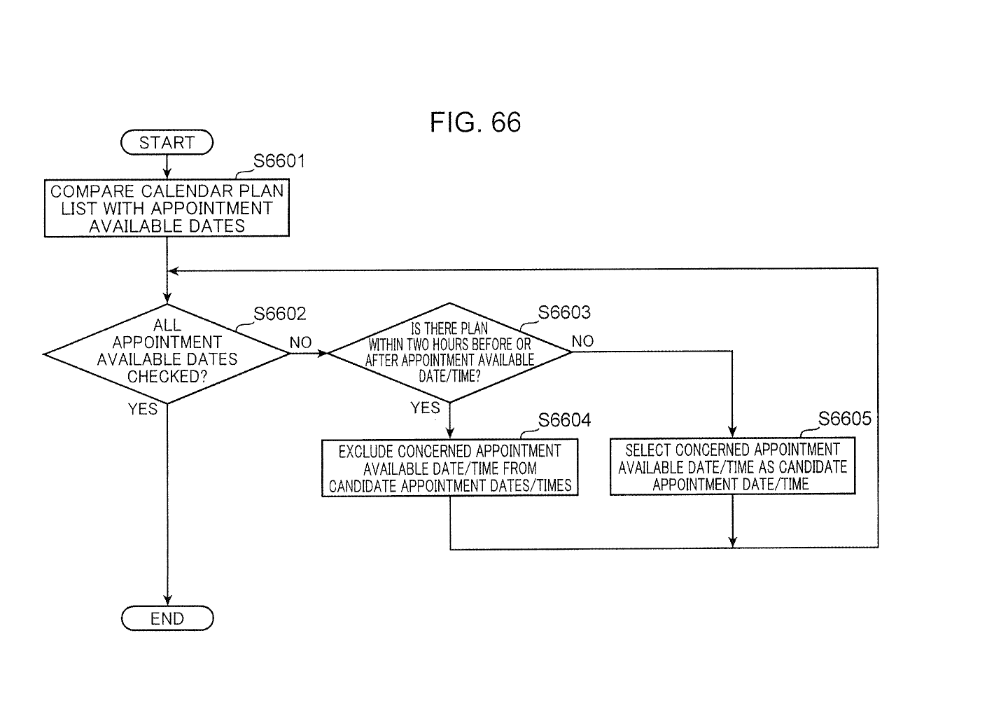

FIG. 66 is a flow chart showing a third example of the extraction process of a candidate appointment date by the appointment server 100 or the appointment terminal 200. S6601, S6602, S6604, and S6605 are the same as S6501, S6502, S6504, and S6505 in FIG. 65.

When a determination of NO is made in S6602, a determination is made on whether or not there is a plan of the user within two hours before or after an appointment available date and time (S6603). When there is a plan of the user within two hours before or after an appointment available date and time (YES in S6603), the process advances to S6604. On the other hand, when there are no plans of the user within two hours before or after an appointment available date and time (NO in S6603), the process advances to S6605.

In other words, in S6603, a margin is provided in the plans of the user to select a candidate appointment date and time. In this case, for example, assuming that a start time of an appointment available date and time is 13:00 and an end time thereof is 14:00, the two hours from 11:00 to 13:00 and the two hours from 14:00 to 16:00 correspond to the two hours before or after the appointment available date and time.

While two preceding or subsequent hours have been adopted in this case, alternatively, a value set in advance by the appointment system may be adopted or a preferred value set by the user may be adopted.

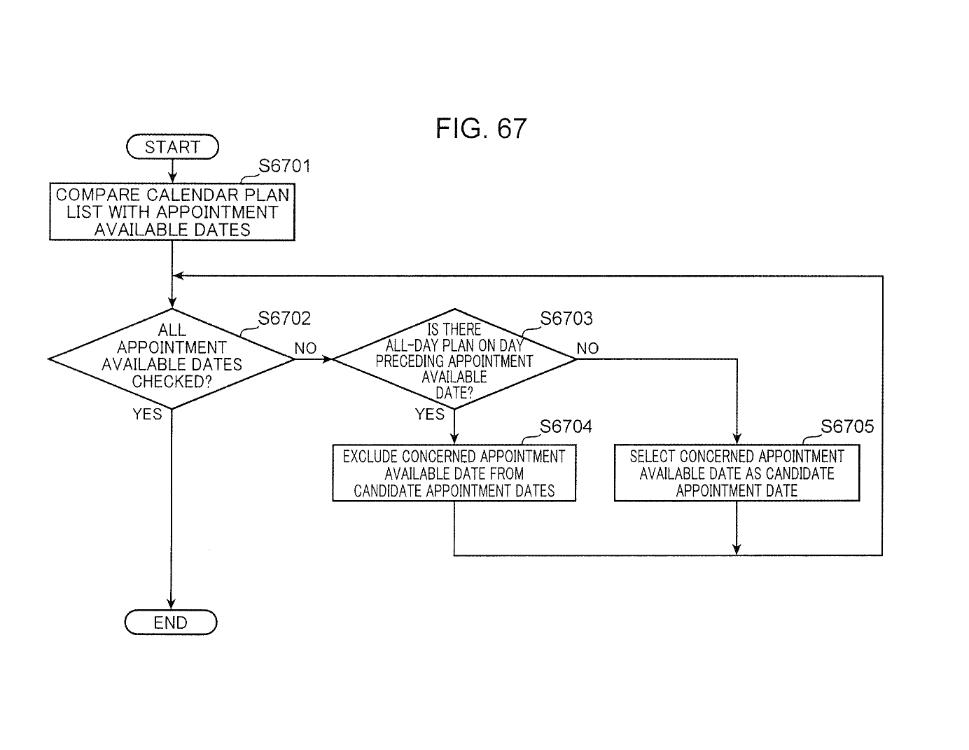

FIG. 67 is a flow chart showing a fourth example of the extraction process of a candidate appointment date by the appointment server 100 or the appointment terminal 200. S6701, S6702, S6704, and S6705 are the same as S6401, S6402, S6404, and S6405 in FIG. 64.

When a determination of NO is made in S6702, a determination is made on whether or not there is an all-day plan on the day preceding an appointment available date (S6703). When there is an all-day plan on the day preceding the appointment available date (YES in S6703), the process advances to S6704. On the other hand, where there is no all-day plan on the day preceding the appointment available date (NO in S6703), the process advances to S6705.

In this case, for example, a plan whose time slot is from 0:00 to 24:00 and which extends over a plurality of days such as a trip corresponds to an all-day plan. When there is an all-day plan on the previous day, the user may still feel tired on the following day. It is unlikely that the user would select such a day as an appointment date. Therefore, in the fourth example, such dates that are unlikely to be selected as an appointment date by the user are excluded from candidate appointment dates.

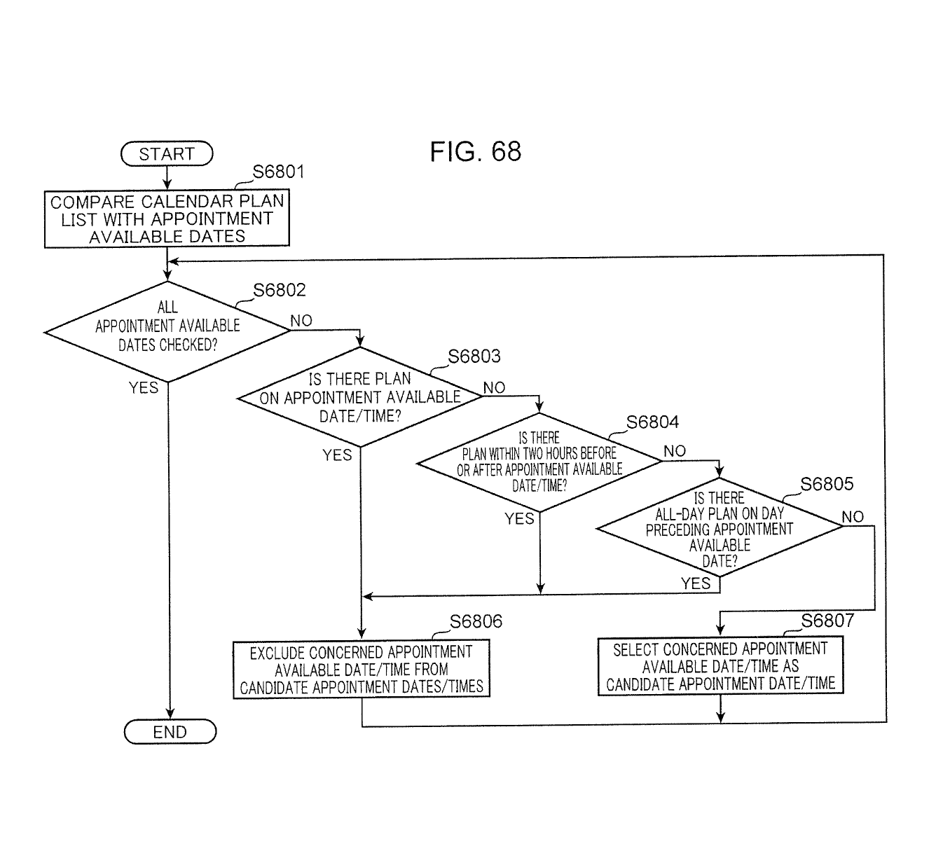

FIG. 68 is a flow chart showing a fifth example of the extraction process of a candidate appointment date by the appointment server 100 or the appointment terminal 200. S6801 to S6803. S6806, and S6807 are the same as S6501 to S6503. S6504, and S6505 in FIG. 65. S6804 is the same as S6603 in FIG. 66. S6805 is the same as S6703 in FIG. 67. Subsequently, when a determination of NO is made in S6803, the process advances to S6804. When a determination of YES is made in S6804, the process advances to S6806, and when a determination of NO is made in S6804, the process advances to S6805. When a determination of YES is made in S6805, the process advances to S6806, and when a determination of NO is made in S6805, the process advances to S6807. In other words, the fifth example combines the second to fourth examples.

Moreover, while the second to fourth examples are combined in FIG. 68, the present disclosure is not limited thereto. In the present disclosure, any combination may be adopted such as a combination of the second and third examples and a combination of the second and fourth examples.

### INDUSTRIAL APPLICABILITY

The present disclosure is useful in a cloud system that manages plans of a user or manages appointment available dates at a specialized institution.

What is claimed is:

1. A method for controlling a communication device having a display and being used in an information management system, the information management system performing an appointment process for a specialized institution via a network connected to the specialized institution,
the communication device having a memory for storing schedule information of a user of the communication device,
the method causing a computer of the communication device to:
display display data on the display, the display data being generated using the stored schedule information with calendar data, the calendar data representing each day on a per month or per week basis;
access the information management system via the network to acquire appointment available dates and times at the specialized institution from the information management system when performing the appointment process for the specialized institution;
determine candidate appointment dates and times at the specialized institution by excluding each date and time, on which a plan of the user is stored in the memory, from the acquired appointment available dates and times at the specialized institution;
display each display representing each candidate appointment time based on the candidate appointment dates and times, in each region corresponding to each day represented in the calendar data; and
display an appointment screen on the display when selection of one region is detected in the calendar data, the one region corresponding to one display and representing one candidate appointment time, the appointment screen being used for setting one candidate appointment date and time corresponding to the selected one region as an appointment date and time at the specialized institution.

2. The method according to claim 1, further causing the computer of the communication device to:
transmit an appointment request to the information management system via the network based on a result of an appointment made using the appointment screen, the appointment request indicating the selected one candidate appointment date and time; and
perform registration of the selected one candidate appointment date and time in the information management system, as the appointment date and time at the specialized institution.

3. The method according to claim 2, further causing the computer of the communication device to display the appointment date and time at the specialized institution within the one region in the calendar data, when the registration has been completed in the information management system.

4. The method according to claim 2, further causing the computer of the communication device to display on the display a message indicating completion of the registration, in association with the display of the calendar data.

5. The method according to claim 1, wherein
the information management system collects to manage customer information via the network, the customer information being associated with the user of the communication device, and
a notice is received from the information management system via the network when it is determined in the information management system based on the customer information that a service, which is in accordance with preferences or history of the user of the communication device, is provided by the specialized institution, wherein the notice indicates that the service is provided by the specialized institution.

6. The method according to claim 1, wherein the calendar data included in the display data represents each day of a concerned month,
the method further causing the computer of the communication device to:
in a case where the each display representing the each candidate appointment time is included in respective displays of the concerned month and a following month, display a display notice in the display data which includes the calendar data representing each day of the concerned month, wherein the display notice indicates that each display representing each remaining candidate appointment time is to be displayed in each region corresponding to each day included in the display of the following month.

7. The method according to claim 1, wherein the calendar data included in the display data represents each day of a concerned week,
the method further causing the computer of the communication device to:
in a case where the each display representing the each candidate appointment time is included in respective displays of the concerned week and a following week, display a display notice in the display data which includes the calendar data representing each day of the concerned week, wherein the display notice indicates that each display representing each remaining candidate appointment time is to be displayed in each region corresponding to each day included in the display of the following week.

8. The method according to claim 1, wherein
a region corresponding to a day, which includes a plan of the user in the calendar data, is displayed in a first display color, and
the each region corresponding to the each day, which includes the each display representing the each candidate appointment time in the calendar data, is displayed in a second display color different from the first display color.

9. The method according to claim 1, wherein
a fee for a service provided by the specialized institution is displayed, when the each display representing the each candidate appointment time is displayed in the each region corresponding to the each day represented in the calendar data.

10. The method according to claim 1, further causing the computer of the communication device to:
in a case where a region corresponding to a given day represented in the calendar data has not an enough area to display all of displays which represent a plurality of candidate appointment times corresponding to the given day, display a display representing a candidate appointment date at the specialized institution in the region corresponding to the given day, without displaying all of the displays representing the plurality of the candidate appointment times corresponding to the given day in the region corresponding to the given day.

11. The method according to claim 1, wherein
the specialized institution includes a medical institution, a restaurant, or a lodging facility.

12. The method according to claim 1, wherein
the communication device is configured to be able to register the plan of the user in the each region corresponding to the each day represented in the calendar data.

13. A non-transitory computer-readable recording medium which stores a program to be executed in a communication device having a display and being used in an information management system, the information management system performing an appointment process for a specialized institution via a network connected to the specialized institution,
the communication device having a memory for storing schedule information of a user of the communication device,
the program causing a computer of the communication device to:
display display data on the display, the display data being generated using the stored schedule information with calendar data, the calendar data representing each day on a per month or per week basis;
access the information management system via the network to acquire appointment available dates and times at the specialized institution from the information management system when performing the appointment process for the specialized institution;
determine candidate appointment dates and times at the specialized institution by excluding each date and time, on which a plan of the user is stored in the memory, from the acquired appointment available dates and times at the specialized institution;
display each display representing each candidate appointment time based on the candidate appointment dates and times, in each region corresponding to each day represented in the calendar data; and
display an appointment screen on the display when selection of one region is detected in the calendar data, the one region corresponding to one day and representing one candidate appointment time, the appointment screen being used for setting one candidate appointment date and time corresponding to the selected one region as an appointment date and time at the specialized institution.

14. A method for providing information in an information management system which performs an appointment process for a specialized institution via a network connected to the specialized institution, the method comprising:
receiving from a communication device of an authenticated user an inquiry signal and schedule information of the user via the network, the inquiry signal being related to the appointment process for the specialized institution, the schedule information of the user being stored in a memory of the communication device;
acquiring first candidate data using a database in response to the inquiry signal, the database storing appointment available dates and times at the specialized institution, the first candidate data indicating the appointment available dates and times at the specialized institution;
determining, using the acquired first candidate data and the received schedule information, candidate appointment dates and times at the specialized institution by excluding each date and time, on which a plan of the user is included in the received schedule information, from the appointment available dates and times indicated by the acquired first candidate data;
transmitting second candidate data indicating the determined candidate appointment dates and times to the communication device via the network, wherein the communication device displays each display representing each candidate appointment time based on the candidate appointment dates and times indicated by the second candidate data, within each region corresponding to each day represented in calendar data that is generated using the schedule information at the communication device; and
when selection of one region is detected in the communication device, the one region corresponding to one day represented in the calendar data and representing one candidate appointment time, and when an appointment request, which indicates one candidate appointment date and time corresponding to the selected one region, is received from the communication device via the network, registering the one candidate appointment date and time indicated by the appointment request as an appointment date and time in the information management system.

15. The method according to claim 14, wherein
the appointment date and time at the specialized institution is displayed in the communication device within the one region represented in the calendar data when the registration has been completed in the information management system.

16. The method according to claim 14, wherein
the information management system collects to manage customer information via the network, the customer information being associated with the user of the communication device, and
the method further comprising:
transmitting a notice to the communication device via the network, when it is determined based on the customer information that a service, which is in accordance with preferences or history of the user of the communication device, is provided by the specialized institution, wherein the notice indicates that the service is provided by the specialized institution.

17. A method for controlling a communication device having a display and being used in an information management system, the information management system performing an appointment process for a specialized institution via a network connected to the specialized institution,
the information management system managing schedule information of a user of the communication device,
the method causing a computer of the communication device to:
access the information management system via the network to acquire i) schedule information of the user of the communication device and ii) appointment available dates and times at the specialized institution from the information management system when performing the appointment process for the specialized institution;
display display data on the display, the display data being generated using the acquired schedule information with calendar data, the calendar data representing each day on a per month or per week basis;
determine candidate appointment dates and times at the specialized institution by excluding each date and time, on which a plan of the user is acquired from the information management system, from the acquired appointment available dates and times at the specialized institution;
display each display representing each candidate appointment time based on the determined candidate appointment dates and times, in each region corresponding to each day represented in the calendar data; and
display an appointment screen on the display when selection of one region is detected in the calendar data, the one region corresponding to one day and representing one candidate appointment time, the appointment screen being used for setting one candidate appointment date and time corresponding to the selected one region as an appointment date and time at the specialized institution.

18. The method according to claim 17, further causing the computer of the communication device to:
transmit an appointment request to the information management system via the network based on a result of an appointment made using the appointment screen, the appointment request indicating the selected one candidate appointment date and time; and
perform registration of the selected one candidate appointment date and time in the information management system, as the appointment date and time at the specialized institution.

19. The method according to claim 18, further causing the computer of the communication device to display the appointment date and time at the specialized institution, within the one region in the calendar data, when the registration has been completed in the information management system.

20. The method according to claim 18, further causing the computer of the communication device to display on the display a message indicating completion of the registration, in association with the display of the calendar data.

21. The method according to claim 17, wherein
the information management system collects to manage customer information via the network, the customer information being associated with the user of the communication device, and
a notice is received from the information management system via the network when it is determined in the information management system based on the customer information that a service, which is in accordance with preferences or history of the user of the communication device, is provided by the specialized institution, wherein the notice indicating that the service is provided by the specialized institution.

22. The method according to claim 17 wherein
the communication device is configured to be able to register the plan of the user in the each region corresponding to the each day represented in the calendar data.

23. A non-transitory computer-readable recording medium which stores a program to be executed by a communication device, the communication device having a display and being used in an information management system, the information management system performing an appointment process for a specialized institution via a network connected to the specialized institution,
the information management system managing schedule information of a user of the communication device,
the program causing a computer of the communication device to:
access the information management system via the network to acquire i) schedule information of the user of the communication device and ii) appointment available dates and times at the specialized institution from the information management system when performing the appointment process for the specialized institution;
display display data on the display, the display data being generated using the acquired schedule information with calendar data, the calendar data representing each day on a per month or per week basis:
determine candidate appointment dates and times obtained by excluding each date and time, on which a plan of the user is acquired from the information management system, from the acquired appointment available dates and times at the specialized institution;
display each display representing each candidate appointment time based on the determined candidate appointment dates and times, in each region corresponding to each day represented in the calendar data; and
display an appointment screen on the display when selection of one region is detected in the calendar data, the one region corresponding to one day and representing one candidate appointment time, the appointment screen being used for setting one candidate appointment date and time corresponding to the selected one region as an appointment date and time at the specialized institution.

24. A method for providing information in an information management system which performs an appointment process for a specialized institution via a network connected to the specialized institution, the method comprising:
receiving an inquiry signal from a communication device of an authenticated user via the network, the inquiry signal being related to the appointment process for the specialized institution;
acquiring schedule information of the user of the communication device using a first database based on the inquiry signal, the first database storing the schedule information of the user of the communication device;
acquiring first candidate data using a second database based on the inquiry signal, the second database storing appointment available dates and times at the specialized institution, the first candidate data indicating the appointment available dates and times at the specialized institution;
determining, using the acquired schedule information and the acquired first candidate data, candidate appointment dates and times obtained by excluding each date and time, on which a plan of the user is included in the acquired schedule information, from the appointment available dates and times at the specialized institution indicated by the acquired first candidate data;
transmitting second candidate data indicating the determined candidate appointment dates and times to the communication device via the network, wherein the communication device displays each display representing each candidate appointment time based on the candidate appointment dates and times indicated by the second candidate data, within each region corresponding to each day represented in calendar data that is generated using the schedule information at the communication device; and
when selection of one region is detected in the communication device, the one region corresponding to one day represented in the calendar data and representing one candidate appointment times, and when an appointment request, which indicates one candidate appointment date and time corresponding to the selected one region, is received from the communication device via the network, registering the one candidate appointment date and time indicated by the appointment request as an appointment date and time at the specialized institution in the information management system.

25. The method according to claim 24, wherein
the appointment date and time at the specialized institution is displayed in the communication device within the one region represented in the calendar data, when the registration has been completed in the information management system.

26. The method according to claim 24, wherein
the information management system collects to manage customer information via the network, the customer information being associated with the user of the communication device, and
the method further comprising:
transmitting a notice to the communication device via the network, when it is determined based on the customer information that a service, which is in accordance with preferences or history of the user of the communication device, is provided by the specialized institution, wherein the notice indicates that the service is provided by the specialized institution.
